(19) United States
(12) Patent Application Publication
(10) Pub. No.: US 2026/0307077 A1
(43) Pub. Date: Oct. 8, 2026

(54) CUVETTE DESIGN FOR USE IN A CUVETTE MODULE

(71) Applicant: General Fluidics Corporation, Watertown, MA (US)

(72) Inventors: Robert Granier, Boston, MA (US); Ramin Haghgooie, Arlington, MA (US); Daniel Morris Hartmann, Arlington, MA (US); Jesse Newton Jones, IV, Woburn, MA (US)

(21) Appl. No.: 19/481,794

(22) PCT Filed: May 6, 2024
(86) PCT No.: PCT/US2024/028033

§ 371 Date: Nov. 5, 2025

Related U.S. Application Data
(60) Provisional application No. 63/500,506, filed on May 5, 2023.

(51) Int. Cl. B01L 3/00

(52) U.S. Cl. CPC B01L 3/5082; B01L 2200/026; B01L 2300/0663; B01L 2300/0832; B01L 2400/06

(57) ABSTRACT

Aspects of the present disclosure include cuvettes used in photometric assays. Aspects of the present disclosure further include a cuvette module using the cuvette for performing photometric assays. Aspects of the present disclosure further include systems and methods for performing photometric assays using the cuvette.

### CROSS REFERENCE TO RELATED APPLICATIONS

This is a National Stage Application under 35 U.S.C. § 371 of International Application No. PCT/US2024/028033, filed on May 6, 2024, which claims the benefit of priority to U.S. Provisional Application No. 63/500,506, filed on May 5, 2023, the entireties of which are hereby incorporated by reference in their entireties.

### TECHNICAL FIELD

Various embodiments of the present disclosure relate generally to systems and methods for a cuvette, and, more particularly, to systems and methods for a cuvette module.

### BACKGROUND

Cuvettes are small vessels, made from a transparent material, such as quartz, glass, or plastic. They are traditionally used for analysis of liquids with a spectrometer, fluorometer or spectrophotometer. They are also found in automated clinical chemistry and immunoassay analyzers where they are used to analyze biological fluids for determining patient health.

Traditional cuvettes have a single opening into and from which fluids to be analyzed may be dispensed and aspirated. Liquid is pipetted into the opening and fills the cuvette under the influence of gravity, displacing the air within it. A disadvantage of such cuvettes is that if they are to be reused, the liquid must be aspirated out of the cuvette when the analysis is completed. Moreover, the cuvette must then be thoroughly cleaned to prevent carryover of one sample to the next. This requires that the cuvettes either be removed from their locations and washed elsewhere, or that they be addressed by a probe that can aspirate the waste out of them and pipette cleaning solution into them. This can be a time-consuming process, requiring multiple wash steps of the cuvettes and probe. Alternatively, such open-style cuvettes may be disposable, in which case there is no need to clean them. However disposable cuvettes add consumable cost and require additional user steps to remove and insert.

Flow-through cuvettes, or flowcells also exist. A flow-through cuvette has more than one opening, so that fluid may flow from a liquid inlet to a liquid outlet. Such flow cells are used in instruments that include hematology analyzers, refractometers, particle counters, and tablet dissolution instruments, as well as certain fluorimeters, and spectrophotometers. Flow cells are meant for in-line use; the input and output of the flow cell are joined to a fluidic network, and fluid is pumped into and out of the cell. An advantage of these flow cells is that they are more-easily emptied and cleaned in-place. A cleaning solution, for instance, may be flowed through the flowcell directly to a waste reservoir to achieve the desired level of cleanliness. However, traditional flowcells cannot be gravity-filled. Instead, a pressure gradient must be established to enable liquid to be pushed or pulled through the flowcell (e.g. through use of a pump). It is also difficult to mix two or more fluids together in a flowcell because the fluid is generally inaccessible to mechanical methods of mixing. Moreover, many flow cells have features such as expansions and contractions that make them prone to trapping bubbles during flow. Additionally, many flowcells are attached to the upstream fluidic network through unions which can leak.

In light of the deficiencies inherent in the prior art, there is accordingly a need to provide a container, flow cell, or cuvette having an interrogation region that can be loaded and held under the influence of gravity through an input, but emptied from a separate output. There is also a need to ensure that the cuvette may be filled with minimal chance of bubble entrainment occurring in the interrogation region. Furthermore, there is also a need that the cuvette or container maintain the liquid within the interrogation region for as long as desired, and then be easily emptied to remove all, or almost all the liquid within it, so that what little liquid remains may be washed away using the least amount of cleaning solution.

### SUMMARY

Aspects of the present disclosure include cuvettes, cuvette modules, and systems to conduct biological and chemical assays on a variety of samples.

One aspect of the present disclosure includes a cuvette for holding fluids, comprising: an inlet end comprising an inlet open to the atmosphere, wherein the inlet is configured to receive the fluids dispensed into the inlet from above the cuvette; a body of the cuvette connected to the inlet end, the body composed of walls surrounding the cuvette, each wall having an inner surface and an outer surface, the walls including a plurality of regions comprising: an inlet chamber, the inlet chamber comprising: an interrogation region comprising a proximal end and a distal end, the proximal end positioned at the inlet end of the cuvette, the walls at the interrogation region including a first wall and a second wall opposite the first wall, wherein the inlet chamber is configured to: be filled under the influence of gravity; and allow transmission of light through the first wall and the second wall of the interrogation region, and a tapered region comprising a proximal end and a distal end, the tapered region positioned at the distal end of the interrogation region, the inner surface of the wall at the tapered region tapering inward from the proximal end of the tapered region to a narrowed section at the distal end of the tapered region, wherein there is an obtuse angle formed between the inner surface of the walls of the tapered region and the inner surface of the walls of the interrogation region; and a necked region fluidically connected to the distal end of the tapered region, and comprising: an outlet positioned at the distal end of the necked region, wherein the necked region is configured to maintain fluid within the inlet chamber of the cuvette until a pressure gradient is applied across the outlet.

In some embodiments, the necked region comprises an outlet channel. In some embodiments, the outlet channel comprises an outlet opening comprising an inner diameter ranging from 0.01 mm to 2 mm. In some embodiments, the outlet channel comprises an inner diameter ranging from 0.01 mm to 2 mm. In some embodiments, the necked region further comprises a restrictive channel.

In some embodiments, the cuvette further comprising a capillary valve between the transition of the distal end of the tapered region and the proximal end of the restrictive channel. In some embodiments, the capillary valve is created by the transition of the inner diameter of distal end of the tapered region and the inner diameter of the proximal end of the restrictive channel. In some embodiments, the restrictive channel has an inner diameter ranging from 0.01 mm to 2 mm. In some embodiments, the restrictive channel is configured to hold a volume ranging from 0.01 microliters to 2 microliters.

In some embodiments, the volume of the interrogation region of the cuvette is greater than 50% of the total volume of fluid that fills the cuvette In some embodiments, the restrictive channel comprises a length ranging from 0.5 mm to 5 mm. In some embodiments, the inner diameter of the restrictive channel is smaller than the inner diameter of the outlet channel of the necked region. In some embodiments, the first and second walls of the interrogation region are substantially flat. In some embodiments, the obtuse angle between the inner surface of the wall of the tapered region and the inner surface of the first wall and the second wall of the interrogation region ranges from 130 to 179 degrees. In some embodiments, the cuvette comprises a connection point between the distal end of the interrogation region and the proximal end of the tapered region, wherein the connection point comprises the obtuse angle ranging from 130 to 179 degrees.

In some embodiments, the cuvette further comprises an indexing feature configured to index a portion of the cuvette to a surface of a housing, a manifold, a sensor, or a fluidic valve. In some embodiments, the indexing feature is positioned at the inlet end. In some embodiments, indexing feature is positioned at the proximal end of the interrogation region. In some embodiments, the indexing feature comprises a peripheral rim surrounding the inlet. In some embodiments, the peripheral rim comprises a lip extending radially outward from the cuvette to lock the cuvette in place. In some embodiments, the indexing feature comprises a peripheral rim surrounding the inlet. In some embodiments, the indexing feature comprises a peripheral rim positioned between the distal end of the interrogation region and the proximal end of the tapered region.

In some embodiments, the necked region is positioned at the distal end of the tapered region, and the outlet of the necked region is positioned at the distal end of the outlet channel. In some embodiments, the outlet of the cuvette has an opening with a diameter ranging from 0.1 mm to 2 mm. In some embodiments, the interrogation region of the cuvette comprises an inner dimension defining the optical path length that ranges from 1 mm to 10 mm.

In some embodiments, the cuvette is made of a transparent plastic chosen from: polycarbonate, polystyrene, acrylic, polypropylene, cyclic-olefin-copolymer, cyclic-olefin-polymer, copolyester, polyethylene terephthalate (PET), polyethylene terephthalate glycol (PETG), or other transparent plastic. In some embodiments, the cuvette is made of Eastman Tritan copolyester.

In some embodiments, the cuvette, or portions thereof, is made from a material that has a water/solid contact angle that is less than 90 degrees. In some embodiments, the cuvette is connected to a tube or channel at the distal end of the outlet. In some embodiments, the cuvette comprises means for changing the optical properties of light passing through the cuvette.

Another aspect of the present disclosure includes a cuvette module comprising: at least one compartment capable of holding at least one cuvette, the cuvette comprising an inlet open to the atmosphere, an inlet chamber, and an outlet, wherein inlet is configured to receive the fluids dispensed into the inlet from above the at least one cuvette; a central channel in fluidic communication with the outlet of the at least one cuvette; and a fluidic valve positioned between the central channel and a downstream channel and configured to connect and disconnect the downstream channel from the central channel.

In some embodiments, the downstream channel is fluidically connected to and is downstream of the fluidic valve. In some embodiments, the cuvette module further comprises a fluidic seal between the outlet of the at least one cuvette and the central channel configured to create an air-tight seal between the outlet and the central channel. In some embodiments, the fluidic seal is a gasket positioned around the outlet end of the cuvette. In some embodiments, the outlet of the cuvette is configured to create a radial seal with the gasket. In some embodiments, the gasket is configured to provide an air-tight and/or fluid-tight seal between the outlet of the cuvette and a manifold of the cuvette module, the manifold comprising the central channel fluidically connecting the outlet of the cuvette and means for connecting to the fluidic valve.

In some embodiments, the manifold comprises the downstream channel, the central channel, or the downstream channel and the central channel. In some embodiments, the gasket is positioned in the manifold. In some embodiments, the gasket is positioned around the outlet of the cuvette. In some embodiments, the fluidic seal is a radial O-ring seal or an axial gasket seal.

In some embodiments, when the fluidic valve is closed, the fluidic valve is configured to trap a volume of air between the fluidic valve and the inlet chamber of the at least one cuvette. In some embodiments, volume of air between the valve and any liquid in the cuvette inlet chamber ranges from 5 to 60 microliters. In some embodiments, the volume of air trapped between the fluidic valve and the inlet chamber of the cuvette is compressed if the fluid in the cuvette moves into the restrictive channel of the cuvette; wherein the compressed air generates a pressure that is equal and opposite to the head pressure of the fluid in the cuvette, thereby keeping the fluid in the inlet chamber of the cuvette. In some embodiments, the volume of air trapped between the fluidic valve and the inlet chamber of the cuvette is compressed if the fluid in the cuvette moves into the restrictive channel of the cuvette, wherein the compressed air then generates a pressure that, in combination with the capillary pressure associated with the capillary valve, is equal and opposite to the head pressure of the liquid in the cuvette, thereby keeping the fluid in the inlet chamber of the cuvette. In some embodiments, the cuvette comprises at least one cuvette.

In some embodiments, the at least one cuvette comprises a body of the cuvette connected to the inlet end, the body composed of walls surrounding the cuvette, each wall having an inner surface and an outer surface, the walls including a plurality of regions comprising: the inlet chamber, the inlet chamber comprising: an interrogation region comprising a proximal end and a distal end, the proximal end positioned at the inlet end of the cuvette, the walls at the interrogation region including a first wall and a second wall opposite the first wall, wherein the inlet chamber is configured to: be filled, under the influence of gravity, with fluid dispensed into the inlet; and allow transmission of light through the first wall and the second wall of the interrogation region, and a tapered region comprising a proximal end and a distal end, the tapered region positioned at the distal end of the interrogation region, the inner surface of the wall at the tapered region tapering inward from the proximal end of the tapered region to a narrowed section at the distal end of the tapered region, wherein there is an obtuse angle formed between the inner surface of the wall at the tapered region and the inner surface of the first wall and the second wall at the interrogation region, to enable drainage of the fluid from the cuvette once the fluid is measured; and a necked region fluidically connected to the distal end of the tapered region, and comprising: the outlet positioned at the distal end of the necked region, wherein the necked region is configured to maintain fluid within the inlet chamber of the cuvette until a pressure gradient is applied across the outlet.

In some embodiments, when the fluidic valve is closed, the fluidic valve is configured to trap a volume of air between the fluidic valve and the necked region of the cuvette. In some embodiments, the open position of the fluidic valve creates a fluidic connection between the outlet of the cuvette and the downstream channel.

In some embodiments, the volume or air between the fluidic valve and the inlet chamber ranges from 5 and 60 microliters. In some embodiments, wherein the module further comprises mechanical means of holding the cuvette in a fixed position, wherein the inlet is maintained in an orientation and position for fluid to be dropped or dispensed into the inlet of the cuvette, thereby filling the inlet chamber of the cuvette by means of gravity.

In some embodiments, the cuvette module further comprises: a housing having one or more housing walls configured to hold the at least one cuvette in the fixed position, and an opening at the proximal end of the housing walls for insertion of the cuvette into the housing. In some embodiments, the module further comprises a cap configured to attach to the housing over the inlet of the at least one cuvette. In some embodiments, the housing is made of a thermally conductive material. In some embodiments, the thermally conductive material is aluminum. In some embodiments, the housing comprises a slot on at least one of the housing walls to register or index the at least one cuvette in a selected position within the housing. In some embodiments, the housing comprises a fastener on at least one of the housing walls to fasten the cuvette into the housing.

In some embodiments, the at least one cuvette comprises two or more cuvettes, each cuvette positioned in a separate opening or slot of the housing for inserting and indexing each cuvette. In some embodiments, the cuvette module comprises two or more fluidic valves. In some embodiments, the cuvette module comprises two or more downstream channels within a manifold. In some embodiments, the cuvette module comprises two or more central channels within a manifold. In some embodiments, each fluidic valve is configured to fluidically connect to each central channel, and wherein each central channel is configured to be in fluid communication with the outlet of each cuvette.

In some embodiments, the module further comprises means of directing and detecting light that has interacted with at least a portion of the fluid contained in the at least one cuvette. In some embodiments, the module further comprises means of directing light from a light source so that it impinges on and passes through a first wall of the cuvette and interacts with at least a portion of the liquid contained therein.

In some embodiments, the cuvette module further comprises: a light source positioned adjacent to the interrogation region of the cuvette, the light source configured to deliver a beam of light through the interrogation region of the cuvette; and an optical detector disposed in optical communication with the interrogation region of the cuvette to receive at least a portion of the beam that has traversed the cuvette.

In some embodiments, the cuvette module comprises two or more light sources and two or more optical detectors, each light source positioned adjacent to the interrogation region of each cuvette, and each optical detector positioned adjacent to the interrogation region of each cuvette. In some embodiments, the module further comprises means of filtering light passing through the cuvette to change the wavelength content, polarization, and/or intensity of the light.

In some embodiments, the module further comprises a filter housing configured to hold one or more optical filters, each optical filter positioned adjacent to each cuvette. In some embodiments, the module further comprises an optical mask.

In some embodiments, the cuvette module is configured to enable light from a light source to enter the cuvette through a first substantially flat wall of the cuvette, interact with at least a portion of the fluid contained within the at least one cuvette, and exit through a second substantially flat wall of the at least one cuvette, wherein the remaining light is collected by a detector. In some embodiments, the module further comprises a heating and/or cooling element configured to control the temperature of the cuvette and the fluid within the cuvette.

In some embodiments, the optical detector is a silicon photodiode. In some embodiments, the module comprises a sensor configured to detect the presence or absence of fluid in at least a portion of the cuvette. In some embodiments, the module comprises a pressure sensor. In some embodiments, the module comprises a tube or channel directed connected to an input of the cuvette, wherein the tube or channel is configured to hold and move a solution into the input of cuvette to fill the cuvette inlet chamber. In some embodiments, the module comprises one or more channels fluidically downstream of one or more fluidic valves, wherein the one or more fluidic channels is connected to the distal end of one or more fluidic valves. In some embodiments, the module comprises a pump connected to one or more channels that are downstream of and fluidically connected to, the outlet of the cuvette. In some embodiments, the module comprises the pump is configured to trap a pocket or volume of air between the pump and any fluid in the inlet chamber of the cuvette. In some embodiments, the module comprises the pump is selected from: a peristaltic pump, a membrane pump, or a diaphragm pump. In some embodiments, the module comprises the at least one cuvette is the at least one cuvette of described herein.

Another aspect of the present disclosure includes a module having a plurality of cuvettes, fluidic valves, central channels, and downstream channels of the present disclosure. In some embodiments, the fluidic channels downstream of the one or more fluidic valves are joined to a common or adjoining channel.

Another aspect of the present disclosure includes a method of using the module of the present disclosure to perform a photometric assay, the method comprising: (a) mechanically constraining the cuvette in the module in a fixed location and orientation; (b) closing the fluidic valve in the module; (c) dropping or dispensing fluid into the inlet of the cuvette so that it fills the inlet chamber of the cuvette, wherein a volume or pocket of air is trapped between the fluidic valve and the fluid in the inlet chamber of the cuvette; (d) directing light from a light source into the cuvette, wherein the light is configured to interact with at least a portion of the fluid contained within the inlet chamber of the cuvette; (e) collecting light that has interacted with the fluid with a light-detector and gathering data representative of changes occurring in the fluid; and (f) opening the fluidic valve of the module and pulling or pushing, with a pump, the fluid within the cuvette through the outlet of the cuvette and into the downstream channel. In some embodiments, the method further comprises, after step c), optionally processing the fluid of the cuvette by performing one or more steps selected from: adding additional fluids or solids to the cuvette; mixing the fluids or solids within the cuvette; and heating or cooling the mixed fluids or solids within the cuvette. In some embodiments, the method further comprises, after step e), analyzing the data. In some embodiments, the method comprises, after step f), cleaning the cuvette by: closing the fluidic valve; filling the cuvette with a solution; opening the fluidic valve; and pulling or pushing the cleaning fluid through the outlet of the cuvette and into a downstream channel.

In some embodiments, at least a portion of the light configured to interact with the fluid in the cuvette is absorbed, and wherein the photometric assay is an absorbance assay. In some embodiments, at least a portion of the light configured to interact with the fluid in the cuvette is scattered, and wherein the photometric assay is a scattering assay. In some embodiments, the method further comprises measuring a polarization change of the light interacting with the fluid within the cuvette. In some embodiments, the method further comprises measuring a fluorescence emission when the light interacts with the fluid within the cuvette.

Another aspect of the present disclosure includes a fluidic system comprising the cuvette module of the present disclosure and a downstream pump. In some embodiments, the pump is attached to a tube or channel that is connected to the fluidic valve, wherein when the fluidic valve is closed, the pump is fluidically disconnected from the cuvette, and wherein when the valve is open, the pump is fluidically connected to the cuvette. In some embodiments, the system further comprises a waste tank. In some embodiments, the system further comprises a cleaning fluid tank. In some embodiments, the fluidic system further comprises a cleaning pump. In some embodiments, the fluidic system further comprises a degasser. In some embodiments, the fluidic system further comprises one or more pipettes. In some embodiments, the fluidic system comprises the at least one cuvette of the present disclosure. In some embodiments, the fluidic system further comprises a mixing apparatus.

Another aspect of the present disclosure includes a method of using the cuvette module of the present disclosure to perform a photometric assay, the method comprising: (a) mechanically constraining a cuvette in the module in a fixed location and orientation; (b) dropping or dispensing fluid into the inlet of the cuvette so that it fills the inlet chamber of the cuvette, wherein a volume or a pocket of air is trapped between the pump and the fluid in the inlet chamber of the cuvette; (c) directing light from a light source into the cuvette, wherein the light is configured to interact with at least a portion of the fluid contained within the inlet chamber of the cuvette; (d) collecting light that has interacted with the fluid with a light-detector and gathering data representative of changes occurring in the fluid; and (e) pulling, using the pump, the fluid within the cuvette through the outlet of the cuvette to the downstream channel. In some embodiments, the method further comprises, after step b), using the pump to slightly-increase the pressure in the volume or pocket of air between the cuvette and the pump. In some embodiments, method further comprises, after using the pump to slightly-increase the pressure in the volume or pocket of air between the cuvette and the pump, the method further comprises processing the fluid of the cuvette by performing one or more steps selected from: adding additional fluids or solids to the cuvette; mixing the fluids or solids within the cuvette; and heating or cooling the mixed fluids or solids within the cuvette.

In some embodiments, the method further comprises, after step d), the method further comprises analyzing the data. In some embodiments, the method comprises, after step e), cleaning the cuvette by filling the cuvette with a wash solution; and pulling the cleaning fluid through the outlet of the cuvette and into a downstream channel

Another aspect of the present disclosure includes a cuvette module comprising: at least one compartment capable of holding at least one cuvette, the cuvette comprising an inlet open to the atmosphere, an inlet chamber, and an outlet, wherein inlet is configured to receive the fluids dispensed into the inlet from above the at least one cuvette; a central channel in fluidic communication with the outlet of the at least one cuvette; and a pump connected between the central channel and a downstream channel, wherein the downstream channel is positioned downstream of the pump. In some embodiments, the pump is configured to trap a pocket or volume of air between the pump and any fluid in the inlet chamber of the cuvette. In some embodiments, the pump is selected from: a peristaltic pump, a membrane pump, or a diaphragm pump.

Another aspect of the present disclosure includes a cuvette comprising an inlet end comprising an inlet open to the atmosphere, wherein the inlet is configured to receive the fluids dispensed into the inlet from above the cuvette; a body of the cuvette connected to the inlet end, the body composed of walls surrounding the cuvette, each wall having an inner surface and an outer surface, the walls including a plurality of regions comprising: an inlet chamber, the inlet chamber comprising: an interrogation region comprising a proximal end and a distal end, the proximal end positioned at the inlet end of the cuvette, the walls at the interrogation region including a first wall and a second wall opposite the first wall, wherein the inlet chamber is configured to: be filled under the influence of gravity; and allow transmission of light through the first wall and the second wall of the interrogation region, and a tapered region comprising a proximal end and a distal end, the tapered region positioned at the distal end of the interrogation region, the inner surface of the wall at the tapered region tapering inward from the proximal end of the tapered region to a narrowed section at the distal end of the tapered region; and a necked region fluidically connected to the distal end of the tapered region, and comprising: an outlet positioned at the distal end of the necked region, wherein the necked region is configured to maintain fluid within the inlet chamber of the cuvette until a pressure gradient is applied across the outlet.

Another aspect of the present disclosure include a cuvette that has: an interrogation region that can be loaded and held under the influence of gravity through an input, but emptied from a separate output; a design to ensure that the cuvette may be filled with minimal chance of bubble entrainment occurring in the interrogation region, and a design that maintains the liquid within the interrogation region for as long as desired, and then be easily emptied to remove all, or almost all the liquid within it.

Another aspect of the present disclosure includes cuvette geometries that minimize the total fluid volume required to fill them, while maintaining the volume of fluid that interacts with light during photometric assays.

Another aspect of the present disclosure includes unique cuvette modules into which at least one cuvette may be removably-inserted; the modules enabling the cuvette to be easily integrated with all the hardware required to perform a desired assay.

Another aspect of the present disclosure includes cuvette designs that provide an indexing feature configured to index a portion of the cuvette to a surface of a housing, a manifold, a sensor, or a fluidic valve. In some embodiments, the indexing feature is to enable it to be removably-inserted into a module in a precise position.

Another aspect of the present disclosure includes a system and methods that use the cuvettes and cuvette modules to conduct biological and chemical assays on a variety of samples.

One aspect of the present disclosure includes a cuvette for holding fluids, comprising: an inlet end comprising an inlet open to the atmosphere, wherein the inlet is configured to receive the fluid that is dropped or dispensed into the inlet from above the cuvette. The cuvette further comprises a body of the cuvette connected to the inlet end, the body composed of walls surrounding the cuvette, each wall having an inner surface and an outer surface, the walls including a plurality of regions comprising: an inlet chamber containing an interrogation region comprising a proximal end and a distal end, the proximal end positioned at the inlet end of the cuvette, the walls at the interrogation region including a first wall and a second wall opposite the first wall, wherein the inlet chamber is configured to: be filled, under the influence of gravity, by the fluid that is dropped or dispensed into the inlet; and allow transmission of light through the first wall and the second wall of the interrogation region, and a tapered region comprising a proximal end and a distal end, the tapered region positioned at the distal end of the interrogation region, the inner surface of the wall at the tapered region tapering inward from the proximal end of the tapered region to a narrowed section at the distal end of the tapered region, wherein there is an obtuse angle formed between the inner surface of the wall at the tapered region and the inner surface of the first wall and the second wall at the interrogation region to enable drainage of the fluid from the cuvette once the fluid is measured; and an outlet end fluidically connected to the body of the cuvette, the outlet end comprising an outlet configured to allow the fluid to be maintained within the inlet chamber for as long as desired, but to exit the cuvette upon application of an additional pressure drop across the outlet.

In some embodiments, the first and second walls of the interrogation region are substantially flat. In some embodiments, the obtuse angle between the inner surface of the wall of the tapered region and the inner surface of the first wall and the second wall of the interrogation region ranges from 130 to 179 degrees. In some embodiments, the cuvette comprises a connection point between the distal end of the interrogation region and the proximal end of the tapered region, wherein the connection point comprises the obtuse angle ranging from 130 to 179 degrees.

In some embodiments, the cuvette comprises an indexing feature. The indexing feature is configured to index a portion of the cuvette to a surface of a housing, a manifold, a sensor, or a fluidic valve of a cuvette module of the present disclosure.

In some embodiments, the inlet end further comprises the indexing feature. In some embodiments, the indexing feature is positioned at the proximal end of the interrogation region. In some embodiments, the indexing feature comprises a peripheral rim surrounding the inlet. In some embodiments, the peripheral rim comprises a lip extending radially outward from the container to lock the container in place.

In some embodiments, the indexing feature is connected to the first and second walls. In some embodiments, the indexing feature comprises a peripheral rim surrounding the inlet. In some embodiments, the cuvette further comprises an indexing feature, wherein the indexing feature comprises a peripheral rim positioned between the distal end of the interrogation region and the proximal end of the tapered region.

In some embodiments, the outlet is positioned at the distal end of the tapered region.

In some embodiments, the body of the cuvette further comprises a necked region positioned at the distal end of the tapered region and comprises an outlet at the distal end of the necked region. In some embodiments, the outlet of the cuvette has an opening that is between 0.1 mm and 2 mm in diameter.

In some embodiments, the necked region comprises an outlet channel that fluidically joins the distal end of the tapered region with the outlet.

In some embodiments, the outlet channel is restrictive, having an inner diameter that is between 0.1 and 1 mm in diameter.

In some embodiments, the necked region comprises two channels: a restrictive channel and an outlet channel, wherein the restrictive channel is proximal to and in fluid communication with the distal end of the tapered region, the distal end of the restrictive channel is connected to the proximal end of the outlet channel, and the distal end of the outlet channel is connected to the outlet. In other words, the restrictive channel and the outlet channel are in series and fluidically connect the distal end of the tapered region to the outlet. In some embodiments, the restrictive channel is between 0.1 and 1 mm in diameter, and the outlet channel is between 0.3 mm and 2 mm in diameter.

In some embodiments, the outlet of the cuvette is fluidically-restricted through use of a restrictive element inserted into a necked region of the cuvette, the restrictive element having an opening that is between 0.1 mm and 1 mm in diameter.

In some embodiments, the cuvette is made of a transparent plastic chosen from: polycarbonate, polystyrene, acrylic, polypropylene, cyclic-olefin-copolymer, cyclic-olefin-polymer, copolyester, polyethylene terephthalate (PET), polyethylene terephthalate glycol (PETG), or other transparent plastic.

In some embodiments, the cuvette is made of Eastman Tritan copolyester.

In some embodiments, the cuvette is connected to a tube or channel at the distal end of the outlet.

Another aspect of the present disclosure includes a cuvette for holding fluids, comprising: an inlet end comprising an inlet open to the atmosphere, wherein the inlet is configured to receive the fluid dropped or dispensed into the inlet from above the cuvette; a body of the cuvette connected to the inlet end, the body composed of walls surrounding the cuvette, each wall having an inner surface and an outer surface, the walls including a plurality of regions comprising: an inlet chamber containing an interrogation region comprising a proximal end and a distal end, the proximal end positioned at the inlet end of the cuvette, the walls at the interrogation region including a first wall and a second wall opposite the first wall, the interrogation region configured to: be filled, under the influence of gravity, by the fluid dispensed into the inlet; and allow transmission of light through the first wall and the second wall of the interrogation region; and an outlet end fluidically connected to the body of the cuvette, the outlet end comprising an outlet that behaves as a passive valve, capable of maintaining the liquid in the interrogation region for as long as desired, but allowing the fluid to exit the cuvette upon demand through application of additional pressure across the outlet.

In some embodiments, the outlet has a small internal diameter.

In some embodiments, the cuvette further comprises a pinching element for creating a tapered region comprising a proximal end and a distal end, the tapered region positioned at the distal end of the interrogation region, the inner surface of the wall at the tapered region tapering inward from the proximal end of the tapered region to a narrowed section at the distal end of the tapered region, wherein there is an obtuse angle formed between the inner surface of the wall at the tapered region and the inner surface of the first wall and the second wall at the interrogation region to enable drainage of the fluid from the cuvette once the fluid is measured.

In some embodiments, the pinching element is configured to close or open the outlet of the cuvette.

In some embodiments, the pinching element is configured to reversibly create a necked region of the cuvette and the tapered region.

In some embodiments, the cuvette is connected to a tube or channel at the distal end of the outlet.

In some embodiments, the cuvette has a trapezoidal cross-section.

In some embodiments, the cuvette is coated with or is made from material that alters the characteristics of light passing through the cuvette in a way that enables or improves the performance of an assay performed therein.

Another aspect of the present disclosure includes a cuvette module comprising: a cuvette design of the present disclosure; a housing comprising one or more housing walls shaped to hold and mechanically constrain the cuvette in place.

In some embodiments, the housing comprises an opening at a proximal end of the housing walls for inserting the cuvette into the housing. In some embodiments, the housing comprises a slot on at least one of the housing walls to register or index the cuvette in a selected position within the housing. In some embodiments, the housing comprises a fastener on at least one of the housing walls to fasten the cuvette into the housing.

In some embodiments, the cuvette module further comprises a manifold having a fluidic channel positioned between and fluidically connecting the outlet of the cuvette and a fluidic valve.

In some embodiments, the manifold further comprises a gasket positioned around the outlet end of the cuvette. In some embodiments, the outlet end of the cuvette is configured to create a radial seal with the gasket. In some embodiments, the gasket is configured to provide an air-tight and/or fluid-tight seal between the manifold and the outlet of the cuvette. In some embodiments, the gasket is configured to provide an air-tight and/or fluid-tight seal between the first fluidic channel and the outlet of the cuvette.

In some embodiments, the cuvette module further comprises an active fluidic valve (e.g., a valve that is controlled by an externally-applied signal), fluidically connected to the central channel of the manifold, wherein the active valve may open and close, such that opening the valve creates a fluid path from the outlet of the cuvette to a channel downstream (e.g., downstream channel) of the valve, and closing the valve disconnects the outlet of the cuvette from the downstream channel. If there is liquid in the cuvette, closing the valve also traps a small volume of air between the liquid and the valve.

In some embodiments, the cuvette module further comprises a second gasket that is configured to provide an air-tight and/or fluid-tight seal between the active fluidic valve and the manifold.

In some embodiments, the cuvette module further comprises: a light source positioned adjacent to the interrogation region of the container, the light source configured to deliver a beam of light through the interrogation region of the cuvette; and an optical detector disposed in optical communication with the interrogation region of the cuvette to receive at least a portion of the beam that has traversed the cuvette.

In some embodiments, the cuvette module further comprises openings into which optical elements, such as filters and lenses may be removably inserted, such that light passes through the optical elements before and/or after passing through the interrogation region of the cuvette.

In some embodiments, the cuvette is one of an array of cuvettes, each of the cuvettes positioned within a housing. In some embodiments, each cuvette within the array of cuvettes is positioned in a separate opening or slot for inserting and indexing each cuvette.

In some embodiments, the cuvette module further comprises an array of active fluidic valves.

In some embodiments, the cuvette module further comprises a manifold comprising an array of fluidic channels, each fluidic channel positioned between and fluidically connecting each outlet of each of the cuvettes and each active fluidic valve.

In some embodiments, each active valve is fluidically connected to the fluidic channel of the manifold, wherein each active valve is configured to open and close, such that opening the valve creates a fluid path from the outlet of the cuvette to a channel downstream of the valve, and closing the valve disconnects the outlet of the cuvette from the downstream channel. If there is liquid in the cuvette this action also traps a small volume of air between the closed valve and the liquid.

In some embodiments, the volume of air trapped between liquid in the cuvette and the active valve is small, such that the head pressure of the liquid in the cuvette is substantially smaller than the increase in the air pressure that would result from the compression of air if fluid was to pass through the restrictive element in the necked region of the cuvette.

In some embodiments, the active valve acts in association with the restrictive region (e.g., restrictive channel) in the necked region of the cuvette to maintain liquid in the inlet chamber of the cuvette until the active valve is opened.

In some embodiments, the small volume of air trapped between the cuvette and the closed active valve becomes pressurized above atmospheric pressure if liquid moves into the restrictive channel in the necked region of the cuvette.

In some embodiments, the array of cuvettes comprises 2 or more cuvettes. In some embodiments, the array of active fluidic valves comprises 2 or more fluidic active valves.

In some embodiments, the cuvette module further comprises an array of light sources and an array of optical detectors, each light source positioned adjacent to the interrogation region of each cuvette, and each optical detector positioned adjacent to the interrogation region of each cuvette. In some embodiments, the cuvette module further comprises an array of cuvettes. In some embodiments, the cuvette module further comprises a tube or channel connected to the distal end of the cuvettes.

Another aspect of the present disclosure includes a system for performing photometric measurements of a fluid, the system comprising the cuvette module of the present disclosure, and a pump.

In some embodiments, the system further comprises a waste tank. In some embodiments, the system further comprises a cleaning fluid tank. In some embodiments, the microfluidic system further comprises a cleaning pump. In some embodiments, the microfluidic system further comprises a degasser. In some embodiments, the microfluidic system further comprises one or more pipettes. In some embodiments, the one or more pipettes comprise one or more automated pipettes. In some embodiments, the system further comprises a thermal heater.

Another aspect of the present disclosure includes methods for processing and performing a photometric measurement.

In some embodiments, the method comprises: (a) dispensing a fluid, under the influence of gravity, into an inlet of the cuvette design of the present disclosure from above the cuvette to deliver the fluid into the cuvette; (b) processing the fluid while holding it within the inlet chamber. In some embodiments, the method further comprises (c) transmitting light from a first light source to a photodetector through the interrogation region of the cuvette containing the fluid; (d) acquiring data representing the fluid; (e) determining the presence or absence of one or more analytes in the fluid.

In some embodiments, the method further comprises, step (f) draining the fluid from the cuvette through the outlet and washing the cuvette to prepare it to process more fluid.

In some embodiments, the method further comprises, before step (e), analyzing the data representing the fluid.

In some embodiments, analyzing comprises determining a concentration of the one or more analytes in the fluid. In some embodiments, acquiring data representing said fluid comprises acquiring fluorometric measurements of the fluid.

In some embodiments, acquiring data representing the fluid comprises measuring the absorbance of the fluid. In some embodiments, acquiring data representing the fluid comprises measuring the concentration of the fluid.

In some embodiments, the one or more analytes are selected from: Blood urea nitrogen (BUN), carbon dioxide (CO2), Creatinine, Glucose, chloride, potassium, sodium, calcium, Hemoglobin, Albumin (ALB), Total protein (TP), Alkaline phosphatase (ALP), Alanine transaminase (ALT), Aspartate aminotransferase (AST), Total Bilirubin, Amylase, Gamma-glutamyl transferase, Lipase, Magnesium, Phosphorus, Direct Bilirubin, Triglycerides, total Cholesterol, high-density-lipoprotein (HDL), Ammonia, lactic acid (LAC), Fructose, Lactate dehydrogenase (LDH), uric acid, bile acids, Hbalc, and Creatine kinase.

In some embodiments, analyzing comprises determining a mean corpuscular hemoglobin concentration (MCHC) in the fluid. In some embodiments, analyzing comprises determining a mean corpuscular hemoglobin (MCH) in the fluid.

### BRIEF DESCRIPTION OF THE DRAWINGS

These and other features, aspects, and advantages of the present invention will become better understood with regard to the following description, and accompanying drawings, where:

FIG. 1 shows a spectrophotometer, chemistry analyzer, and cuvettes for use regarding the same, according to one or more embodiments.

FIG. 2A shows an exemplary cuvette design of the present disclosure comprising an inlet, an outlet, and a body of a cuvette positioned between the inlet and outlet, according to one or more embodiments.

FIG. 2A shows a cuvette body in a side view, according to one or more embodiments.

FIG. 2B shows an outlet channel and the restrictive channel of a cuvette, according to one or more embodiments.

FIG. 2C shows a restrictive channel of a cuvette at the top of a necked region, according to one or more embodiments.

FIG. 2D shows tapered region of a cuvette makes a gradual and smooth transition, according to one or more embodiments.

FIG. 2E a tapered region of a cuvette which transitions to a flat section, according to one or more embodiments.

FIG. 3 shows a cross-sectional view of an exemplary cuvette design of the present disclosure positioned so that it is proximal to a light-emitter and a detector, along with a cone of light from the emitter, according to one or more embodiments.

FIGS. 4A-4B provides isometric and cross-sectional views of cuvette design of the present disclosure, where the cuvette design can be injection moldable, according to one or more embodiments.

FIG. 4A shows the cuvette including a peripheral rim surrounding the inlet end of the cuvette, and a connection point comprising an obtuse angle between the distal end of the interrogation region and the proximal end of the tapered region of the cuvette, according to one or more embodiments.

FIG. 4B depicts isometric and cross-sectional views of a cuvette design according to one or more embodiments, where the cuvette can include a peripheral rim surrounding the cuvette, and positioned at the proximal end of the tapered region.

FIG. 5A-5D show a cross-sectional views of acuvette design of the present disclosure that is fluidically connected to a downstream active valve, according to one or more embodiments.

FIG. 5A shows a cross-sectional view of a cuvette design, according to one or more embodiments.

FIG. 5B illustrates the forces on the liquid when the liquid has filled the cuvette up to the opening of the restrictive channel in the necked region, according to one or more embodiments.

FIG. 5C shows the forces on the liquid when the liquid has entered the restrictive channel in the necked region, according to one or more embodiments.

FIG. 5D show the forces acting on the liquid when the liquid has filled the restrictive channel, according to one or more embodiments.

FIG. 6 shows an example of a cuvette having a necked region with a relatively large inner diameter, into which a restrictive element has been press-fit, according to one or more embodiments.

FIG. 7 provides isometric and cross-sectional views of a cuvette design, according to one or more embodiments, wherein the cuvette has a short neck relative to a necked region of FIG. 4B, and an axial gasket plate.

FIGS. 8A-8C show a views of a cuvette that has a body with a trapezoidal cross section, according to one or more embodiments.

FIG. 8A shows an isometric view of a cuvette that has a body with a trapezoidal cross section, according to one or more embodiments.

FIG. 8B shows an top-view of a cuvette that has a body with a trapezoidal cross section, according to one or more embodiments.

FIG. 8C shows a cross section and top-view within a cuvette module, according to one or more embodiments.

FIGS. 9A-9B depicts isometric views of a cuvette according to one or more embodiments, where the cuvette is dyed or coated with one or more colors or coatings to alter the properties of light transmitted through the cuvette.

FIG. 9A shows views of colored cuvettes, according to one or more embodiments.

FIG. 9B shows views of cuvettes with one or more coatings, according to one or more embodiments.

FIG. 10 provides cross-sectional views of a cuvette design, according to one or more embodiments.

FIGS. 11A-11D depict examples in which a plurality of cuvettes are joined together, for example, either through a monolithic fabrication process, or by assembly of discrete cuvettes into a whole, according to one or more embodiments, where the plurality of cuvettes can be in the form of 1D and 2D arrays, or any other desirable configuration.

FIG. 11A shows a schematic of a 1D array of cuvettes, according to one or more embodiments.

FIG. 11B shows an array of molded cuvettes assembled into a circular holder, according to one or more embodiments.

FIG. 11C shows an isometric and cross-sectional view of a monolithic array of cuvettes in a ID array, according to one or more embodiments.

FIG. 11D shows a two-dimensional array of molded cuvettes, according to one or more embodiments.

FIG. 12 shows exemplary components of a cuvette module comprising a cuvette, a housing, a manifold, and a fluidic valve, according to one or more embodiments.

FIG. 13 shows the components of an exemplary multiplexed cuvette module including an array of cuvettes, and a single-unit-cell of the cuvette module, according to one or more embodiments.

FIG. 14 shows an exploded view of the exemplary multiplexed cuvette module, according to one or more embodiments.

FIGS. 15A-15K show cross-sectional views of a cuvette module of the present disclosure comprising a cuvette, a housing, a fluidic manifold, and a fluidic valve or pump, according to one or more embodiments.

FIG. 15A depicts a cuvette module which provides a radial O-ring seal configured to provide an air-tight and/or fluid tight seal between of the cuvette and the manifold, according to one or more embodiments.

FIG. 15B depicts a cuvette module which provides an axial gasket seal configured to provide an air-tight and/or fluid tight seal between the cuvette and the manifold, according to one or more embodiments.

FIG. 15C illustrates a state of the module before liquid has been dropped or dispensed into the cuvette and where the cuvette and the tube are at atmospheric pressure, according to one or more embodiments.

FIG. 15D illustrates a state of the module when liquid has been dropped or dispensed into the cuvette, thereby trapping a volume of air, VI, between the valve and the liquid, according to one or more embodiments.

FIG. 15E illustrates a state of the module wherein some of the liquid in the cuvette begins to pass into the restrictive channel of the cuvette, thereby compressing the trapped volume of air to a volume V2, according to one or more embodiments.

FIG. 15F illustrates a state in which the cuvette is being emptied, the valve is opened and a downstream pump pulls the fluid out of the cuvette, according to one or more embodiments.

FIG. 15G illustrates a state of the module before liquid has been dropped or dispensed into the cuvette and where the cuvette, tube and upstream side of the pump are all at atmospheric pressure, according to one or more embodiments.

FIG. 15H illustrates an embodiment in which liquid has been dropped or dispensed into the cuvette, thereby trapping a volume of air, VI, between the pump and the liquid in the inlet chamber of the cuvette, according to one or more embodiments.

FIG. 15I illustrates an alternative situation wherein some of the liquid in the cuvette begins to pass into the restrictive channel of the cuvette, thereby compressing the trapped volume of air to a volume V2, according to one or more embodiments.

FIG. 15J illustrates an optional aspect of this embodiment in which the pump may be configured to apply a very slight pressure to the air-chamber, thereby momentarily increasing the pressure in the trapped air volume above the head-pressure of the liquid, according to one or more embodiments.

FIG. 15K illustrates a state in which the cuvette is being emptied by the pump which pulls the fluid out of the cuvette, according to one or more embodiments.

FIGS. 16A-16B show examples of a cuvette module of the present disclosure, according to one or more embodiments.

FIG. 16A shows a cross-sectional view of a cuvette module of the present disclosure comprising a cuvette, a housing, a fluidic manifold, and a fluidic valve, according to one or more embodiments.

FIG. 16B shows an isometric view of a cuvette module that includes one or more filter holders within the housing that can accept optical filters, according to one or more embodiments.

FIG. 17 shows cross-sectional views of an cuvette module of the present disclosure comprising a cuvette, and a soft rubber tube positioned at the end of the outlet of the cuvette that serves the purpose of a manifold, according to one or more embodiments.

FIG. 18 shows a fluidic system design comprising a cuvette of the present disclosure, cuvette module and a fluidic base with channels or tubes connecting individual cuvettes to a single waste chamber, according to one or more embodiments.

FIG. 19A-19B show a workflow schematic of the methods of the present disclosure using a cuvette module to fill and mix liquids in a cuvette of the present disclosure, measure and analyze the sample, and empty the cuvette after the sample has been measured and analyzed, according to one or more embodiments.

FIG. 19A shows stages of using a cuvette module to fill and mix liquids, according to one or more embodiments.

FIG. 19B shows steps for using a cuvette module in a system, according to one or more embodiments.

FIG. 20 shows the fluid architecture of an exemplary system of the present disclosure, according to one or more embodiments.

FIG. 21 shows a process flow of a method of the present disclosure including clinical chemistry using the cuvette module cuvette module of the present disclosure, according to one or more embodiments.

FIG. 22 shows an example of a fluidic system of the cuvette module comprising a tube or channel connected to a hole within the cuvette for dispensing fluids into the cuvette, according to one or more embodiments.

FIG. 23 depicts a representative of the cuvettes wherein the interrogation region is contained within the inlet chamber, according to one or more embodiments.

FIG. 24A depicts a cuvette design in which the interrogation region is separate from the inlet chamber, according to one or more embodiments.

FIG. 24B depicts a cuvette design in which the interrogation region is separate from the inlet chamber, according to FIG. 23B.

FIG. 24C depicts a cuvette design in which the interrogation region is separate from the inlet chamber, according to FIG. 23C.

FIG. 25 shows a cuvette module system containing the integrated module, a wash station, and a pipette system for use in processing samples, according to one or more embodiments.

FIG. 26 shows a cuvette module that includes a circular array of cuvettes, according to one or more embodiments.

### DETAILED DESCRIPTION OF THE DRAWINGS

Generally, the terms “sample”, “biological sample”, “chemical sample” and the like as used herein refer to a sample of fluid material that is assumed to contain an analyte of interest. For example, samples include bodily fluids (such as whole blood, serum, plasma, cerebrospinal fluid, urine, lymph fluids), and other fluids (such as, for example, cell culture suspensions, cell extracts, cell culture supernatants). A sample may be suspended or dissolved in, for example, buffers, extractants, solvents, and the like. Additional examples of samples are provided by fluids deliberately created for the study of biological processes or discovery or screening of drug candidates. The latter include, but are not limited to, aqueous samples containing bacteria, viruses, DNA, polypeptides, natural or recombinant proteins, metal ions, or drug candidates and their mixtures.

Aspects of the present disclosure include a container for holding a fluid, such as a cuvette or tube or channel, or other fluid holder. It can be used in a device or instrument for performing measurements or testing. In one embodiment, the container or cuvette is used in a cuvette module for performing a photometric measurement. The term “cuvette” is used throughout for illustration, but it is understood that this can be any type of sample holder or container, such as a test tube, a well or microwell in a plate, centrifuge tube, etc.

The present disclosure provides cuvette designs that can be used in an instrument capable of performing a plurality of clinical chemistry, hematology, and/or immunoassays. Preferably, it is a multi-modal instrument capable of running assays of all these types.

The cuvettes of the present disclosure are designed to be used in photometric and radiometric assays (the words “photometry,” and “photometric” are used interchangeably herein). These assays involve the detection of light intensity as a means of quantifying an analyte. This broadly includes absorption, scattering, polarization, fluorescence, and luminescence-based assays, which have been widely adopted as tools for determining concentrations of analytes in both human and animal biological samples such as, for example, blood, urine, and saliva, to name just a few. In vitro diagnostic devices using photometric detection techniques have been developed for a large variety of clinical biomarkers.

An aspect of the present disclosure includes a cuvette for use in photometric measurements.

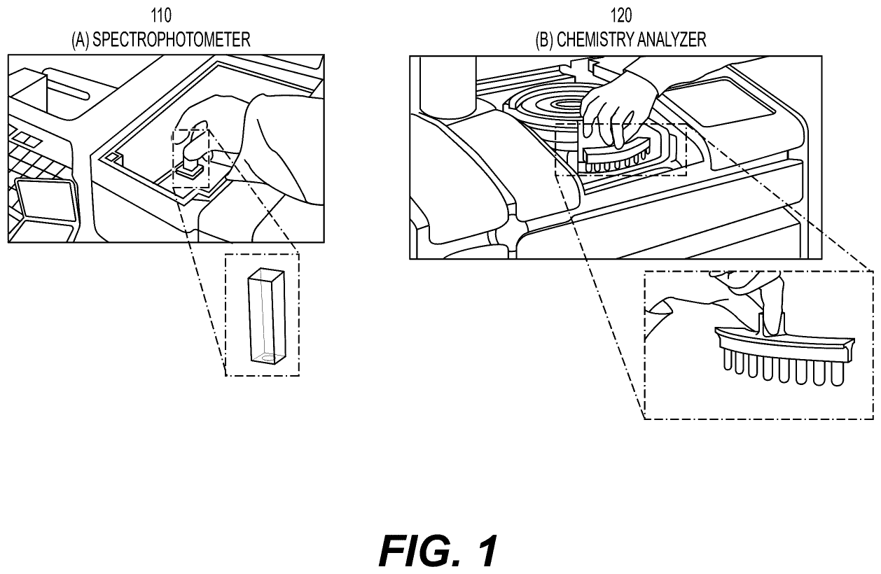

FIG. 1 shows a spectrophotometer, chemistry analyzer, and cuvettes for use regarding the same, according to one or more embodiments. Spectrophotometer 110 may measure quantity of light for a specific wavelength from a sample. Chemistry analyzer 120 may measure the concentration of substances in fluids and biological samples described herein. Spectrophotometer 110 and chemistry analyzer 120 may be photometric and radiometric assays described herein.

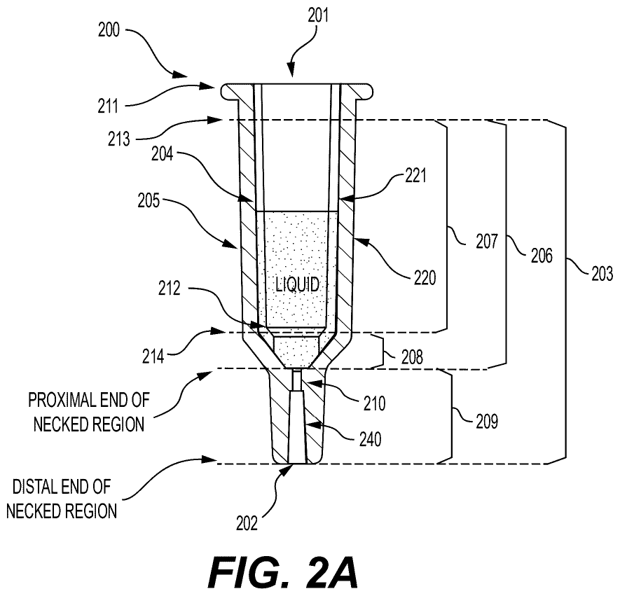

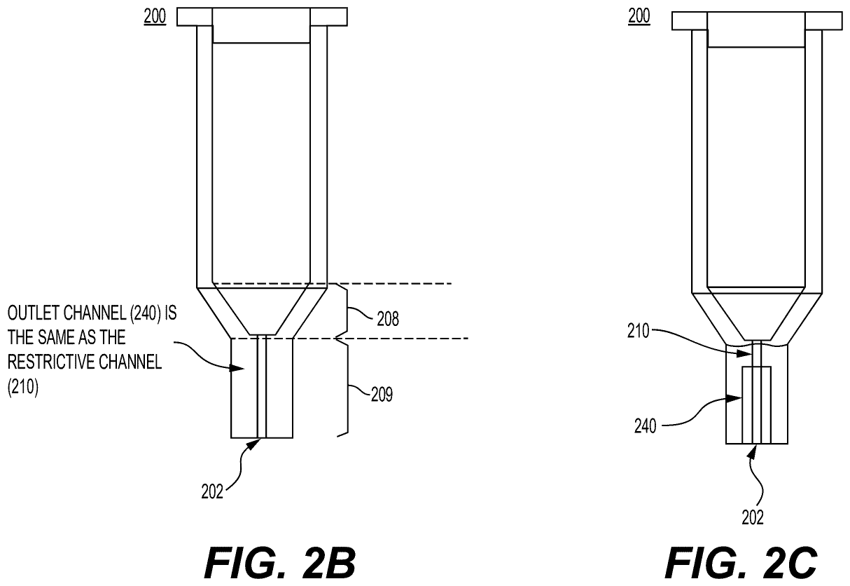

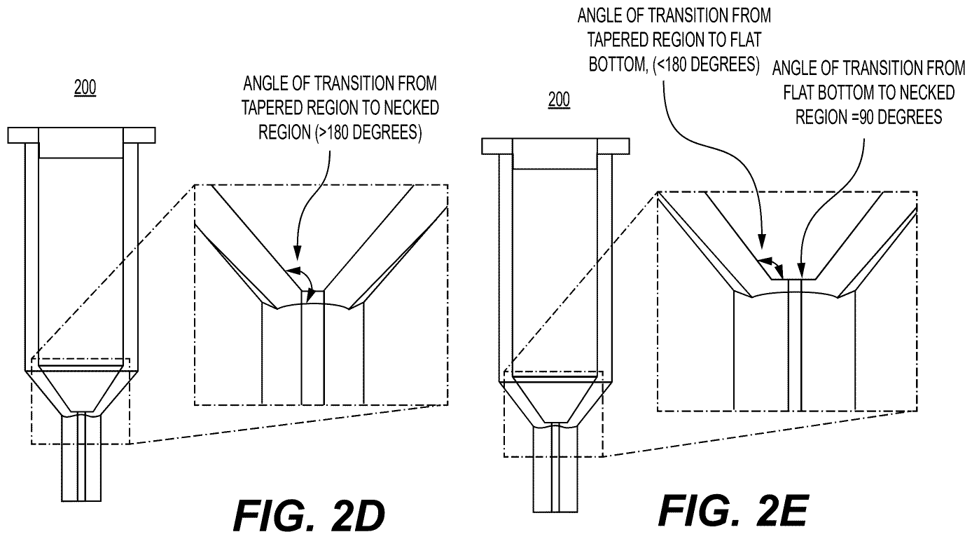

Referring to FIG. 2A, an example of the cuvette of the present disclosure includes cuvette 200 comprising an inlet 201, an outlet 202, and a body 203. Cuvette 200 may include inlet 201, outlet 202, body 203, wall inner surface 204, wall outer surface 205, inlet chamber 206, interrogation chamber 207, tapered region 208, necked region 209, restrictive channel 210, peripheral rim 211, taper angle 212, interrogation chamber proximal 213, interrogation chamber distal 214, wall outer surface 220, wall inner surface 221, and outlet channel 240. FIG. 2B shows an outlet channel and the restrictive channel of a cuvette, according to one or more embodiments. Cuvette 200 may include tapered region 208, necked region 209, outlet 202, restrictive channel 210, and outlet channel 240. Outlet channel 240 may be the same as restrictive channel 210. FIG. 2C shows a restrictive channel of a cuvette at the top of a necked region, according to one or more embodiments. Cuvette 200 may include outlet 202, restrictive channel 210, and outlet channel 240. Restrictive channel 210 may be at the top of a necked region, and outlet channel 240 may be below the restrictive channel 210. FIG. 2D shows tapered region of a cuvette makes a gradual and smooth transition, according to one or more embodiments. The angle of transition from tapered region to necked region may be greater than 180 degrees. FIG. 2E a tapered region of a cuvette which transitions to a flat section, according to one or more embodiments. The angle of transition from tapered region to flat bottom may be less than 180 degrees. The angle transition from flat bottom to necked region may be equal to 90 degrees. The design of the cuvette allows for prevention of trapped air bubbles inside of the cuvette; complete drainage of the cuvette after measurement of the sample leaving behind no residual fluid; elimination of sharp edges or corners where fluid may pool; maintaining fluid within the interrogation region for as long as desired, but to exit the cuvette upon application of an additional pressure drop across the outlet, and provides an optical path length for a light beam traversing its width that is sufficient for the desired photometric assay(s). Additionally, the design and orientation of the cuvette is such that gravity ensures that fluids provided through the inlet enter and uniformly fill the inlet chamber 206 and the interrogation region 207. The cuvette also includes a restrictive channel 210 located in the necked region 209 of the cuvette. This restriction helps maintain all the liquid in the inlet chamber while the liquid is being processed.

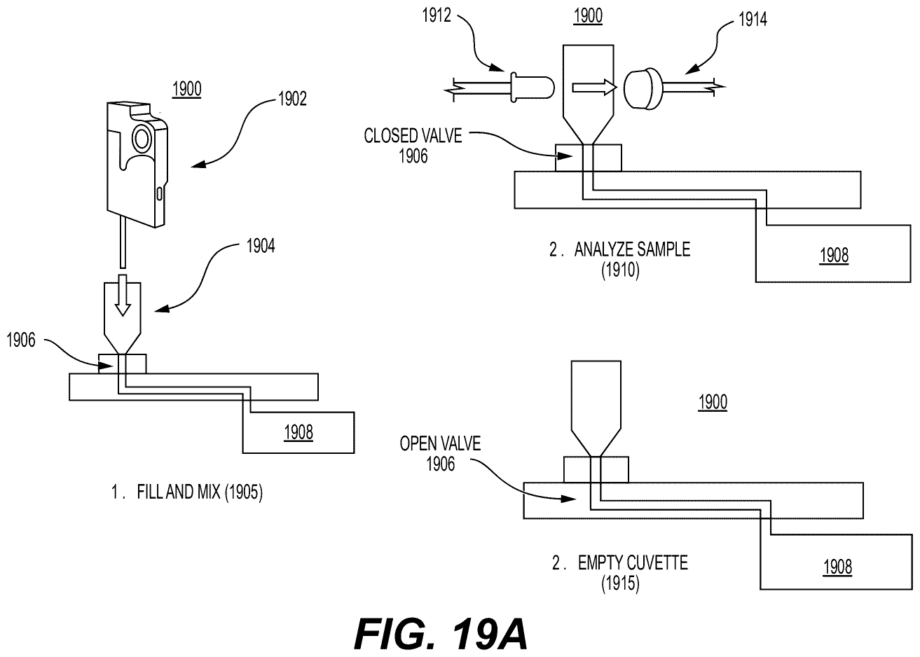

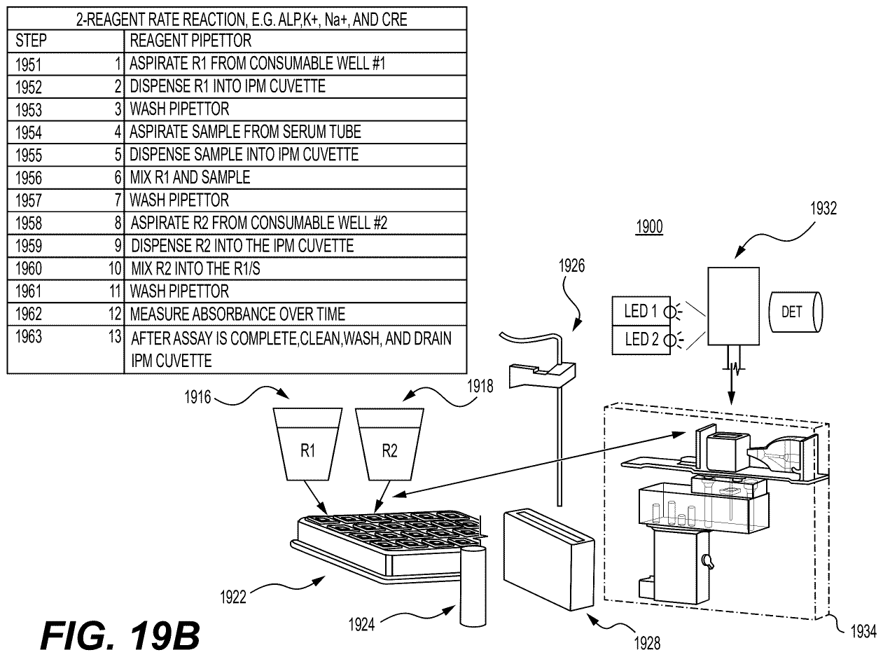

The cuvette design also allows for processing of the sample and measurement of a sample in a single cuvette design. For example, as shown in a workflow of use of the cuvette in a cuvette module of FIG. 19, the cuvette of the present disclosure allows pipetting and active mixing of reagents and the sample inside a single cuvette prior to or during measurement of the sample.

The cuvette is designed so that when it is placed into a corresponding cuvette module, and loaded with the expected fluid volume (e.g. sample, reagents, or sample+reagents), the liquid volume fills the inlet chamber comprising the interrogation region 207 that is proximal to the position of a light emitter and a detector.

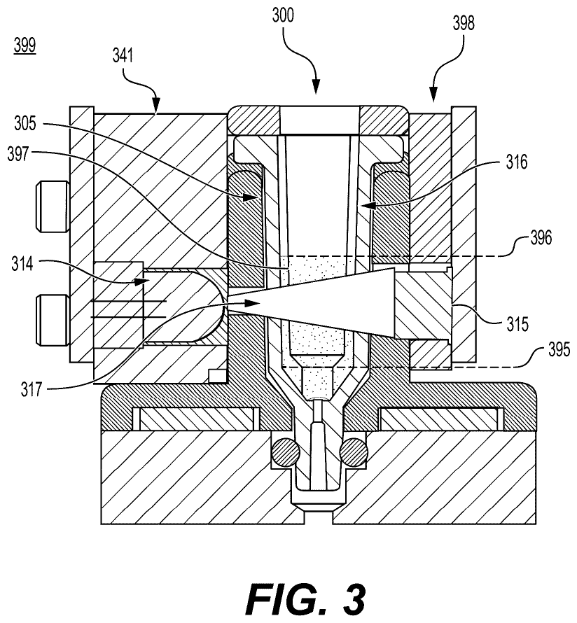

FIG. 3 shows a cross-sectional view of an exemplary cuvette design of the present disclosure positioned so that it is proximal to a light-emitter and a detector, along with a cone of light from the emitter, according to one or more embodiments. System 399 may include cuvette 300, first wall outer surface 305, emitter 314, detector 315, second wall outer surface 316, cone of light 317, emitter spacer 341, top of cuvette tapered region 395, top of liquid volume 396, liquid volume 397, and detector spacer 398. For example, as shown in FIG. 3, when a cuvette 300 is filled with a desired volume of a fluid, the emitter and detector are positioned such that they are approximately halfway between the cuvette taper and the top of the liquid volume, so that the cone of light from the emitter is not disturbed by the liquid/air meniscus, or the taper of the cuvette. Additionally, the cuvette of the present disclosure is designed such that the sample can be processed and optically measured at the same time. Alternatively, the sample can also be processed first within the cuvette, followed by measuring the sample.

A feature of this cuvette is that the interrogation region of the inlet chamber of the cuvette does not require a pressure gradient to fill it since it relies on gravity to allow fluid, once received by the inlet of the cuvette, to fill the inlet chamber, which contains the interrogation region. In some embodiments, the capillary pressure created by a liquid/air interface at the outlet of the necked region of the cuvette is greater than the force of gravity acting on the liquid, thereby preventing the liquid from leaving the cuvette. In some embodiments, the cuvette includes a restrictive channel positioned between the tapered region of the cuvette and the outlet channel of the necked region. In some embodiments, the capillary pressure created by a liquid/air interface at this restrictive fluidic channel is greater than the force of gravity acting on the liquid, thereby preventing the liquid from leaving the cuvette for as long as desired during processing. The cuvette can be emptied by applying a pressure drop across the fluid (e.g. with a pump).

As shown in FIG. 2A, the body includes an inlet chamber 206 that contains an interrogation region. The body also contains a tapered region and a necked region. The necked region contains an output channel and a restrictive channel that is proximal to the inlet chamber. In one aspect of the cuvette design, the restrictive channel is small enough in diameter and/or has a low-enough surface energy that a liquid/air interface formed at the restricted region creates an upward force greater than or equal to the force of gravity pushing the liquid down, so that liquid stays in the inlet chamber and does not leave the cuvette. FIGS. 2B-2C show examples of cuvettes with necked regions having restrictive channels, according to one or more embodiments. In FIG. 2B the outlet channel 240 and the restrictive channel 210 are one-and-the same, and the channel spans the full-length of the necked region; in FIG. 2C the restrictive channel 210 is at the top of the necked region, proximal to the tapered region, and is in series with a larger-diameter outlet channel 240. FIGS. 2D-2E show cuvettes in which the tapered region makes a gradual and smooth transition to the restrictive channel of the necked region, according to one or more embodiments. FIGS. 2D-2E show examples of cuvettes in which FIG. 2D the tapered region makes a gradual and smooth transition to the restrictive channel of the necked region. For FIG. 2E the tapered region transitions to a flat section, and there is an abrupt transition to the restrictive channel of the necked region.

### Cuvette Inlet

As shown in FIGS. 2A-2D, the cuvette includes an inlet end comprising an inlet 201 open to the atmosphere. The inlet is configured to receive a sample dropped or dispensed into the inlet from above the cuvette, wherein the fluid enters the inlet chamber under the influence of gravity. The cuvette can be positioned within a cuvette module such that fluids can be pipetted into the inlet and the interrogation region of an inlet chamber will fill the interrogation region under the influence of gravity. In some embodiments, the fluid can be dropped, e.g., via gravity, into the inlet, from above the cuvette. In some embodiments, the fluid can be dispensed, e.g., through a pipettor, into the inlet, from above the cuvette. Once the fluid is either dropped or dispensed into the inlet of the cuvette, the inlet chamber comprising an interrogation region fills with fluid under the influence of gravity to a level determined only by the force of gravity. In other words, once the fluid is dropped or dispensed into the inlet of the cuvette, the fluid equilibrates at the same level in the inlet chamber under influence of gravity.

For example, the size and orientation of the inlet chamber and interrogation region are such that the force of gravity within them is larger than any other forces within them (such as surface tension and capillary forces); therefore liquid uniformly fills these volumes without entrapment of air bubbles.

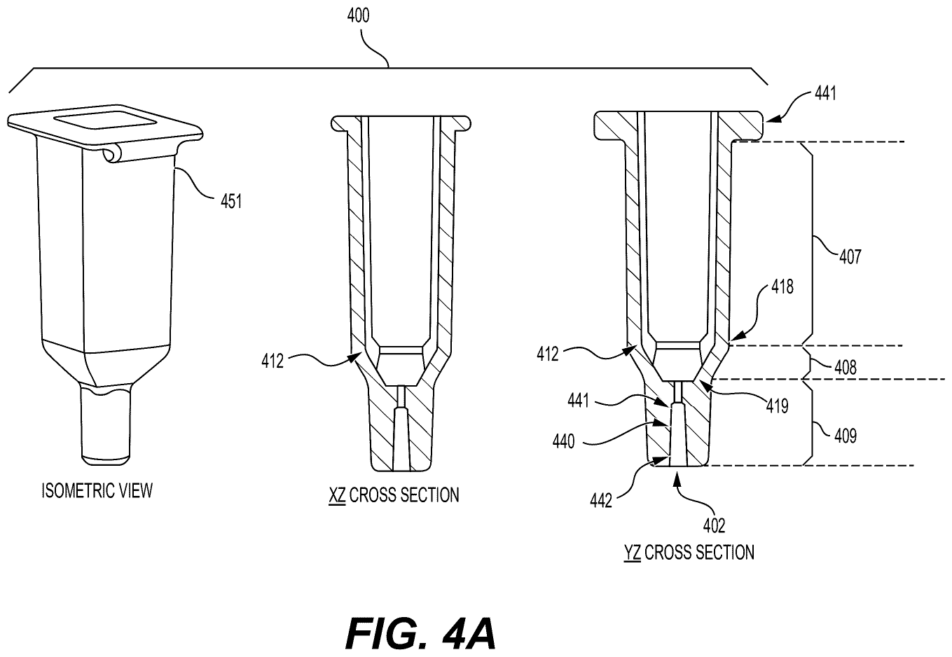

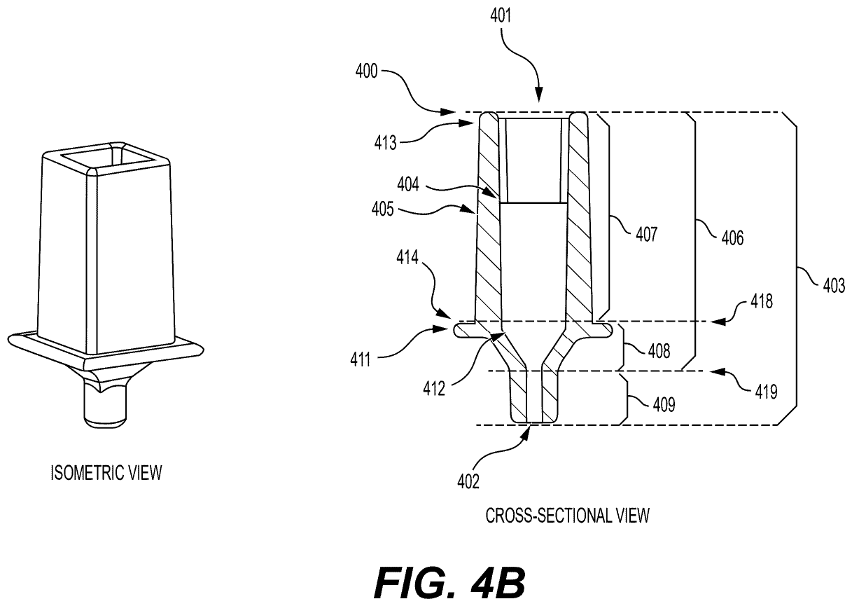

FIGS. 4A-4B provides isometric and cross-sectional views of cuvette design of the present disclosure, where the cuvette design can be injection moldable, according to one or more embodiments. FIG. 4A shows the cuvette including a peripheral rim surrounding the inlet end of the cuvette, and a connection point comprising an obtuse angle between the distal end of the interrogation region and the proximal end of the tapered region of the cuvette, according to one or more embodiments. Cuvette 400 may include tapered angle connection point 412, proximal end of outlet channel 441, outlet channel 440, distal end of outlet channel 442, outlet 402, distal end of tapered region 419, necked region 409, tapered region 408, proximal end of tapered region 418, interrogation region 407, and peripheral rim 411, and thicker area for gating the part 451. FIG. 4B depicts isometric and cross-sectional views of a cuvette design according to one or more embodiments, where the cuvette can include a peripheral rim surrounding the cuvette, and positioned at the proximal end of the tapered region. Cuvette 400 may include inlet 401, outlet 402, body 403, wall inner surface 404, wall outer surface 405, inlet chamber 406, interrogation region 407, tapered region 408, necked region 409, peripheral rim 411, taper angle 412, interrogation region proximal 413, interrogation region distal 414, proximal end of tapered region 418, and distal end of tapered region 419.

In some embodiments, the inlet end further comprises an indexing feature. In certain embodiments, the indexing feature is positioned at the proximal end of the interrogation region (e.g., closest to the inlet). In certain embodiments, as shown in FIG. 4A, the indexing feature comprises a peripheral rim 411 surrounding the inlet. In some embodiments, the peripheral rim 411 comprises a lip extending radially outward from the cuvette. In some embodiments, the purpose of the indexing feature is to index the cuvette against a hard stop that prevents movement of the cuvette. In some embodiments, the indexing feature is connected to the first and second walls of the cuvette. In some embodiments, the indexing feature, as shown in FIG. 4B, is positioned at the distal end of the interrogation region.

As described herein, the inlet is open directly to atmosphere and is sized appropriately to allow a sample or reagent to flow through the inlet from a pipettor or any other vessel such as a cartridge. The width of the inlet is sized appropriately such that a pipettor can easily access the inlet opening. In some embodiments, the inlet opening is between 3 mm and 10 mm in width. Moreover, the opening of the inlet and the inlet chamber are sized appropriately such that the interrogation region of the cuvette may be filled under the influence of gravity, with fluid without creating air bubbles in the interrogation region, and so that fluids may be mixed e.g., by mechanical stirring.

### Cuvette Body

In some embodiments, of the present disclosure, as shown in FIG. 2, the cuvette, 200, includes a body 203 connected to the inlet end. The body is composed of walls surrounding the cuvette, with each wall having an inner surface 204 and an outer surface 205. In some embodiments, the body portion of the cuvette includes an inlet chamber, 206, and the inlet chamber 206 includes an interrogation region 207, and a tapered region 208. In some embodiments, the body portion includes a necked region 209 having an output channel 240. In some embodiments, the necked region has a restrictive channel, 210, wherein the inner diameter of the restrictive channel is smaller than that of the output channel.

### Inlet Chamber

As shown in FIG. 2, the inlet chamber comprises an interrogation region 207 that includes a proximal end and a distal end. The proximal end 213 of the interrogation region is positioned near or at the inlet 201 end of the cuvette, while the distal end 214 of the interrogation region is positioned near or at the beginning of the tapered region 208. The walls at the interrogation region include a first wall and a second wall opposite the first wall, which, depending on the position of a light source, allows for transmission of light through the first wall and the second wall of the interrogation region. In some embodiments, the first and second walls of the interrogation region are substantially flat (see e.g., walls proximal to the interrogation region in FIG. 2). As shown in FIG. 3, the interrogation region is designed and dimensioned to accept light from an emitter 314 from one side of the cuvette and allow it to pass through the cuvette 300 to a light detector 315 on the opposite side of the cuvette without obstruction.

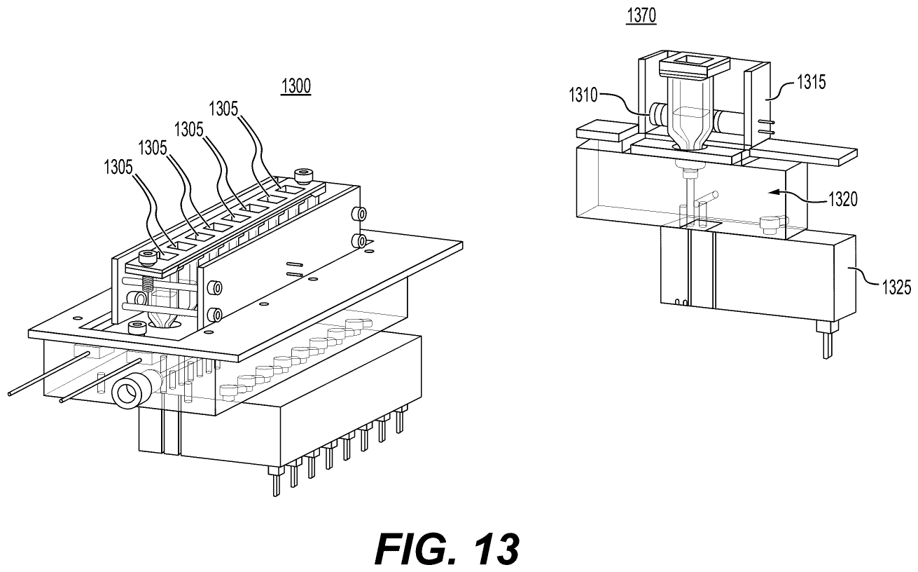

For example, as shown in FIG. 3 and FIG. 13, if the light source 314 is closest to the first wall (left-most wall 305 of FIG. 3), light will first transmit through a first wall 305, through the center of the interrogation region of the cuvette, and then through a second wall (right-most wall 316 of FIG. 3). In this example, an optical detector 315 is situated proximal to the second wall 316. FIG. 3 also shows a cone of light 317 transmitted through the interrogation region. In some embodiments, the optical path length of the interrogation region ranges from 1-20 mm, such as 1-10 mm, 5-10 mm, 7-10 mm, 10-15 mm, 5-12 mm, and 8-15 mm. In some embodiments, the optical path length of the interrogation region is 1 mm or more, 1.5 mm or more, 2 mm or more, 2.5 mm or more, 3 mm or more, 3.5 mm or more, 4 mm or more, 4.5 mm or more, 5 mm or more, 5.5 mm or more, 6 mm or more, 6.5 mm or more, 7 mm or more, 7.5 mm or more, 8 mm or more, 8.5 mm or more, 9 mm or more, 9.5 mm or more, 10 mm or more, 10.5 mm or more, 11 mm or more, 11.5 mm or more, 12 mm or more, 12.5 mm or more, 13 mm or more, 13.5 mm or more, 14 mm or more, 14.5 mm or more, 15 mm or more, 15.5 mm or more, 16 mm or more, 16.5 mm or more, 17 mm or more, 17.5 mm or more, 18 mm or more, 18.5 mm or more, 19 mm or more, or 20 mm or more. Path lengths will vary depending on the assay being used. For example, a longer optical path length may be optimal for assays with lower concentrations of the sample. In contrast, a shorter path length may be optimal for assays with higher concentrations of the sample. As another non-limiting example, a shorter path length may be optimal for assays that require a high level of light absorbance.

### Tapered Region

Referring to FIG. 4B, the body 403 of the cuvette 400 further includes a tapered region 408. The tapered region 408 includes a proximal end and a distal end as shown in FIG. 4A. The proximal end 418 is positioned near or closest to the distal end of the interrogation region 407, while the distal end 419 of the tapered region is positioned near or closest to the outlet 402 or an optional necked region 409 of the cuvette. For example, the tapered region 408 is positioned at the distal end of the interrogation region 407, with the inner surface of the wall at the tapered region tapering inward from the proximal end of the tapered region 408 to a narrowed section at the distal end 419 of the tapered region. The tapered region 408 is between the interrogation region 407 surfaces and the outlet 402 of the cuvette. This tapered transition region can include a connection point 412 shaped to promote fluid-elimination when the cuvette is drained from the outlet 402. In some embodiments, the tapered transition region creates a smooth transition from the interrogation region 407 to the neck of the cuvette, thereby eliminating corners and crevices that might otherwise cause fluid to become trapped when it is drained from the cuvette.

In some embodiments, as shown in FIG. 2, and FIGS. 4A-4B, an obtuse angle (212 and 412) is formed between the inner surface of the first and second walls (204 and 221) at the tapered region 208 and the inner surface of the first wall 204 and second wall 221 at the interrogation region 207. This obtuse angle provides for complete drainage of the sample from the cuvette once the sample is measured. In some embodiments, the obtuse angle between the inner surface of the wall of the tapered region and the inner surface of the first wall and the second wall of the interrogation region ranges from 130 to 179 degrees. For example, the obtuse angle between the inner surface of the wall of the tapered region and the inner surface of the first wall and the second wall of the interrogation region can be at least 130 degrees, at least 135 degrees, at least 140 degrees, at least 145 degrees, at least 150 degrees, at least 155 degrees, at least 160 degrees, at least 165 degrees, at least 170 degrees, or at least 175 degrees. In some embodiments, as shown in FIGS. 4A-4B, the cuvette comprises a connection point 412 between the distal end of the interrogation region and the proximal end of a tapered region, wherein the connection point comprises the obtuse angle ranging from 130 to 179 degrees. In some embodiments, the obtuse angle prevents liquid from getting trapped through the surface energy interaction with the walls of the cuvette and thus allows for fluid to flow down the cuvette.

In some embodiments, the cuvette further comprises fillets and/or chambers on all internal surfaces of the cuvette to eliminate sharp edges or corners where liquid can pool.

### Necked Region

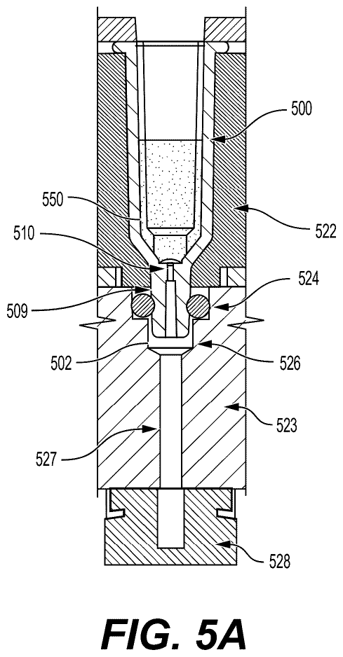

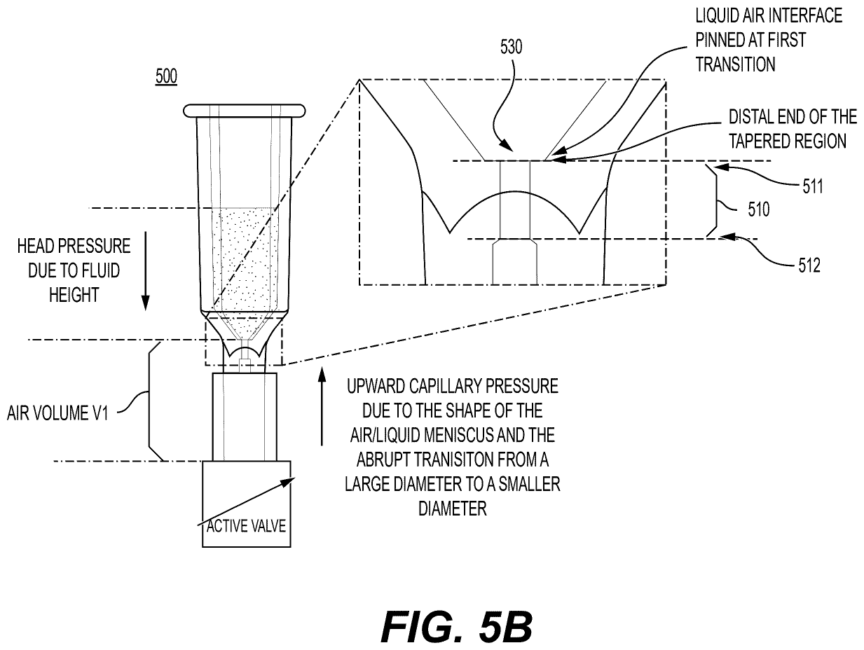

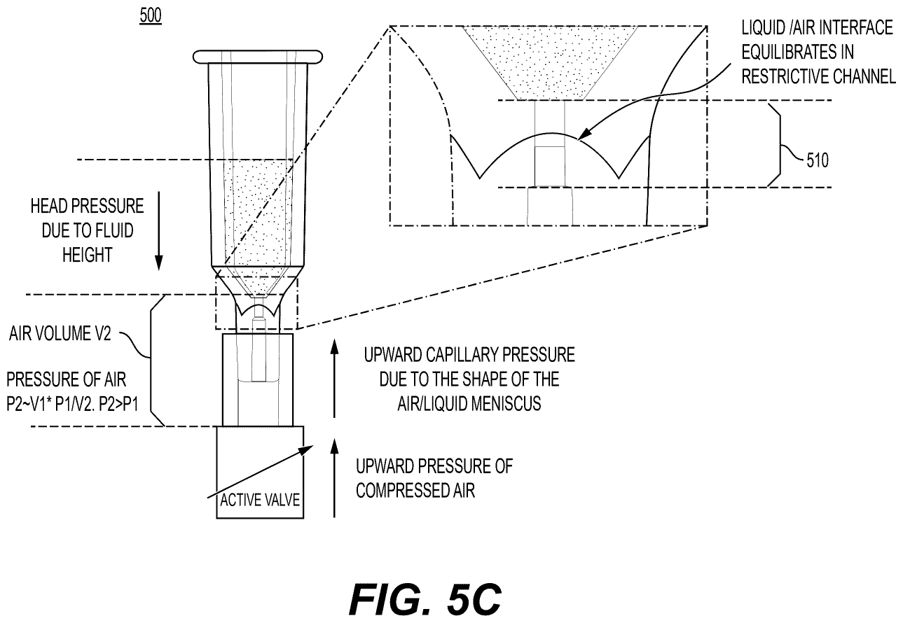

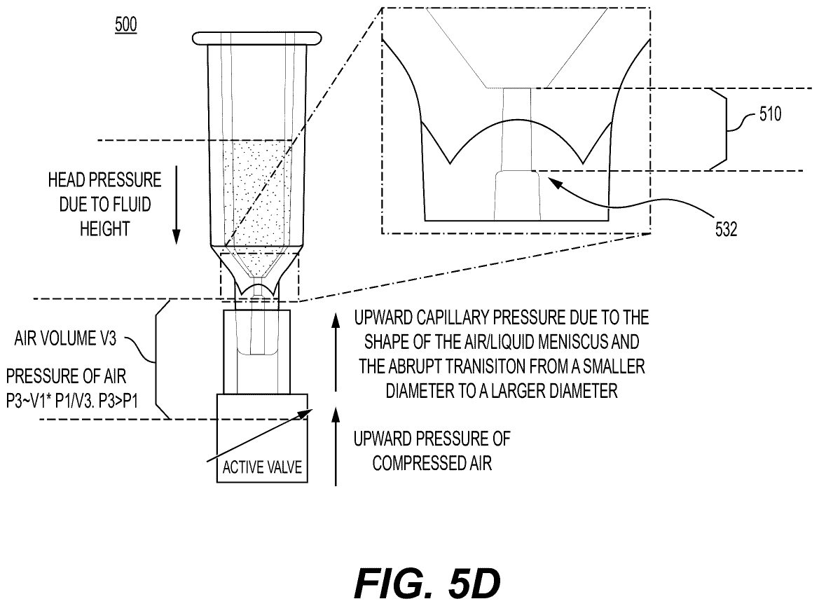

FIG. 5A-5D show a cross-sectional views of acuvette design of the present disclosure that is fluidically connected to a downstream active valve, according to one or more embodiments. FIG. 5A shows a cross-sectional view of a cuvette design, according to one or more embodiments. Cuvette 500 may include liquid contained in inlet chamber 550, restrictive channel 510, cuvette neck 509, outlet 502, central channel 527, housing 522, O-ring 524, neck chamber 526, manifold 523, and active valve 528. Central channel 527 may be a channel or tube leading to the valve. Neck chamber 526 may be a neck chamber into which the neck of the cuvette protrudes.

FIG. 5B illustrates the forces on the liquid when the liquid has filled the cuvette up to the opening of the restrictive channel in the necked region, according to one or more embodiments. Cuvette 500 may include capillary valve 530, and may include restrictive channel 510 with proximal end 511 and distal end 512. Cuvette 500 may include a liquid/air interface pinner at the first transition and may include a distal end of the tapered region. Head pressure due to fluid height may be oriented in a first direction, and upward capillary pressure due to the shape of the air/liquid meniscus and the abrupt transition from a large diameter to a small diameter may be oriented in a second direction opposite the first direction.

FIG. 5C shows the forces on the liquid when the liquid has entered the restrictive channel in the necked region, according to one or more embodiments. Cuvette 500 may include restrictive channel 510. Cuvette 500 may provide that a liquid/air interface equilibrates in the restrictive channel. Head pressure due to fluid height may be oriented in a first direction, and upward capillary pressure due to the shape of the air/liquid meniscus and upward pressure of compressed air may be oriented in a second direction opposite the first direction.

FIG. 5D show the forces acting on the liquid when the liquid has filled the restrictive channel, according to one or more embodiments. Cuvette 500 may include a restrictive channel 510 and a capillary valve 532. Head pressure due to fluid height may be oriented in a first direction, and upward capillary pressure due to the shape of the air/liquid meniscus and the abrupt transition from a small diameter to a larger diameter and upward pressure of compressed air may be oriented in a second direction opposite the first direction.

In some embodiments, the body of the cuvette further comprises a necked region 209 positioned at the distal end of the tapered region 208. In some embodiments, the necked region 509 allows for sealing to a manifold 523. For example, as shown in FIG. 5A, the necked region may be used to create a radial seal with a manifold 523 through use of an O-ring 524.

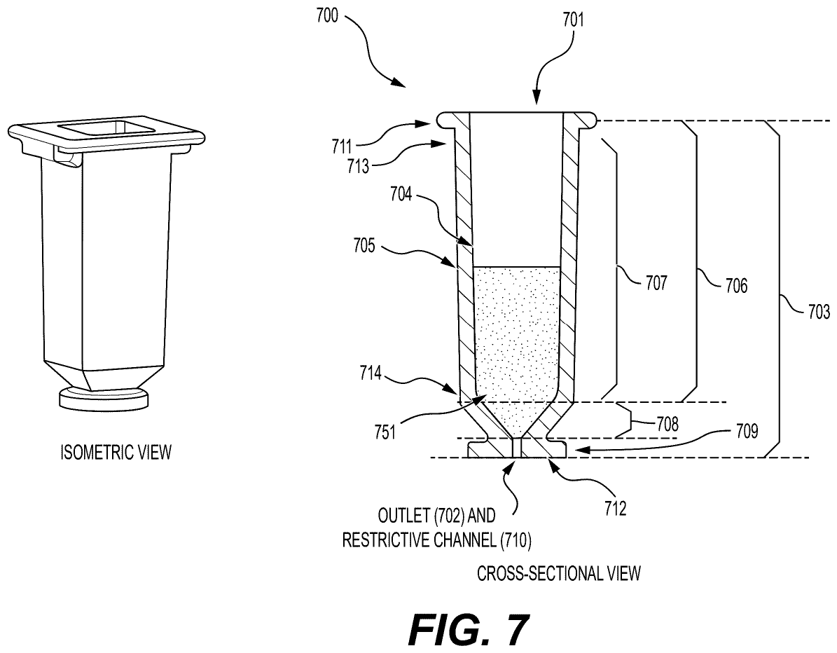

In some embodiments, the necked region contains a channel that comprises an outlet 202 at the distal end of the necked region. In certain embodiments, the necked region contains an elongated outlet channel as shown, for example, in FIGS. 2A-2E and 4A-4B. In certain embodiments, the necked region contains a short outlet channel as shown in FIG. 7. In certain embodiments, the short necked region that includes a channel comprises a length ranging from 0 to 2 mm. In certain embodiments, the long necked region comprises a length ranging from 2 to 10 mm. In some embodiments, the necked region comprising a channel comprises an inner diameter at the proximal end of the channel that is smaller than at the distal end of the channel. In some embodiments, the necked region comprises an outlet channel 240 and a restrictive channel 210 that are in series with each other. In some embodiments, the outlet channel comprises an inner diameter at the proximal end of the outlet channel that is smaller than the distal end of the outlet channel. In some embodiments, the outlet channel comprises an inner diameter at the proximal end of the outlet channel that is bigger than the distal end of the outlet channel. In some embodiments, the restrictive channel comprises an inner diameter at the proximal end of the restrictive channel that is smaller than the distal end of the restrictive channel. In some embodiments, the restrictive channel comprises an inner diameter at the proximal end of the restrictive channel that is bigger than the distal end of the restrictive channel.

In some embodiments, the necked region comprises a restrictive channel that is between 0.5 and 4 mm in length, and has an inner diameter between 0.1 mm and 1 mm.

In some embodiments, the necked region of the cuvette further comprises an outlet channel that is fluidically connected to the restrictive channel having a smaller diameter than the outlet channel. In some embodiments, the fluidic channel(s) of the necked region create a passage between the tapered region of the cuvette and the outlet. In some embodiments, the restrictive channel 210 creates a passage between the tapered region 208 of the cuvette and the outlet channel 240.

In certain embodiments, the restrictive channel 210 of the cuvette is created by inserting a restrictive element into the necked region of the cuvette, the restrictive element having an opening that is between 0.1 mm and 1 mm in diameter, and a length ranging between 0.5 and 4 mm.

In some embodiments, the outlet channel is the same as the restrictive channel, comprising a single small diameter channel that joins the tapered region of the cuvette to the outlet of the cuvette, for example FIG. 2B. In some embodiments, the necked region of the cuvette comprises two channels having different inner diameters: an outlet channel comprising an inner diameter, and a restrictive channel comprising an inner diameter that is smaller than the inner diameter of the outlet channel, which may be seen in FIG. 2A and FIG. 2B. In some embodiments, the restrictive channel is positioned within the necked region. In some embodiments, the restrictive channel comprising a smaller inner diameter is positioned between the tapered region 208 and the outlet channel 240. (FIG. 2A and FIG. 2C)

In some embodiments, the tapered region of the cuvette gradually narrows to a small channel with a smaller inner diameter of the necked region, for example as seen in FIG. 2D. In other embodiments, there is a sudden step change from the tapered region of the cuvette to the small inner diameter channel of the necked region, for example as seen in FIG. 2E.

In some embodiments, the restrictive channel comprising a smaller first inner diameter positioned proximal to the tapered region of the cuvette exhibits a step change to an outlet channel with a larger internal diameter, for example as seen in FIG. 2C. In some embodiments, there is a step change at the distal end of the outlet channel 240 of the necked region comprising the transition from the inner diameter of the outlet to the atmosphere, for example as seen in FIG. 2B and FIG. 2C).

In some embodiments, the necked region comprises a restrictive channel with a minimum inner diameter ranging from 0.01 mm to 2 mm. In some embodiments, the necked region comprises a restrictive channel with an inner diameter ranging from 0.01 mm to 1 mm. In some embodiments, the necked region comprises a restrictive channel with an inner diameter ranging from 0.01 mm to 0.5 mm. In some embodiments, the necked region comprises a restrictive channel with an inner diameter ranging from 0.2 mm to 1 mm. In some embodiments, the necked region comprises a restrictive channel with an inner diameter of 0.01 mm, 0.05 mm, 0.06 mm, 0.07 mm, 0.08 mm, 0.09 mm, 0.1 mm, 0.15 mm, 0.2 mm, 0.25 mm, 0.3 mm, 0.35 mm, 0.4 mm, 0.45 mm, 0.5 mm, 0.55 mm, 0.6 mm, 0.65 mm, 0.7 mm, 0.75 mm, 0.8 mm, 0.85 mm, 0.9 mm, 0.95 mm, 1 mm, 1.1 mm, 1.2 mm, 1.3 mm, 1.4 mm, 1.5 mm, 1.6 mm, 1.7 mm, 1.8 mm, 1.9 mm, or 2 mm.

### Cuvette Outlet Channel

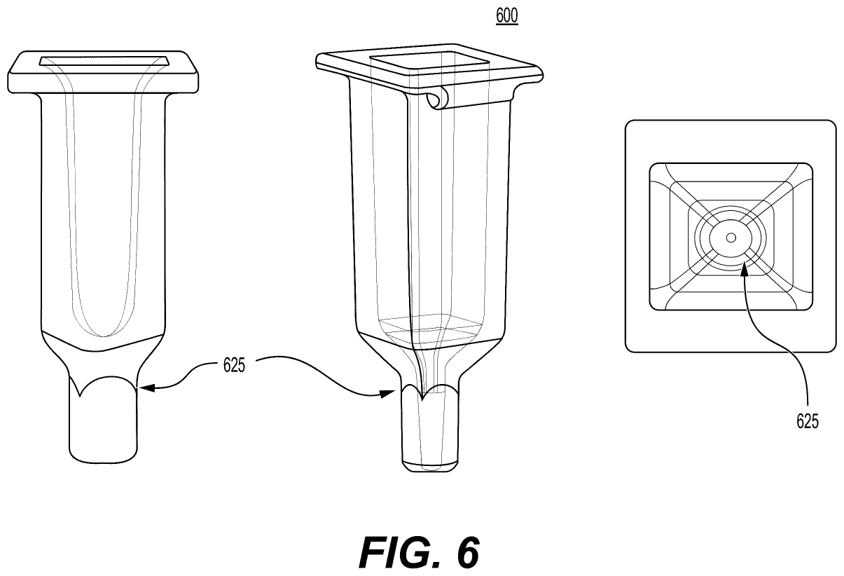

FIG. 6 shows an example of a cuvette having a necked region with a relatively large inner diameter, into which a restrictive element has been press-fit, according to one or more embodiments. Cuvette 600 may include restrictive element 625. Restrictive element 625 may be a restrictive element or passive valve press-fit into the neck of the cuvette.

With reference to FIG. 2, FIGS. 4A-4B, and FIGS. 6A-6B, the cuvette of the present disclosure comprises an outlet channel that includes an outlet 202. The outlet of the cuvette is configured to allow the sample to exit the cuvette. In some embodiments, the outlet is positioned at the distal end of the outlet channel. In some embodiments, the inner diameter of the outlet 402 (or inner diameter of the outlet channel) is sufficiently small to prevent fluid from passing through the outlet 402 during measuring and/or processing of the sample. In some embodiments, the inner diameter of the outlet 402 is configured to cause surface tension to keep the fluid in the inlet chamber. For example, the size of the outlet 402 is configured so that the upward force due to the capillary pressure between the fluid/solid and fluid/air interfaces at the outlet 402 are equal to the gravitational force of the fluid above the outlet (e.g., in the interrogation region), thus preventing the fluid from draining from the cuvette under the influence of gravity. In some embodiments, the surface tension of cuvette outlet 202 is configured to maintain fluid in the interrogation region of the cuvette.

In some embodiments, the internal diameter (inner diameter) of the outlet channel is configured to elicit capillary force at the outlet channel that is equal to the gravitational force of the fluid above the outlet, thus maintaining the fluid in the inlet chamber and preventing the fluid from draining from the cuvette under the influence of gravity. In some embodiments, the surface energies between the liquid/solid and liquid/air interfaces at the outlet channel is configured to prevent the fluid from draining from the cuvette under the influence of gravity. In some embodiments, both the size of the inner diameter of the outlet channel and the surface energies between the liquid/solid and liquid/air interface at the outlet channel are configured to prevent the fluid from draining from the cuvette under the influence of gravity.

In some embodiments, the outlet end of the cuvette is configured to be deformable such that it is capable of opening and closing.

In some embodiments, the cuvette may be fabricated, e.g. by injection molding, or machining, so that the outlet channel in the necked region of the cuvette has a relatively large inner diameter (for example, 1 mm-2 mm). In this case, the outlet channel may be further constricted by press-fitting or gluing a short length of a restrictive element (such as a short length of drawn tubing) into the neck, as illustrated in FIG. 6. This method permits the outlet of each cuvette to be adjusted to any desired inner diameter, based on factors that may include the viscosity and surface tension of the liquids contained therein. Furthermore, it reduces the complexity of the injection molding or machining operations necessary to fabricate the cuvettes. Furthermore, it enables different materials to be used for the cuvette and the restrictive element. For instance, a short length of tubing of one material may be press-fit into the outlet channel of a cuvette made of a different material as shown in FIG. 6. On the other hand, this method does require an additional assembly step. Therefore, in alternative embodiments of the cuvette design the necked region of the cuvette comprises a monolithic restrictive channel as illustrated in FIG. 2.

In some embodiments, the outlet (or outlet channel) comprises an opening with an inner diameter ranging from 0.01 mm to 2 mm. In some embodiments, the outlet comprises an opening with an inner diameter ranging from 0.01 mm to 1 mm. In some embodiments, the outlet comprises an opening with an inner diameter ranging from 0.01 mm to 0.5 mm. In some embodiments, the outlet comprises an opening with an inner diameter ranging from 0.2 mm to 1 mm. In some embodiments, the outlet comprises an opening with an inner diameter of 0.01 mm, 0.05 mm, 0.06 mm, 0.07 mm, 0.08 mm, 0.09 mm, 0.1 mm, 0.15 mm, 0.2 mm, 0.25 mm, 0.3 mm, 0.35 mm, 0.4 mm, 0.45 mm, 0.5 mm, 0.55 mm, 0.6 mm, 0.65 mm, 0.7 mm, 0.75 mm, 0.8 mm, 0.85 mm, 0.9 mm, 0.95 mm, 1 mm, 1.1 mm, 1.2 mm, 1.3 mm, 1.4 mm, 1.5 mm, 1.6 mm, 1.7 mm, 1.8 mm, 1.9 mm, or 2 mm.

In some embodiments, the outlet comprises an outer diameter (the outer-diameter of the necked region) ranging from 0.25 mm to 6 mm. In some embodiments, the outlet comprises an outer diameter ranging from 0.25 to 5 mm. In some embodiments, the outlet comprises an opening with an outer diameter ranging from 0.25 mm to 2 mm. In some embodiments, the outlet comprises an opening with an outer diameter ranging from 0.25 mm to 1.5 mm. In some embodiments, the outlet comprises an opening with an outer diameter ranging from 1.5 mm to 2 mm. In some embodiments, the outlet comprises an opening with an outer diameter of 2 mm, 2.5 mm, 3 mm, 3.5 mm, 4 mm, 4.5 mm, 5 mm, 5.5 mm, or 6 mm.

### Restrictive Channel

In some embodiments of the present disclosure, as shown in FIGS. 5B-5D, the cuvette, 600, includes a restrictive channel 510. In some embodiments, the restrictive channel is positioned/connected to the distal end of the tapered region and the outlet channel of the cuvette. In some embodiments, the combination of the restrictive channel and the abrupt transition (expansion or contraction) of the channel diameter constitutes a passive capillary valve 530. Thus, in some embodiments, the cuvette comprises a capillary valve, e.g., between the transition in diameter of the distal end of the tapered region and the diameter of the proximal end of the restrictive channel. FIG. 5B illustrates the forces on the fluid when the liquid has filled the cuvette up to the opening of the restrictive channel 510 in the necked region 509. The force of gravity acts to push the fluid down with a force proportional to the height of the fluid in the cuvette and the cross-sectional area of the outlet channel in the restrictive channel 510. An upward force also acts on the fluid, proportional to the surface tension of the fluid/air interface, the radius of the restrictive channel 510, and dependent upon the abrupt angle with which the transition from large to small diameter occurs. The equilibrium position of the fluid is at the entry to the restrictive channel, and all liquid is maintained in the inlet chamber of the cuvette. As the surface tension of the fluid/air interface increases, or the radius of the restrictive channel 510 decreases, the surface tension of the fluid/air interface becomes relatively more important than gravity, and the height of the fluid that can be maintained in the cuvette increases.

FIG. 5C shows a state in which the capillary pressure associated with the passive valve is insufficient to keep the liquid in the inlet chamber. Liquid therefore enters the restrictive channel in the necked region. As the liquid enters the restrictive channel, it compresses the air trapped between the liquid and a downstream active valve. The additional pressure generated by the compression of air adds to the capillary force associated with the liquid/air meniscus in the restrictive channel to create a force that opposes further egress of the liquid from the inlet chamber.

FIG. 5D shows a state in which liquid has continued to move out of the inlet chamber until it reaches the end of the restrictive channel. In this state, there is a second abrupt transition from a small diameter channel to a large diameter channel. This second transition constitutes a second capillary valve 532, and generates an additional capillary pressure that resists further egress of the liquid from the cuvette. Furthermore in this state the air trapped between the liquid and the active valve has been further compressed, resulting in additional force that resists the egress of liquid from the cuvette. Thus, in some embodiments, the cuvette comprises a second capillary valve, e.g., between the transition in diameter of the distal end of the restrictive channel and the diameter of the proximal end of the outlet channel.

In some embodiments, the passive valve 530 is created by insertion of a restrictive element into the necked region of the cuvette. An example of a restrictive region is shown as a restrictive element 625 in FIG. 6. In some embodiments, the restrictive element has an opening that is between 0.1 mm and 1 mm in diameter.

In some embodiments, the volume of air between the inlet chamber of the cuvette and the closed active valve ranges from 5 and 60 microliters. In some embodiments, the volume of air between the inlet chamber of the cuvette and the closed active valve is 50 microliters or less, 40 microliters or less, 30 microliters or less, 20 microliters or less, 10 microliters or less, 9 microliters or less, 8 microliters or less, 7 microliters or less, 6 microliters or less, or 5 microliters or less.

In some embodiments, the necked region has a passive valve (e.g., a restrictive channel) with a diameter small enough that liquid dropped or dispensed into the inlet of the cuvette does not fill or only partially fills the restricted opening of the restrictive channel in the necked region.

In some embodiments, the force that prevents liquid from displacing air in the restricted opening of the necked region is a capillary force. For example, it is the force that results from the geometric shape of the opening in the outlet, and from the surface tension between the liquid/solid interface.

In some embodiments, the force keeping the liquid from displacing air in the restricted opening of the necked region is the force due to the compression of the air that is trapped between the liquid in the cuvette and a downstream active valve.

In some embodiments, a combination of capillary and compressed-air forces is configured to keep the air in the restricted opening of the necked region from being displaced.

In some embodiments, the restrictive channel of the cuvette creates a passive capillary valve.

In some embodiments, the outlet of the cuvette is in fluidic communication with a tube or channel that can be opened and closed through means of an active valve.

In some embodiments, an active valve placed downstream of the cuvette may open and close, such that opening the active valve creates a fluid path from the outlet of the cuvette to a separate channel downstream of the valve, and closing the valve disconnects the outlet of the cuvette from the downstream channel and traps a small volume of air between the closed valve and the liquid in the cuvette.

In some embodiments, the volume of air trapped between liquid in the cuvette and the active valve is small, such that the head pressure of the liquid in the cuvette is substantially smaller than the increase in the air pressure that would result from the compression of air if fluid was to pass through the outlet channel of the cuvette comprising a small inner diameter.

In some embodiments, the pressurized air trapped between the active valve and liquid in the cuvette maintains the liquid in the inlet chamber of the cuvette and prevents the liquid from draining from the cuvette under the influence of gravity.

In some embodiments, the volume or pocket of air is trapped between the liquid in the inlet chamber of the cuvette and the active valve. In some embodiments, the volume or pocket of air is trapped between liquid in the restrictive channel and the active valve. In some embodiments, the volume or pocket of air is trapped between liquid in the outlet channel and the active valve.

The equilibrium position of the liquid/air meniscus in the restricted channel of the necked region is located at the point where the forces due to gravity, capillary pressure, and air-pressure balance one another. The choice of cuvette material and the type of liquid put into the cuvette will influence the capillary pressure. The cuvette shape and the volume of liquid put into the cuvette will change the height of the column of liquid in the cuvette, and so alter the force due to gravity. The volume of air trapped between liquid in the cuvette inlet chamber and an active valve influences the rate at which pressure increases when the air from the restrictive channel is displaced. In some embodiments, the cuvette and associated hardware (e.g. the location of the active valve) are configured such that liquid does not move down past the restrictive channel in the necked region.

For example, an exemplary cuvette of the present disclosure can hold a liquid column that is up to 2 cm in height. The head-pressure associated with a 2 cm tall liquid column of an aqueous solution is approximately 0.03 psi. Thus, in some embodiments, it is desirable that the combined capillary and compressed-air pressures at the restrictive channel be capable of counteracting a head pressure of 0.03 psi. In the exemplary embodiment, the volume of air trapped between the liquid in the cuvette and a downstream active valve is 50 microliters. When this volume is compressed to 49.9 microliters, an air pressure of 0.03 psi is generated. In other words, a change in the volume of air of just 0.1 microliters is sufficient to counteract a 2 cm head pressure. Therefore, if the restrictive channel in the cuvette has an internal volume greater than 0.1 microliters, liquid will not fill the restrictive channel under the influence of gravity. For example, a restrictive channel having an inner diameter of 0.5 mm and a length of 1 mm has an internal volume of 0.19 microliters, which is almost twice the volume necessary to ensure that no liquid passes through the restrictive channel.

As another example, if the volume of air trapped between the liquid in the cuvette and the downstream active valve is bigger, a larger amount of air must be compressed to generate the same air-pressure. For instance, if the volume of trapped air between the valve and the liquid in the cuvette is 500 microliters, 1.0 microliter of air must be compressed to generate 0.03 psi. In this case, the restrictive channel of the previous example would need to also have a volume of at least one microliter to prevent liquid from being pushed past it.

In some embodiments, it is preferable to keep the restrictive channel short so that it is easy to manufacture by molding, and so that the cuvette can be emptied quickly when a pressure drop is applied across the restrictive channel. In some embodiments, it is preferable to keep the volume of air between the inlet chamber and the active valve small.

In some embodiments, the length of the restrictive channel is at least 1 mm. In some embodiments, the length of the restrictive channel ranges from 0.05 mm to 8 mm. In some embodiments, the restrictive channel comprises a length ranging from 0.5 mm to 5 mm. In some embodiments, the length of the restrictive channel ranges from 0.05 mm to 5 mm. In some embodiments, the length of the restrictive channel is at least 0.05 mm, at least 0.1 mm, at least 0.5 mm, at least 1 mm, at least 1.5 mm, at least 2 mm, at least 3 mm, at least 4 mm, at least 5 mm, at least 6 mm, at least 7 mm, at least 8 mm, at least 9 mm, or at least 10 mm.

In some embodiments, the restrictive channel is configured to hold a volume of fluid ranging from 0.005 microliters to 10 microliters. In some embodiments, the restrictive channel is configured to hold a volume of fluid ranging from 0.005 microliters to 5 microliters. In some embodiments, the restrictive channel holds a volume of fluid ranging from 0.005 microliters to 4 microliters. In some embodiments, the restrictive channel is configured to hold a volume of fluid ranging from 0.005 microliters to 3 microliters. In some embodiments, the restrictive channel is configured to hold a volume of fluid ranging from 0.005 microliters to 2 microliters. In some embodiments, the restrictive channel is configured to hold a volume of fluid ranging from 0.005 microliters to 1 microliter. In some embodiments, the restrictive channel is configured to hold a volume of fluid ranging from 0.05 microliters to 1 microliter. In some embodiments, the restrictive channel is figured to hold a volume of fluid ranging from 0.01 microliters to 2 microliters. In some embodiments, the restrictive channel is configured to hold a volume of fluid ranging from 0.01 microliters to 1 microliter. In some embodiments, the restrictive channel is configured to hold a volume of 2 microliters or less, 1 microliter or less, 0.5 microliters or less, 0.4 microliters or less, 0.2 microliters or less, or 0.1 microliters or less.

### Cuvette Dimensions

An aspect of the cuvette that is the subject of this disclosure is that in operation, a substantial part of the interrogation region is filled with fluid without introducing air bubbles that might obscure the optical path of light used for photometric measurements. Air in the path of light can lead to light diffraction, reflection, and scatter, thereby causing errors in the measurement of transmitted light. The design and dimensions of the cuvette of the present disclosure are such as to prevent the entrapment of bubbles in the interrogation region and to ensure that all the light collected by the detector is representative of the fluids contained within the cuvette.

In other words, the cuvette is dimensioned such that every portion of light collected by the photodetector has passed through the liquid in the cuvette. If this condition is not observed, the background noise associated with the measurement is increased and the measurement system will have reduced sensitivity at the lower end of the sample concentration range.

Another factor restricting configuration of a photometric module is a path length, for light propagating from a source of light through the fluids being measured to a detector. Typical photometric modules are structured to ensure that the path length is on the order of 1 cm. Some point-of-care blood analysis instruments, however, may be configured to utilize path lengths as small as a few hundred microns. In some embodiments of the cuvette that is the subject of this disclosure, the path length of the interrogation region of the cuvette ranges from 1 mm to 5 mm. In some embodiments, the path length of the interrogation region of the cuvette ranges from 1 mm to 25 mm. In some embodiments, the path length of the interrogation region of the cuvette ranges from 1 micron to 1000 microns.

In some embodiments, the volume of the interrogation region of the cuvette is greater than 50% of the total volume of fluid that fills or is placed into the cuvette.

Overall, the minimum operational value of the cuvette width over which light is transmitted is determined both by the desire to measure the analyte having the lowest concentration (at the dilution ratio of the assay) and by the availability of the sample to be measured. As the cuvette width increases, the amount of fluid required to fill the interrogation region also increases. If sample is limited, it may be necessary to dilute the sample to achieve this fill. However, if the dilution ratio is made too large, it may not be possible to detect analytes at low-concentration. Conversely, as cuvette width decreases, the necessary sample dilution ratio for an assay also decreases, (e.g., a more concentrated sample may be used). However, if the width of the cuvette results in an optical path length that is too small, it will again be impossible to detect analytes at low-concentration.

Related to the path length is the volume of liquid that interacts with the light as it passes through the cuvette. In some embodiments, the volume of liquid that interacts with the light as it passes through the cuvette is large, because this volume is directly proportional to the sensitivity of the assay. In other embodiments, the total volume of liquid used in the cuvette is the minimum volume needed to perform the assay so as to reduce waste and minimize cost. In some embodiments, the cuvette of the present disclosure is configured to hold a total volume ranging from 50 microliters to 5 milliliters. In some embodiments, the cuvette of the present disclosure is configured to hold a total volume ranging from 50 microliters to 4 millimeters. In some embodiments, the cuvette of the present disclosure is configured to hold a total volume ranging from 50 microliters to 3 milliliters. In some embodiments, the cuvette of the present disclosure is configured to hold a total volume ranging from 50 microliters to 2 milliliters. In some embodiments, the cuvette of the present disclosure is configured to hold a total volume ranging from 50 microliters to 1 milliliter. In some embodiments, the cuvette of the present disclosure is configured to hold a total volume ranging from 50 microliters to 800 microliters. In some embodiments, the cuvette of the present disclosure is configured to hold a total volume ranging from 50 microliters to 500 microliters. In some embodiments, the cuvette of the present disclosure is configured to hold a total volume ranging from 50 microliters to 400 microliters. In some embodiments, the cuvette of the present disclosure is configured to hold a total volume ranging from 50 microliters to 300 microliters. In some embodiments, the cuvette of the present disclosure is configured to hold a total volume ranging from 50 microliters to 200 ml. In some embodiments, the cuvette of the present disclosure is configured to hold a total volume ranging from 50 microliters to 100 microliters.

FIG. 7 provides isometric and cross-sectional views of a cuvette design, according to one or more embodiments, wherein the cuvette has a short neck relative to a necked region of FIG. 4B, and an axial gasket plate. Cuvette 700 may include inlet 701, body 703, peripheral rim 711, interrogation region proximal 713, wall inner surface 704, wall outer surface 705, interrogation region distal 714, taper angle 751, outlet 702, restrictive channel 710, interrogation region 707, tapered region 708, axial gasket plate 712, inlet chamber 706, necked region 709. Necked region 709 may be a necked region with a restrictive channel.

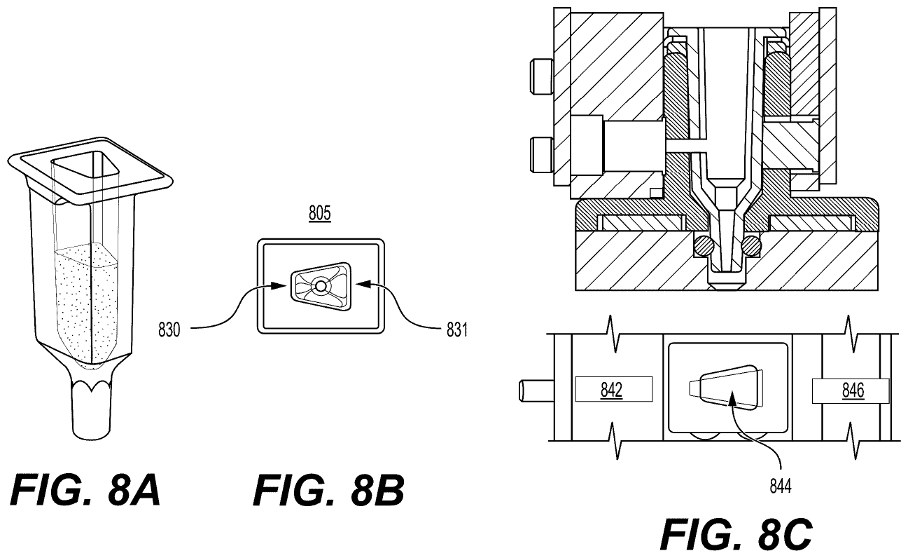

FIGS. 8A-8C show a views of a cuvette that has a body with a trapezoidal cross section, according to one or more embodiments. FIG. 8A shows an isometric view of a cuvette that has a body with a trapezoidal cross section, according to one or more embodiments.

FIG. 8B shows an top-view of a cuvette that has a body with a trapezoidal cross section, according to one or more embodiments. Trapezoidal cross-section 805 may include short wall 830 and long wall 831.

FIG. 8C shows a cross section and top-view within a cuvette module, according to one or more embodiments. The top-view may include a light source 842, a cone of light 844, and a detector 846.

In some embodiments, the cuvette body is composed of walls surrounding the cuvette. In some embodiments, the cuvette body can include a short wall 830 on one side and a long wall 831 on the opposite side. Such a cuvette may be positioned with the short side wall 830 that is proximal to the light source and the long side wall 831 that is proximal to the optimal detector, so that the cuvette widens in the same or similar manner as the widening of the beam of light as it passes from the light source to the detector.

A non-limiting example of such a cuvette with a long side wall 831 and a short side 830 wall is a cuvette that has a trapezoidal cross-section, as illustrated in FIG. 8A-8C. Relative to a cuvette with a square cross-section, a cuvette with a trapezoidal cross-section (for example, FIG. 8B) includes a smaller total liquid volume but the amount of liquid that interacts with the light entering the cuvette remains the same. The obtuse angles of the trapezoid may be of any value between 90° and 180° but are preferably equal to or slightly larger than the angle of the cone of light emitted by the light source. However, other cross-sectional geometries are possible to maintain the function and parameters of the cuvette in a cuvette module. For example, other cross-sectional geometries such as a square cross-section also prevent liquid within the interrogation region of the cuvette from exiting the cuvette until an additional pressure gradient is applied across the cuvette outlet.

### Cuvette Materials

In some embodiments, the cuvette or portions thereof is composed of a plastic material. In some embodiments, the plastic material is selected from: polycarbonate, polystyrene, acrylic, polypropylene, cyclic-olefin-copolymer, cyclic-olefin-polymer, copolyester, polyethylene terephthalate (PET), polyethylene terephthalate glycol (PETG), or other transparent plastic such as are known in the art. In some embodiments, the cuvette is molded from an injection moldable plastic.

In some embodiments, the cuvette or portions thereof (e.g., walls of the cuvette) is composed of glass, quartz, or fused-silica.

In some embodiments, the cuvette or portions thereof (e.g., walls of the cuvette) is composed of a transparent elastomer.

In some embodiments, the cuvette or portions thereof (e.g., walls of the cuvette) is composed of a thin, transparent material to enable light to pass through the cuvette from one side to another.

In some embodiments, the cuvette, or portions thereof, (e.g. the outlet of the cuvette) is made from a material that has a static liquid/solid contact angle greater than 90° for all fluids that are to be placed inside the cuvette. In some embodiments, the restricted channel of the cuvette is made from a different material than that of the rest of the cuvette. In some embodiments, the restricted channel is made of PEEK, FEP, PTFE, or PF A plastic.

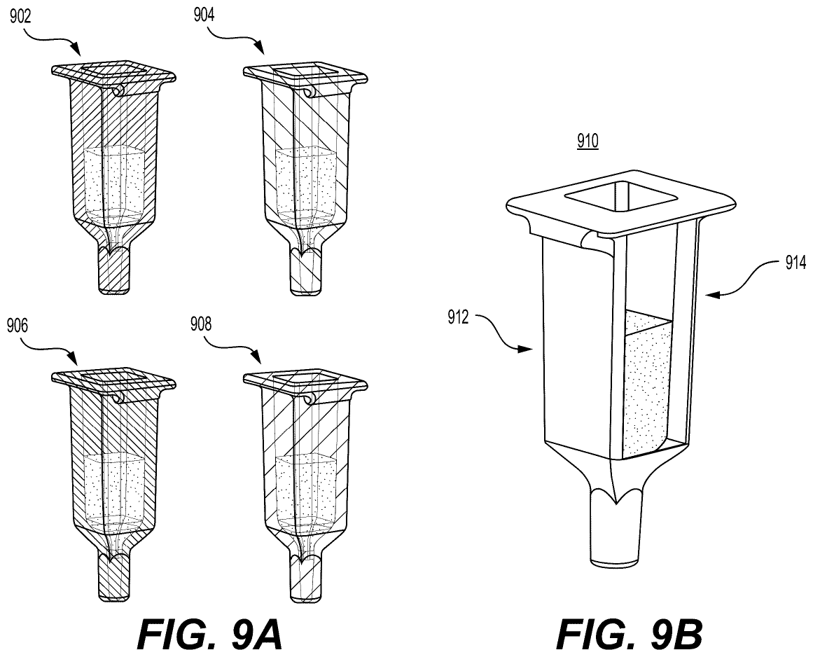

FIGS. 9A-9B depicts isometric views of a cuvette according to one or more embodiments, where the cuvette is dyed or coated with one or more colors or coatings to alter the properties of light transmitted through the cuvette. Such alterations include altering the spectrum, polarity, or intensity of light transmitted through the cuvette.

FIG. 9A shows views of colored cuvettes, according to one or more embodiments. Cuvettes may include multiple colors, including cuvette 902 with a first color, cuvette 904 with a second color, cuvette 906 with a third color, and cuvette 908 with a fourth color.

FIG. 9B shows views of cuvettes with one or more coatings, according to one or more embodiments. Cuvette 910 may include multiple coatings. Cuvette 910 may include coating 912 and coating 914. Coating 912 may be a first coating. Coating 914 may be a second coating.

In some embodiments, the cuvette may be dyed, colored, or coated, with a wavelength-selective material. In some embodiments, the cuvette comprises one or more materials molded into the materials used to make the cuvette in order to change the optical properties of the light passing through the cuvette. For example, such materials embedded into the cuvette materials can include a dye, coating, or a lens molded into the cuvette. In certain embodiments, when the cuvette is dyed, colored, or coated, the cuvette dye, color, or coating acts as a light filter. For example, dyes of any color may be added to the cuvette during the manufacturing process, as illustrated in FIG. 9A In some embodiments, the cuvette is coated with one or more coatings as shown in FIG. 9B. As shown in FIG. 9B, each wall of the cuvette can be coated with the same or different coating/color. These dyes and coatings may serve to alter the spectrum, polarity, or intensity of light transmitted through the cuvettes.

In some embodiments, the cuvette, or portions thereof, is made from a material that has a water/solid contact angle that is less than 90 degrees.

### Alternative Cuvette Embodiments

FIG. 4B shows an alternative embodiment of the cuvette of the present disclosure. The cuvette, 400 is substantially the same as the cuvette of FIG. 2. However, the peripheral rim 411 that may serve as an indexing feature is here located between the distal end of the interrogation region 407 and the proximal end of the tapered region 408. In certain embodiments, the cuvette further comprises an indexing feature, wherein the indexing feature comprises a peripheral rim 411 positioned between the distal end 414 of the interrogation region and the proximal end 418 of the tapered region, as shown in FIG. 4B.

FIG. 7 shows another embodiment of the cuvette of the present disclosure. This cuvette 700 shares many common features with cuvettes of FIGS. 2-6. However, this cuvette has a much shorter necked region 709 as compared to cuvettes of FIGS. 2-6, and includes an axial-gasket plate 732. In some embodiments, the axial-gasket plate 732 could also serve as an indexing feature, making the peripheral rim unnecessary. In certain embodiments, the cuvette comprising the axial-gasket plate does not comprise a peripheral rim.

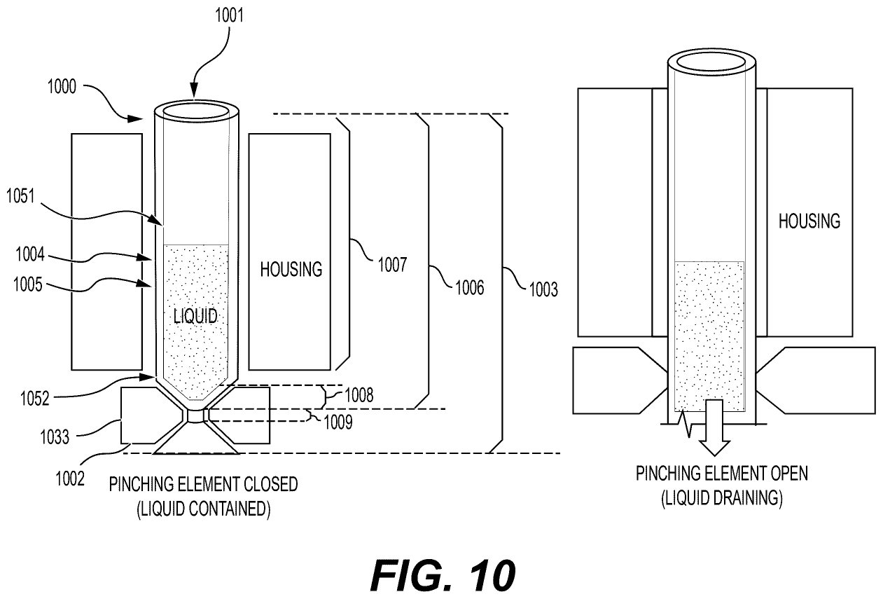

FIG. 10 provides cross-sectional views of a cuvette design, according to one or more embodiments. This cuvette may be made from an elastomeric material that can be deformed by a pinching element so as to close or open the outlet of the cuvette. The taper and neck of this cuvette may be reversibly formed through its interaction with an external pinching element. Cuvette 1000 may include a soft elastomeric tube. Cuvette 1000 may include inlet 1001, interrogation region proximal 1051, wall inner surface 1004, wall outer surface 1005, interrogation region distal 1052, pinching element 1033, outlet 1002, interrogation region 1007, tapered region 1008, necked region 1009, inlet chamber 1006, and body 1003.

FIG. 10 shows another embodiment of the cuvette of the present disclosure. This cuvette 1000 is made from a soft elastomeric tube. In some embodiments, the tube has a square cross-section and has substantially flat walls. In some embodiments, the tube is cylindrical, but is inserted into a housing that causes at least two of the opposing walls to deform into substantially flat walls. In some embodiments, the cuvette of FIG. 10 is connected to a pinching element 1033, such as a pinch valve, or a peristaltic pump that, when closed, creates a tapered region and a closed outlet for containing the fluid within the cuvette during processing and/or measurement of the fluid. When the pinching element is opened, fluid can then be drained or aspirated from the cuvette through an outlet. The interrogation region of the cuvette of FIG. 10 is contained within the inlet chamber 1006, and may be filled under the influence of gravity by a fluid inserted through the inlet (e.g. by a pipettor). Further, the outlet 1002 of the cuvette of FIG. 10 is constrained to have an opening that is small enough to prevent fluid from exiting the cuvette under the influence of gravity alone.

Another aspect of the present disclosure includes a cuvette for holding fluids, comprising: (A) an inlet end comprising an inlet open to the atmosphere, wherein the inlet is configured to receive the fluids dropped or dispensed into the inlet from above the cuvette; (B) a body of the cuvette connected to the inlet end, the body composed of walls surrounding the cuvette, each wall having an inner surface and an outer surface, the walls including a plurality of regions comprising an inlet chamber and a necked region; (C) the inlet chamber configured to be filled under the influence of gravity by the fluid dropped or dispensed into the inlet; (D) the inlet chamber containing an interrogation region comprising a proximal end and a distal end, the proximal end positioned at the inlet end of the cuvette, the walls at the interrogation region including a first wall and a second wall opposite the first wall, wherein the inlet chamber is configured to allow transmission of light through the first wall and the second wall of the interrogation region; and E an outlet end fluidically connected to the inlet chamber of the cuvette, the outlet end configured to allow the fluid to be maintained within the inlet chamber for as long as desired, but to exit the cuvette upon a change in the geometry of the outlet, or through application of an additional pressure drop across the outlet.

### Cuvette Arrays

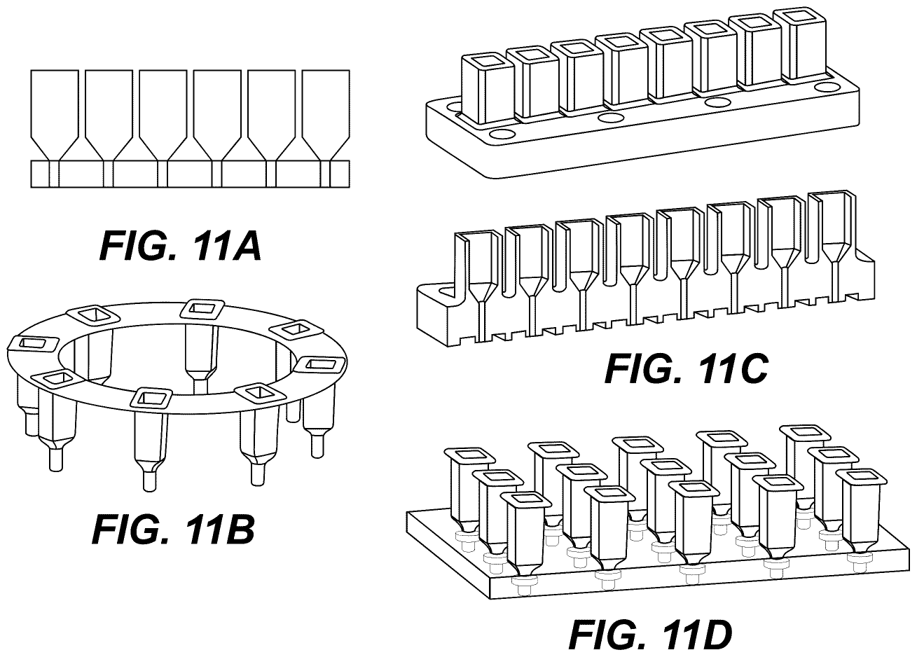

FIGS. 11A-11D depict examples in which a plurality of cuvettes are joined together, for example, either through a monolithic fabrication process, or by assembly of discrete cuvettes into a whole, according to one or more embodiments, where the plurality of cuvettes can be in the form of 1D and 2D arrays, or any other desirable configuration.

FIG. 11A shows a schematic of a 1D array of cuvettes, according to one or more embodiments. FIG. 11B shows an array of molded cuvettes assembled into a circular holder, according to one or more embodiments. FIG. 11C shows an isometric and cross-sectional view of a monolithic array of cuvettes in a ID array, according to one or more embodiments. FIG. 11D shows a two-dimensional array of molded cuvettes, according to one or more embodiments.

The various embodiments of the cuvette of the present disclosure may be ganged together to create structures containing a plurality of cuvettes (e.g. a multiplicity of cuvettes or an array of cuvettes). For instance, as shown in FIG. 11, individual cuvettes may be placed into ID or 2D arrays, or may be assembled into other structures, such as rings. Furthermore, arrays of cuvettes may be fabricated as a monolithic block, as illustrated in FIG. 11C.

In some embodiments, the plurality of cuvettes comprises at least 2 cuvettes, at least 3 cuvettes, at least 4 cuvettes, at least 5 cuvettes, at least 6 cuvettes, at least 7 cuvettes, at least 8 cuvettes, at least 9 cuvettes, or at least 10 cuvettes. In some embodiments, the plurality of cuvettes comprises at least 5 cuvettes, at least 10 cuvettes, at least 15 cuvettes, at least 20 cuvettes, at least 25 cuvettes, at least 30 cuvettes, at least 35 cuvettes, at least 40 cuvettes, at least 45 cuvettes, or at least 50 cuvettes. In some embodiments, the plurality of cuvettes comprises at least 50 cuvettes, at least 100 cuvettes, at least 150 cuvettes, at least 200 cuvettes, at least 250 cuvettes, at least 300 cuvettes, at least 350 cuvettes, at least 400 cuvettes, at least 450 cuvettes, or at least 500 cuvettes.

### Cuvette Module

Aspects of the present disclosure include a cuvette module for processing and performing measurements, such as photometric measurements. In some embodiments, the cuvette module is a multiplexed device that can process and measure multiple samples in a single cuvette or in an array of cuvettes within the cuvette module.

In some embodiments, the cuvette module comprises at least one compartment capable of holding at least one cuvette. In some embodiments, the cuvette module comprises one or more compartments capable of holding at least one cuvette. In some embodiments, the cuvette module comprises at least one cuvette. In some embodiments, the cuvette module comprises one or more cuvettes.

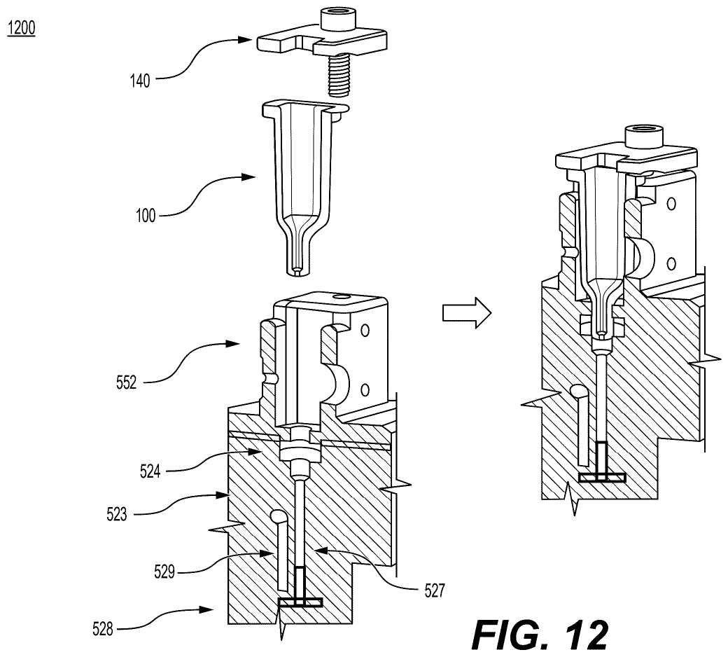

FIG. 12 shows exemplary components of a cuvette module comprising a cuvette, a housing, a manifold, and a fluidic valve, according to one or more embodiments. Module 1200 may include housing cap 140, cuvette 100, housing 522, O-ring 524, manifold 523, downstream channel 529, active valve 528, and central channel 527.

A non-limiting example of the cuvette module of the present disclosure is shown in FIG. 12. FIG. 12 shows a cuvette module that includes one or more compartments configured to hold at least one cuvette of the present disclosure. The cuvette has an inlet open to the atmosphere, wherein the inlet is configured to receive fluids dropped or dispensed into the inlet from above the cuvette. The cuvette further comprises an inlet chamber that holds the fluids. The cuvette further comprises an output, the output having a restrictive channel. Any of the cuvette designs described in the present disclosure can be used in the cuvette module of the present disclosure.

In some embodiments, as shown in FIG. 12, the cuvette module comprises a cuvette and a housing comprising one or more housing walls shaped to hold and mechanically constrain the cuvette in place. In this example as shown in FIG. 12, the cuvette module also includes a manifold having a fluidic channel positioned between and fluidically connecting the outlet of the cuvette and an active valve 528. In some embodiments, the active valve 528 can serve to open and close the connection between the outlet 502 of the cuvette and a downstream channel 529. In embodiments where an array of cuvettes is present, the cuvette module comprises an array of valves that serve to open and close specifically selected cuvettes when needed.

### Cuvette

FIG. 13 shows the components of an exemplary multiplexed cuvette module including an array of cuvettes, and a single-unit-cell of the cuvette module, according to one or more embodiments. Module 1300 may be a multiplexed cuvette module including an array of cuvettes. Module 1300 may include reusable cuvettes 1305. Module 1370 may be a single-unit-cell of the cuvette module. Module 1370 may include reusable cuvette detector 1310, LED 1315, fluidic manifold 1320, and valve 1325.

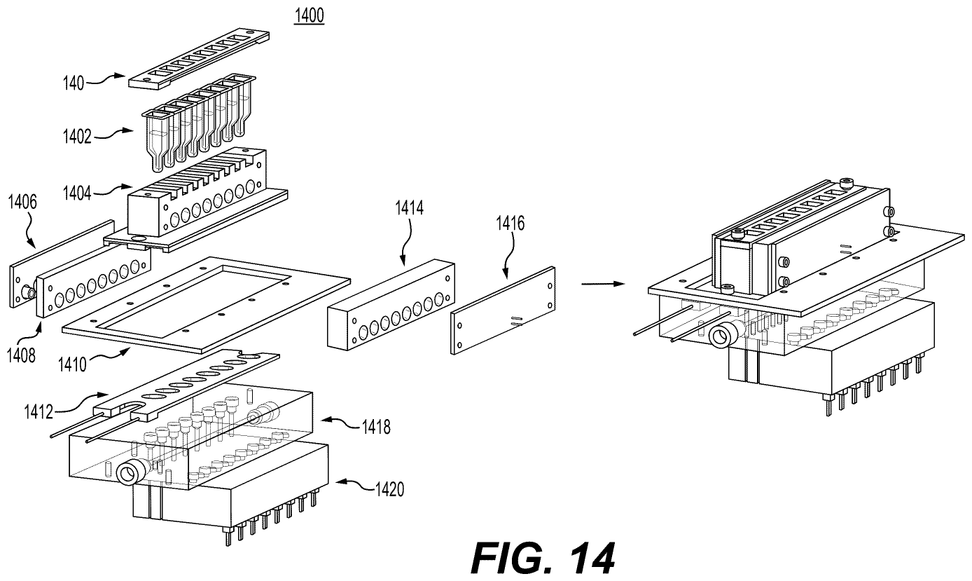

FIG. 14 shows an exploded view of the exemplary multiplexed cuvette module, according to one or more embodiments. Module 1400 may be a module like module 1300. Module 1400 may include housing cap 140, cuvettes 1402, housing and thermal block 1404, detector board 1406, detector spacer 1408, motherboard 1410, heating element 1412, light source spacer 1414, light source board 1416, fluidic manifold 1418, and valve bank 1420.

A non-limiting example of a multiplexed cuvette module comprising an array of cuvettes is shown in FIG. 13. As shown in FIG. 13 and FIG. 14, the array comprises 8 reusable cuvettes within a housing, each cuvette associated with an optical emitter on one side of the cuvette and an optical detector on the opposite side of the cuvette. The cuvette module of FIG. 13 and FIG. 14 also include a fluidic manifold comprising 8 fluidic channels, each fluidic channel connected to a respective outlet of a cuvette. The cuvette module of FIG. 13 and FIG. 14 also include 8 active valves fluidically connecting the fluidic channels of the manifold. In some embodiments, the cuvette module comprises a solenoid valve bank.

In some embodiments, the cuvette module of the present disclosure comprises one or more cuvettes described herein. In some embodiments, the cuvette module comprises 2 or more cuvettes, 3 or more cuvettes, 4 or more cuvettes, 5 or more cuvettes, 6 or more cuvettes, 7 or more cuvettes, 8 or more cuvettes, 9 or more cuvettes, 10 or more cuvettes, 15 or more cuvettes, 20 or more cuvettes, 25 or more cuvettes, 30 or more cuvettes, 40 or more cuvettes, 45 or more cuvettes, or 50 or more cuvettes. In certain embodiments, cuvette module the 2 or more cuvettes are positioned in an array within the cuvette module as shown in FIG. 13.

FIG. 13 illustrates a non-limiting example of a cuvette module having a plurality of cuvettes and associated hardware. In this picture QTY (8) cuvettes and their associated hardware are shown, though it will be apparent that any number of cuvettes could be assembled into an array such as this to create smaller or larger cuvette modules. FIG. 13 shows a cuvette module in which an individual light source and an individual detector are associated with each cuvette. In other embodiments, more than one cuvette may share a single light source and/or detector. In some embodiments, multiple light sources may address a single cuvette.

In some embodiments, one or more cuvettes are reusable. In some embodiments, the one or more cuvettes comprise at least 2 reusable cuvettes, at least reusable 3 cuvettes, at least 4 reusable cuvettes, at least reusable 5 cuvettes, at least reusable 6 cuvettes, at least reusable 7 cuvettes, at least reusable 8 cuvettes, at least reusable 9 cuvettes, or at least 10 reusable cuvettes. In certain embodiments, the array of cuvettes comprises 2-10 reusable cuvettes, 2-20 reusable cuvettes, 2-50 reusable cuvettes, or 2-100 reusable cuvettes.

In some embodiments, the cuvette module contains an array of cuvettes and associated hardware. In such embodiments, the cuvettes may be individual cuvettes inserted into individual cavities in the housing. Alternatively, the cuvettes may be joined together into a monolithic array which is positioned in the housing.

### Housing

In some embodiments, the cuvette module comprising the cuvette of the present disclosure further comprises a housing into which one or more cuvettes is inserted or placed.

In some embodiments, the housing includes an opening at a proximal end of the housing walls for inserting the cuvette into the housing. As shown in FIG. 12, in some embodiments, the cuvette module further comprises a housing having one or more housing walls shaped to hold and mechanically constrain at least one cuvette and orient it so that its inlet chamber may be filled under the influence of gravity. In some embodiments, the cuvette module further comprises a housing cap 140 that additionally constrains the position of the cuvette. In some embodiments, the cap may be attached to the housing over a portion of the cuvette.

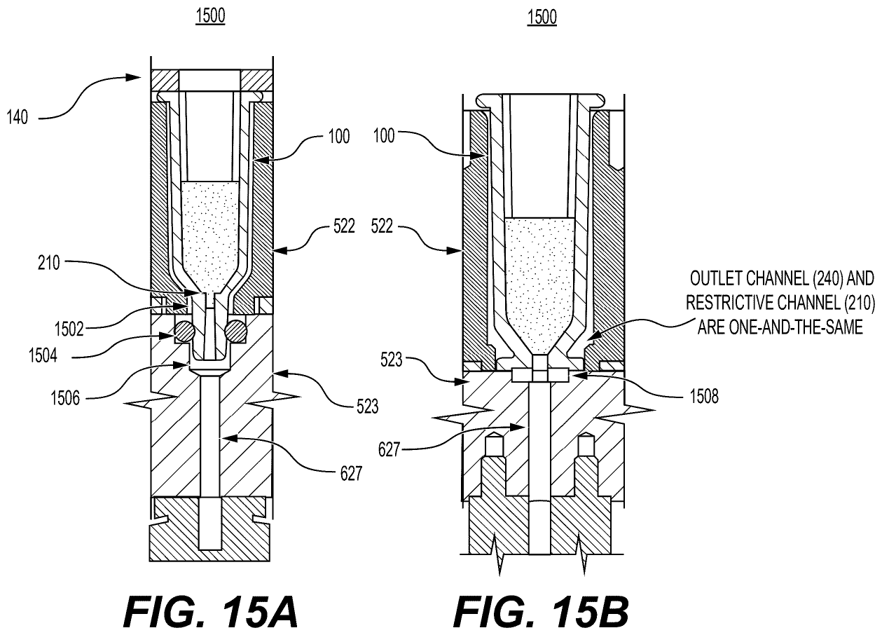

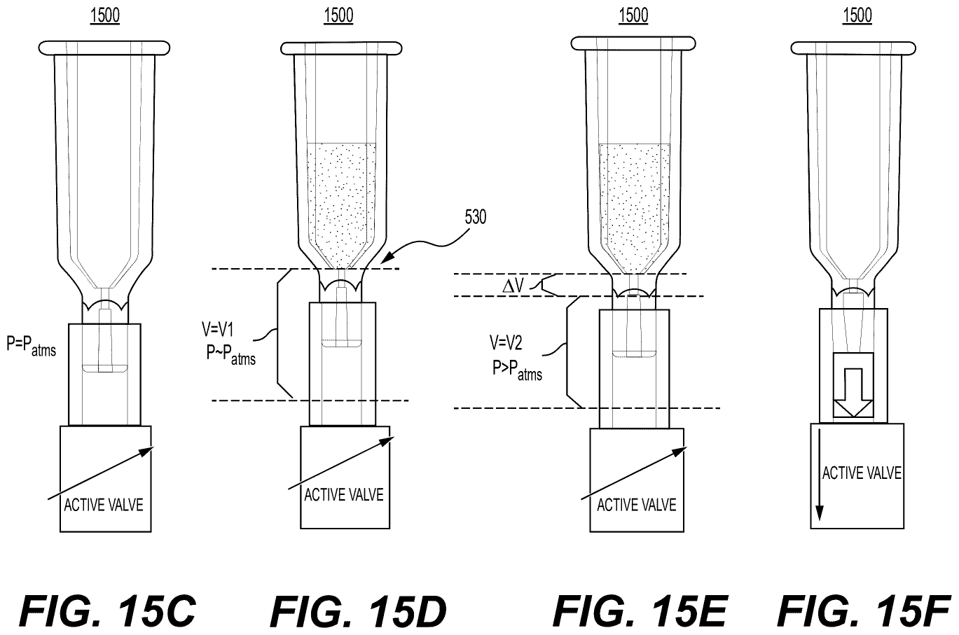

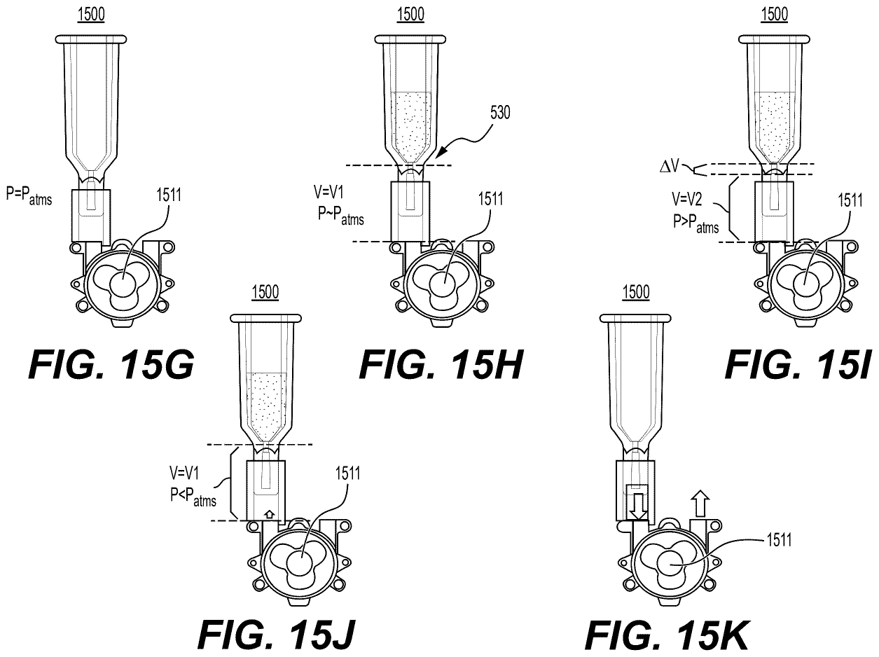

FIGS. 15A-15K show cross-sectional views of a cuvette module of the present disclosure comprising a cuvette, a housing, a fluidic manifold, and a fluidic valve or pump, according to one or more embodiments.

FIG. 15A depicts a cuvette module which provides a radial O-ring seal configured to provide an air-tight and/or fluid tight seal between of the cuvette and the manifold, according to one or more embodiments. Module 1500 may include cuvette 100, and may include housing cap 140, restrictive channel 210, cuvette neck 1502, radial O-ring seal 1504, neck chamber 1506, housing 522, manifold 523, and manifold channel 627.

FIG. 15B depicts a cuvette module which provides an axial gasket seal configured to provide an air-tight and/or fluid tight seal between the cuvette and the manifold, according to one or more embodiments. Module 1500 may include cuvette 100, and may include housing 522, manifold 523, manifold channel 627, outlet channel 240, and axial gasket 1508. Outlet channel 240 may be a restrictive channel 210.

FIG. 15C illustrates a state of the module before liquid has been dropped or dispensed into the cuvette and where the cuvette and the tube are at atmospheric pressure, according to one or more embodiments. For module 1500 in this figure the pressure of the cuvette and tube may be equal to atmospheric pressure.

FIG. 15D illustrates a state of the module when liquid has been dropped or dispensed into the cuvette, thereby trapping a volume of air, V1, between the valve and the liquid, according to one or more embodiments. Module 1500 may include capillary valve 530. Volume of air may be equal to V1, which may between the valve and the liquid. Pressure of the cuvette and tube may approximately equal to atmospheric pressure.

FIG. 15E illustrates a state of the module wherein some of the liquid in the cuvette begins to pass into the restrictive channel of the cuvette, thereby compressing the trapped volume of air to a volume V2, according to one or more embodiments. Volume of air may be equal to V2, which may between the valve and the liquid, minus a delta-V. Pressure of the cuvette and tube may be greater than atmospheric pressure.

FIG. 15F illustrates a state in which the cuvette is being emptied, the valve is opened and a downstream pump pulls the fluid out of the cuvette, according to one or more embodiments.

FIG. 15G illustrates a state of the module before liquid has been dropped or dispensed into the cuvette and where the cuvette, tube and upstream side of the pump are all at atmospheric pressure, according to one or more embodiments. Module 1500 may include pump 1511. For module 1500 in this figure, the pressure of the cuvette, tube and upstream side of the pump may be equal to atmospheric temperature

FIG. 15H illustrates an embodiment in which liquid has been dropped or dispensed into the cuvette, thereby trapping a volume of air, VI, between the pump and the liquid in the inlet chamber of the cuvette, according to one or more embodiments. Module 1500 may include capillary valve 530 and pump 1511. Volume of air may be equal to V1, which may between the valve and the liquid. Pressure of the cuvette and tube may approximately equal to atmospheric pressure.

FIG. 15I illustrates an alternative situation wherein some of the liquid in the cuvette begins to pass into the restrictive channel of the cuvette, thereby compressing the trapped volume of air to a volume V2, according to one or more embodiments. Module 1500 may include pump 1511. Volume of air may be equal to V2, which may between the valve and the liquid, minus a delta-V. Pressure of the cuvette and tube may be greater than atmospheric pressure.

FIG. 15J illustrates an optional aspect of this embodiment in which the pump may be configured to apply a very slight pressure to the air-chamber, thereby momentarily increasing the pressure in the trapped air volume above the head-pressure of the liquid, according to one or more embodiments. Module 1500 may include pump 1511. Volume of air may be equal to V1, which may between the valve and the liquid. Pressure of the cuvette and tube may be greater than atmospheric pressure.

FIG. 15K illustrates a state in which the cuvette is being emptied by the pump which pulls the fluid out of the cuvette, according to one or more embodiments. Module 1500 may include pump 1511. The pump 1511 may pull fluid out of a cuvette (for example, cuvette 100).

A non-limiting example of the housing of the cuvette module is provided in FIG. 15A-15B. FIG. 15A shows a cuvette comprising a long-necked region of different designs fitted into a housing of the cuvette module and fluidically connected through a radial seal, whereas FIG. 15B shows a cuvette design with a short-necked region fitted into a housing of the cuvette module and fluidically connected through an axial seal.

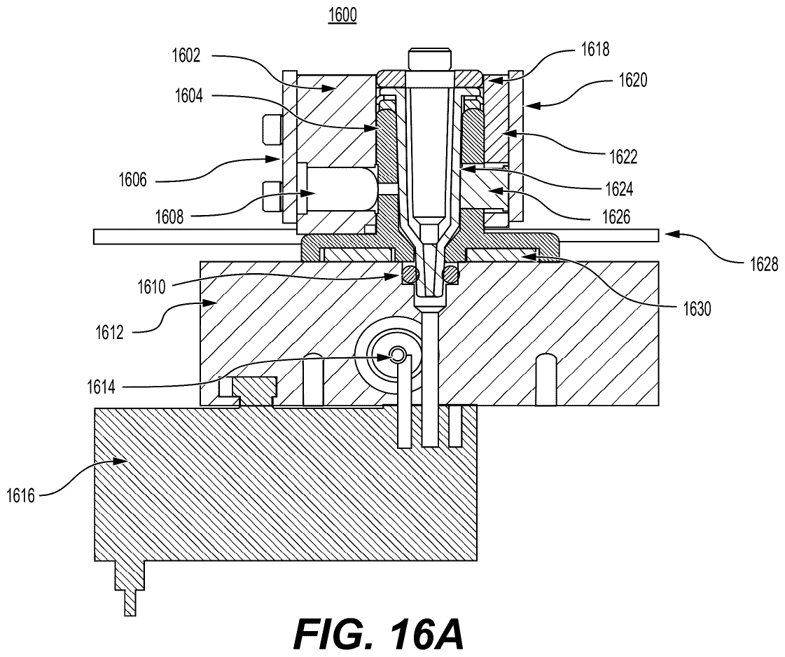

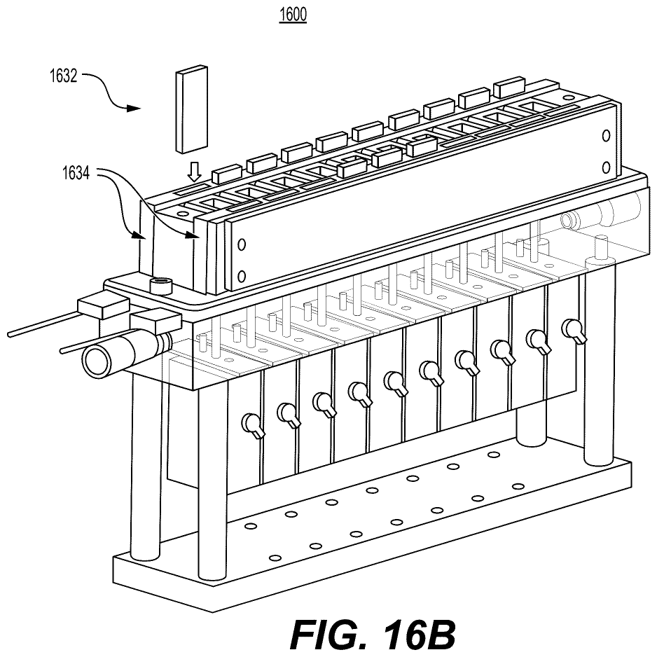

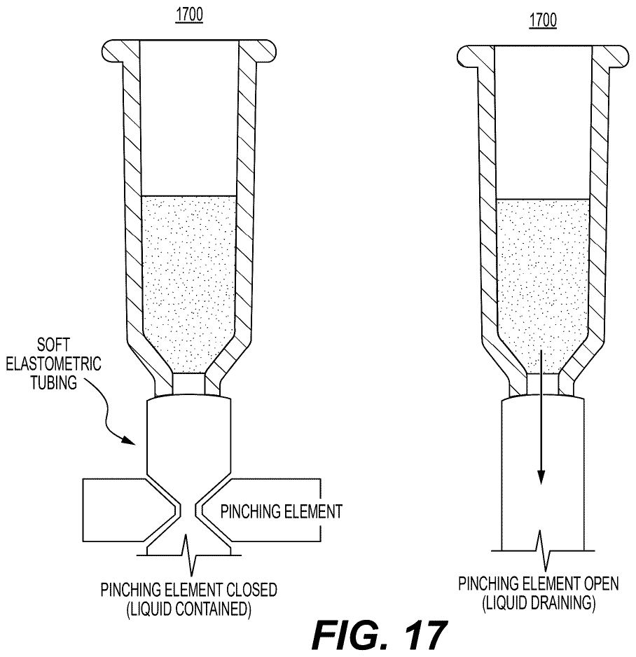

FIGS. 16A-16B show examples of a cuvette module of the present disclosure, according to one or more embodiments. FIG. 16A shows a cross-sectional view of a cuvette module of the present disclosure comprising a cuvette, a housing, a fluidic manifold, and a fluidic valve, according to one or more embodiments. Module 1600 may include light source space 1602, housing 1604, light source board 1606, light source 1608, fluidic seal 1610, fluidic manifold 1612, waste line 1614, valve 1616, cap 1618, detector board 1620, detector spacer 1622, cuvette 1624 (which may be a cuvette like cuvette 100), detector 1626, motherboard 1628, and heating/cooling element 1630.

FIG. 16B shows an isometric view of a cuvette module that includes one or more filter holders within the housing that can accept optical filters, according to one or more embodiments. Module 1600 may include filter 1632 and filter holders 1634.

FIG. 17 shows cross-sectional views of an cuvette module of the present disclosure comprising a cuvette, and a soft rubber tube positioned at the end of the outlet of the cuvette that serves the purpose of a manifold, according to one or more embodiments. The cuvette module 1700 may include a pinching element that prevents fluid from draining through the outlet when the pinching element is closed, but may permit fluid to be drained when the pinching element is open.

In some embodiments, the housing comprises a slot on at least one of the housing walls to register or index the cuvette in a selected position within the housing. In some embodiments, the lip or indexing feature of cuvette is positioned such that when the cuvette is securely placed into the housing, the lip or indexing feature of the cuvette is configured to stop the cuvette from movement further into the housing (see e.g., FIG. 15A and FIG. 15B). In some embodiments, the housing comprises a fastener on at least one of the housing walls to fasten the cuvette into the housing. In some embodiments, when a cuvette module comprises an array of cuvettes, each cuvette within the array of cuvettes is positioned in a separate opening or slot within the housing for inserting and indexing each cuvette.

In some embodiments, the housing comprises a thermal block, composed of a thermally-conductive material such as a metal. In some embodiments, the metal is aluminum.

### Fluidic Seal

The cuvette module of the present disclosure incorporates a fluidic seal that puts the outlet of the cuvette in fluid communication with a fluidic tube or channel (e.g., central channel described herein as 527), and an active valve 528 that can open and close the path from the cuvette to the downstream tube or channel 529.

In some embodiments, the fluidic seal puts the cuvette in fluidic communication with a manifold; the manifold having a fluidic channel positioned between and fluidically connecting the outlet of the cuvette and an active valve that serves to open and close the connection between the outlet of the cuvette and a downstream channel.

In some embodiments, the housing comprises a fluidic seal around one or more regions of the cuvette wall. For example, in some embodiments, a fluidic seal can be positioned within the housing at the necked region, of the cuvette. In other embodiments, a fluidic seal can be positioned at the distal end of the transition tapered region. In some embodiments, the fluidic seal is a radial seal. In some embodiments, the fluidic seal is an axial seal. In some embodiments, the fluidic seal comprises an O-ring or a gasket. In some embodiments, the fluidic seal is configured to hold the cuvette in place within the housing. In some embodiments, the housing comprises a gasket positioned around the outlet end of the cuvette.

### Cap

In some embodiments, the housing further comprises a housing cap as shown in FIG. 12 and FIG. 14. The housing cap does not constrict or block the inlet opening of the cuvette, but sits around the edges of the proximal end of the inlet and allows for holding the cuvette in place.

The housing cap 140 is also shown in FIG. 14 and FIG. 16. In some embodiments, where an array of cuvettes is present, the cuvette module may comprise an array of caps, or a single cap may be configured so that it covers the entire array. As illustrated in FIG. 14, the cap(s) may have holes in them corresponding in size and location to the cuvette inlet openings, so that when the cap is placed on top of the cuvettes, it does not prevent fluid from being loaded into the cuvettes. In some embodiments, the cap may be used to mechanically-secure the cuvettes in their housing. For example, the cap may make contact with the top surface of a peripheral rim surrounding the inlet end of the cuvette, and may be screwed down to the housing so that it prevents the cuvettes from being unintentionally withdrawn from the housing.

### Manifold

In some embodiments, the cuvette module further comprises a manifold. As shown in FIGS. 15A-15B and FIG. 14, in some embodiments, the manifold includes a fluidic channel positioned between and fluidically connecting the outlet of the cuvette and a fluidic valve. In some embodiments, the manifold includes a neck chamber positioned between the fluidic channel and the outlet of the cuvette, as shown in FIG. 15A.

The manifold of the present cuvette module can be of a size appropriate to fluidically connect a single cuvette or an array of cuvettes to a single active fluidic valve or an array of active fluidic valves. For example, in some embodiments, the manifold comprises a number of fluidic channels and valves that correspond to the number of cuvettes in the cuvette module. In some embodiments, the manifold comprises one or more fluidic channels, 2 or more fluidic channels, 3 or more fluidic channels, 4 or more fluidic channels, 5 or more fluidic channels, 6 or more fluidic channels, 7 or more fluidic channels, 8 or more fluidic channels, 9 or more fluidic channels, 10 or more fluidic channels, 15 or more fluidic channels, 20 or more fluidic channels, 25 or more fluidic channels, 30 or more fluidic channels, 40 or more fluidic channels, 45 or more fluidic channels, or 50 or more fluidic channels, each fluidic channel positioned between and fluidically connecting a corresponding outlet of a cuvette and a fluidic valve. In certain embodiments, the cuvette module 2 or more fluidic channels are positioned in an array within the cuvette module.

In some embodiments, the manifold comprises a seal around one or more regions of the cuvette wall as shown in FIG. 12 and FIG. 15. FIG. 15 illustrates two embodiments of the cuvette module; a first embodiment uses a radial O-ring (for examples, FIG. 15A) as an element to create a fluidic seal between a cuvette and a manifold. A second embodiment uses an axial gasket (for example, FIG. 15B) to accomplish the fluidic seal between the cuvette and the manifold.

In some embodiments, a seal can be positioned within the manifold and is adjacent to the necked region of the cuvette. In other embodiments, a seal can be positioned within the manifold and is adjacent to the distal end of the tapered region. In some embodiments, the manifold comprises a seal adjacent to the distal end of the outlet of the cuvette that seals the distal end of the outlet to a channel within the manifold. In some embodiments, the seal is a radial seal. In some embodiments, the seal is an axial seal. In some embodiments, the seal comprises an O-ring or a gasket. In some embodiments, the seal is configured to hold the cuvette in place within the housing. In some embodiments, the manifold comprises a gasket positioned around the outlet end of the cuvette. In certain embodiments, the outlet end of the cuvette is configured to create a radial seal with the gasket. In certain embodiments, the gasket is configured to provide an air-tight and/or fluid-tight seal between the manifold and the outlet of the cuvette. In some embodiments, the gasket is configured to provide an airtight and/or fluid-tight seal between the first fluidic channel and the outlet of the cuvette. In some embodiments, the seal creates a fluid-tight connection between the cuvette and the manifold.

In some embodiments, the cuvette module further comprises a second gasket configured to provide an air-tight and/or fluid-tight seal between an active fluidic valve and the manifold. This is distinct from the gasket that creates a fluid seal between the cuvette module and the cuvette.

In some embodiments, the cuvette module does not comprise a manifold. In such embodiments, the cuvette is connected directly to the active valve, without an intervening manifold.

In some embodiments, the fluidic manifold further comprises a waste channel (e.g., waste line) as shown in FIG. 16A. In some embodiments, the waste line is fluidically connected to one or more active fluidic valves.

In some embodiments, where the cuvette module comprises multiple cuvettes, the module may also comprise a plurality of O-rings, gaskets, or other means of fluidically sealing the cuvettes to a manifold. In some embodiments, the manifold comprises fluidic channels that connect the output of each cuvette to a valve, to enable the output of each cuvette to be controllably opened and closed, and to enable a volume of air to be trapped between the valve and the liquid in each cuvette.

### Fluidic Valve (Active Valve)

In some embodiments, the cuvette module of the present disclosure comprises a fluidic valve (used interchangeably herein as “active fluidic valve” or “active valve”). Nonlimiting examples of the active valve are shown in FIGS. 5A-5D and FIG. 6. The active valve 528 is fluidically connected to the fluidic central channel 527 of the manifold. The active valve is configured to open and close the connection between the central channel 527 and a downstream channel 529 of the manifold. When an array of cuvettes and fluidic channels are present in the cuvette module, the cuvette module comprises an active valve fluidically connected to each fluidic channel. Each active valve allows the connection between the outlet of a specific cuvette and a downstream channel to be opened and closed. The fluidic valve is positioned between the central channel and a downstream channel and is configured to connect and disconnect the downstream channel from the central channel. In some embodiments, the downstream channel is fluidically connected to and is downstream of the fluidic valve, and the central channel is downstream of the outlet. In some embodiments, the central channel is in fluid communication with the outlet of the cuvette.

As illustrated in FIG. 5B-5C, the active fluidic valve 528 serves an additional function, for example, when closed, the active fluidic valve traps a small volume of air between the outlet 502 of the cuvette and the active valve 528 that can serve to help keep fluid in the cuvette inlet chamber if the first passive valve 530 is insufficient to counter the head pressure of the liquid in the cuvette (FIGS. 5B and 5C).

In some embodiments, when the active valve is closed, the module traps a volume of air between it and the liquid in the inlet chamber of the cuvette. FIG. 15C illustrates the state of the module before liquid has been dropped or dispensed into the cuvette. The cuvette and the tube are at atmospheric pressure. FIG. 15D illustrates an embodiment in which liquid has been dropped or dispensed into the cuvette, thereby trapping a volume of air, VI, between the valve and the liquid. In some embodiments, when the fluidic valve is closed, if fluid in the inlet chamber of the cuvette starts to move out of the inlet chamber under the influence of gravity, the volume of air between the inlet chamber of the cuvette and the fluidic valve becomes pressurized, thereby resisting further movement of fluid from the at least one cuvette. As the liquid fills the cuvette, the pressure at the first capillary valve increases to a pressure equal and opposite to the head-pressure of the liquid. FIG. 15D illustrates an embodiment where this equal-and-opposite pressure is generated exclusively by the capillary forces at the air/liquid interface. The liquid has not entered the restrictive channel; rather the air/liquid interface itself creates the pressure. FIG. 15E illustrates an alternative state wherein some of the liquid in the cuvette begins to pass into the restrictive channel of the cuvette, thereby compressing the trapped volume of air to a volume V2. In this state, the pressure of the trapped air again rises to be equal and opposite to the head pressure of the liquid.

However, in this case, it is the compression of the trapped air volume that generates the equal and opposite air pressure that resists further movement of the liquid out of the cuvette. In some embodiments, both capillary pressure and compressed-air pressure contribute to the pressure that resists the liquid head pressure. The equilibrium position of the liquid/air meniscus may lie between the extremes shown in FIG. 15D and FIG. 15E. In other words, the equilibrium position of the liquid/air meniscus may lie anywhere within the restrictive channel of the cuvette depending on the liquid height, the capillary forces associated with the first capillary valve, and the volume of air trapped between the liquid and the active valve. FIG. 15F illustrates a state in which the cuvette is being emptied; the valve is opened and a downstream pump (not shown) pulls the fluid out of the cuvette.

In some embodiments, the fluidic valve (active valve) comprises at least one port. In some embodiments, the fluidic valve comprises at least two ports. In some embodiments, the fluidic valve comprises at least three ports. In some embodiments, the fluidic valve is a one-way valve. In some embodiments, the fluidic valve is a two-way valve. In some embodiments, the fluidic valve is a three-way valve. In some embodiments, at least one port of the fluidic valve is connected to the central channel. In some embodiments, at least one port of the fluidic valve is connected to the downstream channel. In some embodiments, at least one port of the fluidic valve is connected to the central channel, and at least one port of the fluidic valve is connected to the downstream channel.

### Pump

In some embodiments, the opposite end of the active valve (distal end, furthest away from the fluidic channel) is connected to a pump. When an array of cuvettes, active valves, and fluidic channels are present in the cuvette module as shown in FIG. 16A-16B, the opposite ends of each active valve may be connected to a joint channel that is connected to a common pump.

In some embodiments, when the active valve is closed, a pocket of air is trapped between the valve and any fluid in the inlet chamber of the cuvette, such that if fluid in the inlet chamber of the cuvette starts to move out of the inlet chamber under the influence of gravity, the air pocket between the inlet chamber and the valve becomes pressurized and therefore resists further movement of fluid from the cuvette. In some embodiments, the volume or pocket of air between the valve and any liquid in the cuvette inlet chamber has a volume ranging from 5 microliters to 60 microliters.

In some embodiments, the cuvette module does not comprise an active valve. In certain embodiments, the cuvette module comprises a pump. In some embodiments, the pump, such as a peristaltic pump, membrane pump, or diaphragm pump, is configured so that it behaves as a closed fluidic valve when it is at rest, thereby enabling a volume of air to be trapped between the liquid in the cuvette and the pump.

FIG. 15G illustrates the state of the module before liquid has been dropped or dispensed into the cuvette. The cuvette, tube and upstream side of the pump are all at atmospheric pressure. FIG. 15H illustrates an embodiment in which liquid has been dropped or dispensed into the cuvette, thereby trapping a volume of air, VI, between the pump and the liquid in the inlet chamber of the cuvette. As the liquid fills the cuvette, the pressure at the first capillary valve increases to a pressure equal and opposite to the head-pressure of the liquid. FIG. 15H illustrates the situation where this equal-and-opposite pressure is generated exclusively by the capillary forces at the air/liquid interface. The liquid has not entered the restrictive channel; rather the air/liquid interface itself creates the pressure. FIG. 15I illustrates an alternative situation wherein some of the liquid in the cuvette begins to pass into the restrictive channel of the cuvette, thereby compressing the trapped volume of air to a volume V2. In this state, the pressure of the trapped air again rises to be equal and opposite to the head pressure of the liquid. However in this case it is the compression of the trapped air volume that generates the equal and opposite air pressure that resists further movement of the liquid out of the cuvette. In some cases, both capillary pressure and compressed-air pressure contribute to the pressure that resists the liquid head pressure. The equilibrium position of the liquid/air meniscus may lie between the extremes shown in FIG. 15H and FIG. 15I. In other words, the equilibrium position of the liquid/air meniscus may lie anywhere within the restrictive channel of the cuvette depending on the liquid height, the capillary forces associated with the first capillary valve, and the volume of air trapped between the liquid and the pump. FIG. 15J illustrates an optional aspect of this embodiment in which the pump may be configured to apply a very slight pressure to the air-chamber, thereby momentarily increasing the pressure in the trapped air volume above the head-pressure of the liquid. In this way any fluid in the restrictive channel may be pushed back into the inlet chamber of the cuvette. FIG. 15K illustrates a state in which the cuvette is to be emptied, and the pump pulls the fluid out of the cuvette.

### Filter Holders and Filters

In some embodiments, the cuvette module comprises one or more filter holders into which filters may be inserted so that they are positioned proximal to the cuvettes, as shown in FIG. 16B. These filters may be high, low, or bandpass wavelength-selective filters, or they may be polarization or neutral density filters.

In some embodiments, wavelength selective filters can be used to filter out wavelengths from a broad-spectrum light source, so that only an assay-appropriate band of wavelengths is detected by the detector. In some embodiments, relative to broadband light, the wavelength selective filters are configured to provide improved signal/noise during detection.

In some embodiments, polarization filters may be used with polarization-based assays, wherein a first polarizer near the light-source creates linearly polarized light which passes through the cuvette and experiences an assay-dependent change in polarization. A second, crossed polarizer on the other side of the cuvette then only transmits light that has undergone the transition in polarization state.

In some embodiments, neutral density filters can be used to attenuate light received by a detector if the light source is too bright and the light source itself cannot easily be adjusted.

In some embodiments, the filters can be swapped in and out of the filter holders, enabling the cuvette module to accommodate a variety of assays.

### Light Source

In some embodiments, as shown in FIG. 16A-16B, the module comprises a housing that has holes in it to permit light from a light source to pass through the cuvette and any liquid contained therein, to a detector located on the opposite side of the cuvette. In some embodiments, the light source may be attached to a vertically-mounted PCB board, while the detectors may be arranged on a corresponding vertically-mounted PCB board. In some embodiments, the light-source and detector boards may be connected to a common motherboard, which may have its own power and a microcontroller. In some embodiments, the motherboard is capable of capturing data from the detector board and transmitting the data via a communication protocol (such as USB, Ethernet or RS-485) to a master microcontroller. In some embodiments, the discrete light-source and detector PCB boards may be easily swapped out by unplugging them from the motherboard, enabling the module to be rapidly reconfigured with different light sources and detectors to enable different photometric functions.

In some embodiments, the cuvette module comprises a light source, or a plurality of light sources. In other embodiments, the cuvette module may be positioned adjacent to a light source, or plurality of light sources. Each light source can be an optical emitter, such as a light-emitting-diode (LED) laser, or lamp, as shown in FIG. 13, FIG. 14, and FIG. 16A. The optical emitter can include an LED spacer and LED board as shown in FIGS. 14 and 16A. A broad-spectrum light source may be used with a filter wheel, prism, or grating to enable select wavelengths to be transmitted to particular cuvettes. Alternatively, a narrow band wavelength light source may be used.

The light from each light source is guided such that it is directed through the cuvette until it reaches the optical detector. The detector may be a silicon photodiode, silicon photomultiplier, avalanche photodiode (APD), photomultiplier tube (PMT), or any other light detector such as are commonly used in the art, The signal detected at the detector is acquired, amplified, and evaluated through means that are well-known to those versed in the art, so that the presence of an analyte and/or its concentration in the test fluid can be determined.

Based on Beer's law, according to which the absorption of light in a sample is proportional to the concentration of the analyte, the absorbance of light A at wavelength, caused by the presence of species X at a concentration [X] along a path L through the sample, can be expressed as:

$${{A}_{X}}^{λ} = {{ε}_{X}}^{λ} [ X ] L = {log}_{10} [ \frac{{l}_{0}}{l} ]$$

where εₓ^{λ} is the millimolar absorptivity of the species X at the designated wavelength. Accordingly, the concentration of the sought-after species can be expressed as

$$[ X ] = {log}_{10} [ \frac{{l}_{0}}{l} ] / ( {{ε}_{X}}^{λ} L )$$

The transmitted radiant power is determined by integrating the light intensity transmitted through the fluid over a range of wavelengths of interest and multiplying by the sensitivity of the detector at those wavelengths.

Illumination beam paths in accordance with embodiments of the present disclosure may also include various light sources configured to generate light in the visible spectrum, having a wavelength ranging from 390 to 700 nm, or in the UV spectrum, having a wavelength ranging from 300 to 390 nm, or in the infrared spectrum having a wavelength ranging from 700-1500. In some embodiments, the light source may be a laser. In some embodiments, the light source may be a light-emitting diode (LED). In some embodiments, the light source is configured to emit light having a wavelength of, e.g., 340 nm, 365 nm, 405 nm, 488 nm, 514 nm, 525 nm, 561 nm, 594 nm, or 616 nm, 640 nm, or 660 nm, however, other wavelengths are possible.

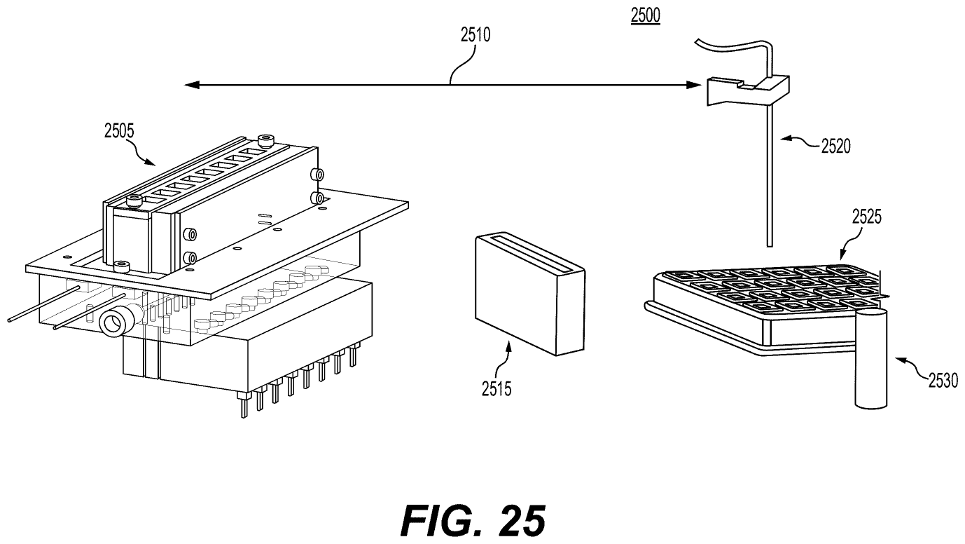

In some embodiments, each cuvette in an array of cuvettes of the cuvette module has a dedicated light source. In some embodiments, a single light source is shared by multiple cuvettes. In some embodiments, the light source and/or the cuvette module is motorized so that it may move by translation or rotation to positions that enable the light source to be delivered to multiple cuvettes. FIG. 25 shows an example of a motorized cuvette module that rotates each cuvette into position between a shared light source and detector.

In some embodiments, more than one light source can be associated with a single cuvette. For instance, several surface-mount LEDs may be positioned close to each other, such that light from all of the LEDs can be directed to a single cuvette.

### Sensors

In some embodiments, the cuvette module comprises a sensor configured to detect the presence or absence of fluid in at least a portion of the cuvette. In some embodiments, the sensor is positioned around the neck of the cuvette in a location at which it can detect fluid in the outlet channel or restrictive channel of the neck. In some embodiments, the sensor is an optical sensor, capacitive sensor, or conductivity sensor.

In some embodiments, the cuvette module comprises a pressure sensor configured to measure the pressure of the volume of air between the cuvette and the active valve.

### Liquid Sensing:

In some embodiments, the cuvette module comprises one or more fluidic sensors configured to determine the presence or absence of liquid in at least a portion of the cuvette. In some embodiments, the fluidic sensor is positioned around the necked region of the cuvette and can detect the position of the liquid/air meniscus in the restrictive channel therein. The location of the meniscus could be used as a check that the cuvette module is working as intended to maintain fluid in the inlet chamber of the cuvette. In some embodiments, this sensor is an optical sensor having an emitter and a detector, configured such that the emitter of the sensor is positioned on one side of the restrictive channel in the neck of the cuvette, and the detector on the other. In some embodiments, the sensor may alternatively be a capacitive sensor that can sense the change in the dielectric constant when air in the restrictive channel of the cuvette is replaced with liquid.

In some embodiments, a fluidic sensor may also be positioned just below the cuvette in the cuvette module. In some embodiments, the sensor is a conductivity sensor, wherein the presence of liquid below the cuvette may create a conductive path between a pair of electrodes. Such a conductive path would be expected during the wash cycle of a cuvette, but not during operation, and so provides a means of assessing the functionality and state of the cuvette module.

### Pressure Sensing:

In some embodiments, the cuvette module comprises at least one pressure sensor, situated so as to measure the pressure in the volume between the inlet chamber of the cuvette and the active valve or pump. The pressure sensor may gather data over the full course of an assay, and the measure of pressure vs. time may provide an important metric of the performance of the cuvette module at all stages of operation. A non-limiting example is provided with reference FIGS. 15H-15L. In FIG. 15G, the inlet chamber is empty and the pressure is at atmospheric pressure. In FIG. 15H and FIG. 15I, liquid has been dropped or dispensed through the inlet of the cuvette into the inlet chamber of the cuvette. In the state shown in FIG. 15I, the pressure sensor will measure a pressure in the now-trapped volume of air between the cuvette and the pump that is equal to the head pressure of the liquid in the cuvette. Thus, the pressure sensor may provide feedback about the height of the liquid in the cuvette inlet chamber. In FIG. 15J, the pump has been used to (optionally) provide a slight overpressure to the volume of trapped air, thereby ensuring that any liquid that has entered the restrictive channel is pushed back up into the cuvette inlet chamber. In this state, the pressure sensor would sense the slight addition of pressure. Finally, in FIG. 15K, during the evacuation of the cuvette, the pressure sensor will measure reduction in pressure associated with pulling the liquid out of the cuvette. At all stages of operation, a characteristic pressure “signature” may be recorded and compared with the expected pressure signature. Significant deviation of the experimental signature from the expected signature may enable diagnostic assessment of hardware failure, clogs or unintended restrictions in the pump, valve, tubing, channels, or cuvette.

### Washing

In some embodiments, after an assay is completed and the cuvette evacuated, the cuvette is rinsed by the same pipettor used to conduct assays. This requires no additional hardware, but is a serial process and occupies pipettor time, and often adds to the total analysis time (e.g., the total time a required in a run before another run can begin). Moreover, if the cleaning fluid differs from the system fluid, it can become inefficient to use the pipettor as means to distribute the cleaning fluid, as it requires the pipette to prime with cleaning fluid, dispense the cleaning fluid, and then prime with system fluid before the next run, leading to the generation of more liquid waste and loss of time.

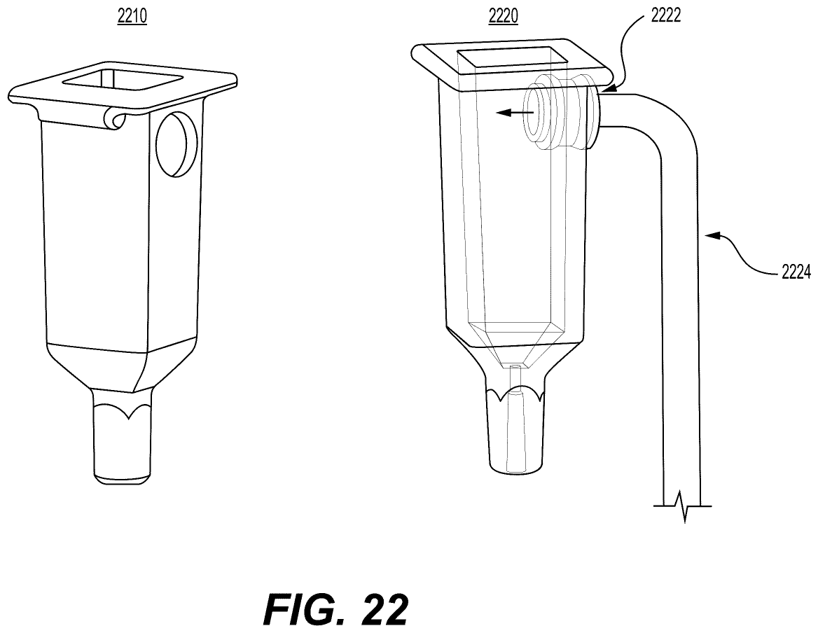

In some embodiments, the cuvette module further comprises a fluid input system, wherein each cuvette has a dedicated tube or channel configured to convey fluid (such as a wash fluid) to the cuvette. In some embodiments, such as that shown in FIG. 22, the cuvette may have an additional inlet hole, positioned such that it is above the expected fill level of the cuvette inlet chamber. In this embodiment, the cuvette module may have a tube or channel configured to interface with the inlet hole of the cuvette. A fluid-tight gasket may be used to ensure a fluid-tight seal of the inlet tube with the cuvette. A non-limiting example of the use of this hole is that in operation, following an assay, wash fluid may be pumped through the fluid tube into the cuvette by an external pump (not shown) such as a peristaltic pump or membrane pump.

In some embodiments, the cuvette does not comprise a inlet hole, and the inlet tube instead interfaces to the cuvette inlet. In such embodiments, it is important to ensure that the inlet tube does not interfere with the operation of the pipettor, thus the inlet tube may be preferentially located in a corner of the cuvette inlet so that it does not obstruct the remainder of the inlet.

### Optical Mask

In some embodiments, the cuvette module comprises an optical mask that limits the spatial extent of the light source. For instance, FIG. 16A illustrates an optical mask that is integral to the heatblock. The mask comprises a small hole that limits the spatial extent of the light emitted from the LED. This spatial filtering can be used, for example, to limit the angular spread of light entering the cuvette so that, for example, no light rays hit the liquid/air meniscus representing the top of the liquid in the cuvette.

In some embodiments, the mask is tailored to the cuvette geometry. For example, the mask with the small hole illustrated in FIG. 16A. will spatially limit the light passing into the cuvette to a cone of light that might match the angular dimensions of the trapezoidal cuvette of FIG. 8A-8C. A mask with a slit will spatially limit the light to a flat-topped pyramid of light that is better suited to a square cuvette. However, other masks and cuvette geometry pairs are possible.

In some embodiments, the cuvette module optionally comprises a spatial mask that can be used to limit the area of light incident on the detectors from the light source through the cuvettes.

### Optical Detector

The cuvette module of the present disclosure includes an optical detector. The optical detector may be a silicon photodiode, silicon photomultiplier, avalanche photodiode (APD), photomultiplier tube (PMT), or any other light detector such as are commonly known in the art.

In some embodiments, the cuvette module further comprises a detector board and detector spacer as shown in FIG. 14 and FIG. 16.

In some embodiments, the cuvette module further comprises a circuit board containing an array of photodiodes (such as, for example, an array of individual photodiodes in T−I<3>/4 packages) that are mounted on one side of the housing. In one embodiment, the number N of photodiodes equals that of the cuvettes. The photodiodes may have, for example, square detectors with active areas of about 1 mm×1 mm and be protected by flat optical windows. A complementary circuit board containing a corresponding number N of narrow-band (or substantially single-wavelength) LEDs in T−I<3>/4 packages with lensed tops is mounted on the other side of the housing as shown in FIG. 14 and FIG. 16.

### System

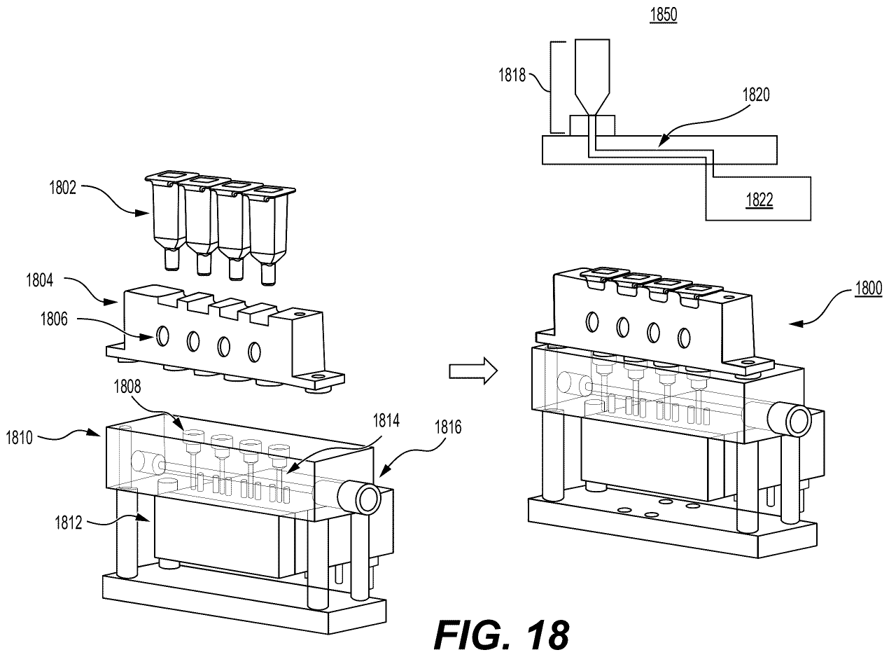

FIG. 18 shows a fluidic system design comprising a cuvette of the present disclosure, cuvette module and a fluidic base with channels or tubes connecting individual cuvettes to a single waste chamber, according to one or more embodiments. Cuvette module 1800 may include reaction vessels 1802, heat block 1804, holes 1806, O-rings 1808, manifold 1810, valves 1812, waste channel 1814, and fluidic fitting 1816. System 1850 may include a system like cuvette module 1800. System 1850 may include multiplex cuvette module 1818, fluidic base 1820, and common waste 1822. Fluidic base 1820 may be a base with channels or tubes connecting individual cuvettes to a single waste chamber. Common waste 1822 may be a single waste chamber.

FIG. 19A-19B show a workflow schematic of the methods of the present disclosure using a cuvette module to fill and mix liquids in a cuvette of the present disclosure, measure and analyze the sample, and empty the cuvette after the sample has been measured and analyzed, according to one or more embodiments.

FIG. 19A shows stages of using a cuvette module to fill and mix liquids, according to one or more embodiments. System 1900 may include pipettor 1902, cuvette 1904, valve 1906, waste chamber 1908, light source 1912, and light detector 1914. System 1900 may perform operation 1905, operation 1910, and operation 1915. Operation 1905 may include filling and mixing, and may include valve 1906 closed. Operation 1910 may include analyzing a sample, and may include valve 1906 closed and operating light source 1912 and light detector 1914. Operation 1915 may include emptying a cuvette into waste chamber 1908, and may include valve 1906 open.

FIG. 19B shows steps for using a cuvette module in a system, according to one or more embodiments. System 1900 may include consumable well with reagent 1916, consumable well with reagent 1918, consumable cartridge 1922, serum sample tube 1924, pipettor 1926 (which may be a pipettor like, for example, pipettor 1902), wash station 1928, reusable cuvette 1932, and cuvette module 1934. Table 1950 may include operations for system 1900. Table 1950 may include operation 1951, operation 1952, operation 1953, operation 1954, operation 1955, operation 1956, operation 1957, operation 1958, operation 1959, operation 1960, operation 1961, operation 1962, and operation 1963. Operation 1951 may include aspirating reagent one from consumable well with reagent 1916. Operation 1952 may include dispensing reagent one into an IPM cuvette. Operation 1953 may include washing pipettor 1926. Operation 1954 may include aspirating sample from serum sample tube 1924. Operation 1955 may include dispensing sample into IPM cuvette. Operation 1956 may include mixing readent one and sample. Operation 1957 may include washing pipettor 1926. Operation 1958 may include aspirating reagent two from consumable well with reagent 1918. Operation 1959 may include dispensing reagent two into the IPM cuvette. Operation 1960 may include mixing reagent two into the reagent one and sample. Operation 1961 may include washing pipettor 1926. Operation 1962 may include measuring absorbance over a time. Operation 1963 may include after the assay is complete, cleaning, washing, and draining the IPM cuvette.

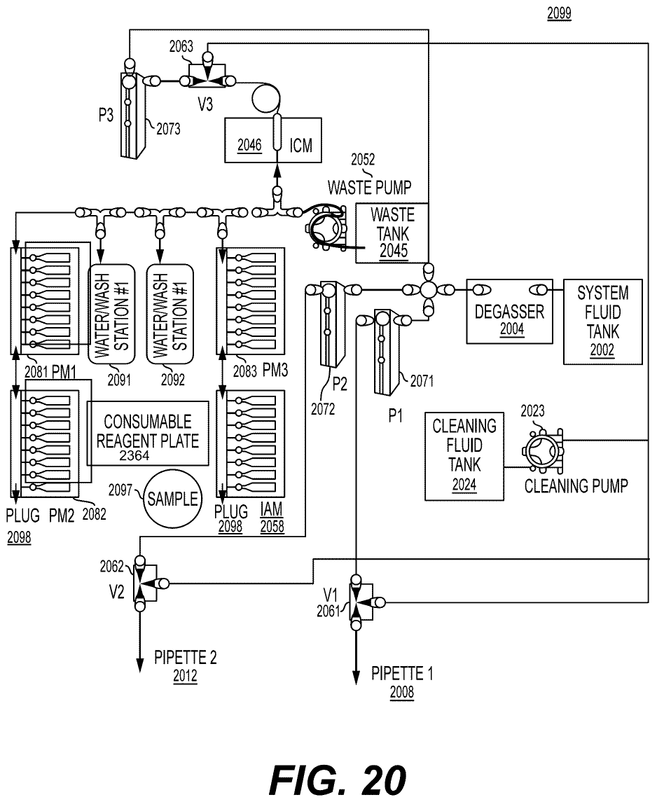

FIG. 20 shows the fluid architecture of an exemplary system of the present disclosure, according to one or more embodiments. System 2099 includes pipette one 2008, pipette two 2012, valve one 2061, valve two 2062, valve three 2063, pump 2023, cleaning fluid tank 2024, system fluid tank 2002, degasser 2004, pump one 2071, pump two 2072, pump three 2073, waste tank 2054, waste pump 2052, ICM 2046, PM one 2081, PM two 2082, and PM three 2083, water wash station 2091, water wash station 2092, consumable reagent plate 2064, sample 2097, IAM 2058, and plug 2098.

Aspects of the present disclosure further comprise a system for processing a sample and/or performing photometric measurements of a sample. An example of such a system is shown in FIG. 20.

The system of the present disclosure includes one or more cuvette module(s) as described herein. In FIG. 20, there are three such modules, labeled PM1-PM3. In some embodiments, the system further comprises a pump. A pump of the system is used to remove fluid through an outlet of one or more cuvettes of the cuvette module(s). For example, once an active fluidic valve is opened, the pump, once turned on, creates a pressure difference across the fluid, resulting in the expulsion of the liquid from an outlet of the cuvette with the open valve. When a cuvette module comprises more than one active valve, the pump causes fluid to be expelled from only a cuvette outlet with an open active valve. For example, if the cuvette module comprises 10 cuvettes, and only 5 of the 10 cuvettes comprises an open active valve, the pump can remove fluid from the 5 cuvettes with an open active valve, without disruption of the remaining 5 cuvettes with closed active valves.

The fluidic pressure difference across the fluid can be formed with the use of, for example, a pump that is appropriately connected to the outlet, of one or more cuvettes, (downstream with respect to the cuvette(s)). In FIG. 20 this is labeled as the “waste pump”. Alternatively, the fluidic pressure can be formed with the use of a pressure that is applied to the inlet end of the cuvette, resulting in fluid that is pushed out of the outlet.

In some embodiments, the pump is a peristaltic pump, a membrane pump, or a diaphragm pump. In some embodiments, the pump comprises an evacuated gas cylinder, configured to create a pressure difference across the fluid in the cuvettes by pulling on their outlets

In some embodiments, the pump is a pneumatic pump. In some embodiments, the pump comprises a pressurized gas cylinder to create a pressure difference across the fluid in the cuvettes by applying pressure to their inlets.

In some embodiments, the pump connected to the downstream tube or channel traps a volume or pocket of air between the pump and any liquid in the cuvette inlet chamber such that if liquid in the cuvette inlet chamber starts to move out of the inlet chamber under the influence of gravity, the air pocket or volume of air between the inlet chamber and the pump becomes pressurized and therefore resists further movement of fluid from the cuvette.

### Waste Tank

In some embodiments, such as that shown in FIG. 20, the system of the present disclosure comprises a waste tank. In some embodiments, where a waste tank is present, the cuvette module comprises a channel or tube connecting the one or more individual cuvettes to the waste container. The waste tank can include a common single waste collection reservoir (storage volume) as shown in FIGS. 18, 19, and 20.

### Cleaning Fluid Tank

In some embodiments, the system further comprises a cleaning fluid tank. The cleaning fluid tank may be fluidically connected to a pipettor so that the pipettor can dispense cleaning fluid into the cuvettes to clean them. This is the configuration shown in FIG. 20 Alternatively, the cleaning fluid may be directly connected to the cuvettes through a valve, or through fluidic inlet tubes as shown in FIG. 22.

### Cleaning Pump

In some embodiments, the system further comprises a cleaning pump. The cleaning pump can be used to pump cleaning fluid from the cleaning fluid tank, to the cuvettes.

### Degasser

In some embodiments, the system further comprises a degasser. The degasser can be used to degas fluids before they are used in the system.

### Pipettes

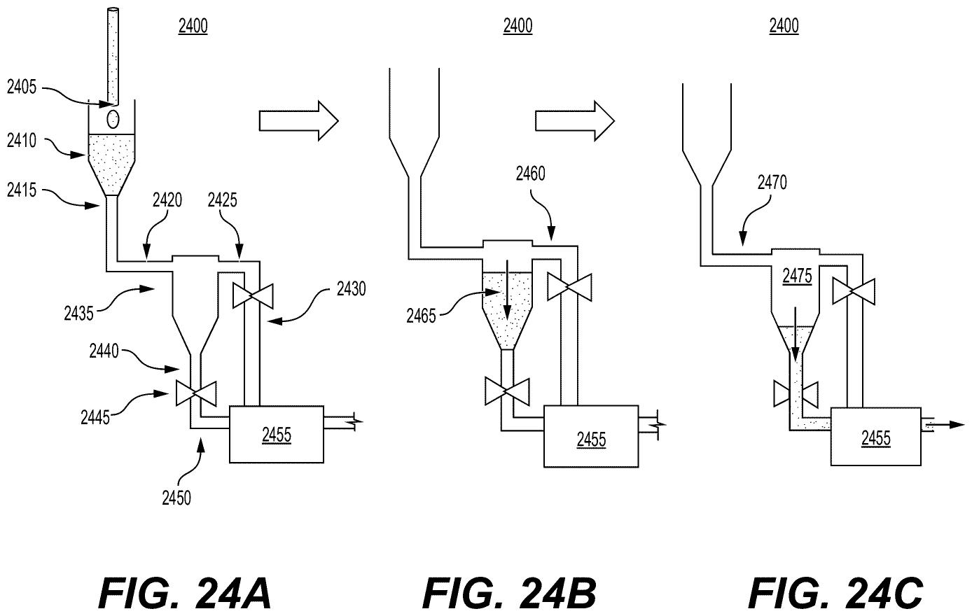

In some embodiments, the system further comprises one or more pipettor(s) for pipetting and/or mixing the sample and/or reagents in the cuvette(s). In some embodiments, the pipettor(s) are automated pipettor(s). In some embodiments, the system comprises a plurality of pipettors. In some embodiments, the pipettor(s) are mounted to arms on a robot, such as an XYZ gantry robot to enable them to move to different places in the system. An example of the pipettor configuration and orientation is provided in FIG. 24.

### Thermal Heater

In some embodiments, the system further comprises a thermal heater or a thermal block. The thermal heater of the system can be used to maintain the temperature inside of an enclosed system generally, or inside the cuvette module, specifically.

### Waste and Wash Stations

As shown in FIG. 19, FIG. 20, and FIG. 24, the system further comprises one or more waste and wash stations. The waste/wash station(s) can be used to accept waste from the pipettor(s) and to the inside and outside of the pipettors.

### Consumable Reagent Plate

As shown in FIG. 20, the system further comprises one or more consumable reagent plates. The reagent plate(s) hold the reagents that are to be used in the assay(s). When the reagents are used up, the consumable reagent plate is replaced.

### Sample Vial

As shown in FIG. 20, the system further comprises one or more sample vials. The sample vial(s) hold the sample(s) that are to be used in the assay(s). After a sample is used, the sample vial is replaced.

### Mixing Apparatus

In some embodiments, the system further comprises a mixing apparatus. A nonlimiting example of a mixing apparatus includes magnetic stir bars or magnetic balls within the cuvette, and a magnet, such as a bar magnet may be positioned outside of the cuvettes. Movement of the bar magnet affects movement of the balls or bar magnets within the cuvettes, thereby creating turbulence that mixes the fluids. Another non-limiting example of a mixing apparatus includes mechanical features such as propellers or impellers that move into the cuvette to mix and retract from the cuvettes during measurement operations. In some embodiments, the system comprises mechanical means of mixing one or more fluids within the cuvette. In some embodiments, the system comprises non-mechanical means of mixing fluids within the cuvette.

### Method for Processing a Sample

Aspects of the present disclosure include a module for processing and performing photometric measurements. In some embodiments, the cuvette module is a multiplexed device that can process and measure multiple samples in a single cuvette or in an array of cuvettes. FIG. 19 describes a non-limiting example of use of the cuvette module.

As shown in FIG. 19A, in step 1, the valve below the cuvette is closed. Liquids are pipetted into the cuvette and mixed, if necessary. In Step 2 of FIG. 19A, the valve remains closed during the assay—a photometric assay is illustrated here. In step 3 of FIG. 19A, the valve is opened—either by electrically actuating an active valve, and/or by creating a pressure differential across a passive valve (e.g. a check-valve, duckbill-valve, or capillary valve), and thereby causing it to open. Such a pressure differential might be generated by using a pump to pressurize the top of the open cuvette, or pull a vacuum on the bottom of the cuvette on the distal side of the valve. Other operating methods and modalities may also be envisioned.

As described by FIG. 19B, the pipettor first aspirates Reagent 1 (R1) from a well in the consumable cartridge and dispenses it to the cuvette on the cuvette module. The pipettor washes itself in a wash station and then aspirates sample (e.g. such as plasma or serum) from the sample tube, dispenses it into the cuvette, and mixes it with R1. The pipettor washes itself again in the wash station while R1 and sample are incubating. When the incubation is complete, the pipettor aspirates Reagent 2 (R2) from a second well in the consumable cartridge, dispenses it into the cuvette on the cuvette module and mixes. The reaction now proceeds, and the intensity of the light from the LED(s) is monitored over time by the detector. These photometric measurements may be used to determine the concentration of the chemical species under test.

When the photometric measurements are complete, the valve is opened and a waste pump (not shown in FIG. 19B) pulls the waste to a waste chamber. The pipette then positions itself above the cuvette and flushes it with consecutive clean and other solutions, which are pumped through the pipette. Other types of assays, such as photometric endpoint assays, may be conducted in a similar manner. In some embodiments, a fluidic solution is a wash solution.

In some embodiments, the method comprises dispensing fluids into an inlet of the cuvette of the present disclosure to deliver the fluid such as sample fluid, reagents, buffers, cleaning fluids, etc. into the cuvette, processing the sample, transmitting light from a first light source to a photodetector through the interrogation region of the cuvette containing the fluids, acquiring data representing the detected analyte(s), and determining the presence and/or concentration of one or more analytes in the sample.

In some embodiments, the method comprises mixing one or more reagents and a sample within a cuvette. In some embodiments, said mixing can be performed using a pipettor.

In some embodiments, the method comprises measuring a sample while processing the sample and acquiring data representing the sample while processing the sample. In some embodiments, the method comprises measuring a processed sample and acquiring data representing the processed sample. An example of a sample processing and measuring workflow of the present methods is shown in FIG. 19A-19B. As shown in FIG. 19A-19B the pipettor dispenses fluids (e.g., sample and/or reagent(s)) into a cuvette to fill the cuvette. The pipettor can be used to mix the sample with reagents and/or buffer solutions (step 1). At any point during processing of the sample, or after processing the sample, the sample is measured and analyzed (step 2 of FIG. 19B). Once measurements are performed, the fluidic valve is opened and the sample fluid is aspirated from the cuvette (step 3).

In some embodiments, the method includes analyzing the data representing the sample. In some embodiments, analyzing comprises determining a concentration of the one or more analytes in the sample.

In some embodiments, acquiring data representing said sample comprises acquiring fluorometric measurements of the sample. In some embodiments, acquiring data representing the sample comprises measuring the absorbance of the sample. In some embodiments, acquiring data representing the sample comprises measuring the concentration of the sample. In some embodiments, the sample comprises one or more metabolic analytes selected from: Blood urea nitrogen (BUN), carbon dioxide (CO2), Creatinine, Glucose, chloride, potassium, sodium, calcium, Hemoglobin, Albumin (ALB), Total protein (TP), Alkaline phosphatase (ALP), Alanine transaminase (ALT), Aspartate aminotransferase (AST), Total Bilirubin, Amylase, Gamma-glutamyl transferase, Lipase, Magnesium, Phosphorus, Direct Bilirubin, Triglycerides, total Cholesterol, high-density-lipoprotein (HDL), Ammonia, lactic acid (LAC), Fructose, Lactate dehydrogenase (LDH), uric acid, bile acids, Hbalc, and Creatine kinase.

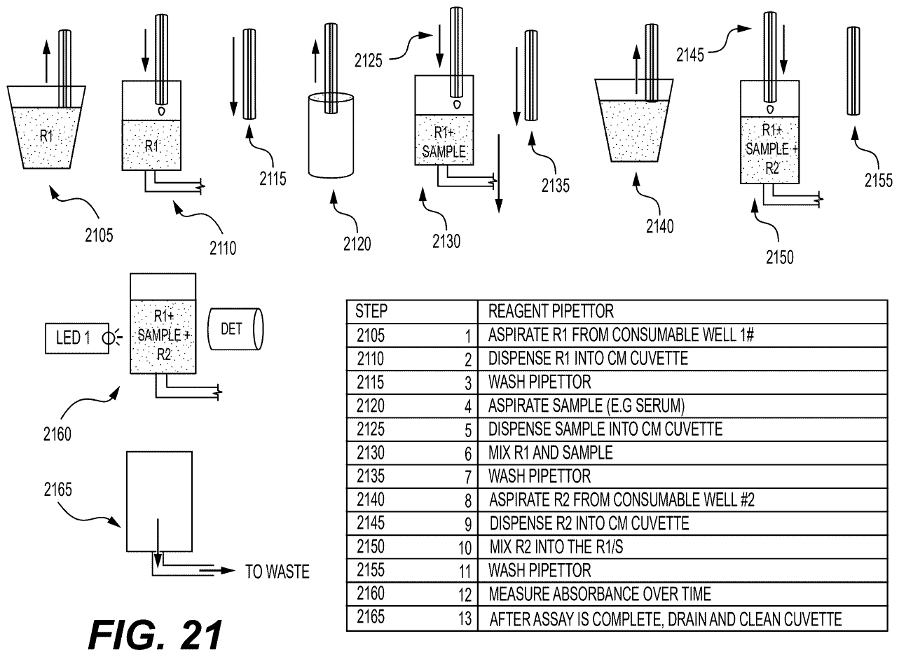

FIG. 21 shows a process flow of a method of the present disclosure including clinical chemistry using the cuvette module cuvette module of the present disclosure, according to one or more embodiments. Method 2100 may include operation 2105, operation 2110, operation 2115, operation 2120, operation 2125, operation 2130, operation 2135, operation 2140, operation 2145, operation 2150, operation 2155, operation 2160, and operation 2165.

Another non-limiting example of the method workflow is shown in FIG. 21. As shown in FIG. 21, the method includes aspirating reagent 1 (R1) from a consumable well (step 1 or operation 2105), and dispensing R1 into the cuvette module cuvette (step 2 or operation 2110). The next step includes washing/rinsing the pipettor (step 3 or operation 2115). The next step of the method includes aspirating the sample from a serum tube (step 4 or operation 2120) and dispensing the sample containing serum into the cuvette module cuvette containing R1 (step 5 or operation 2125). The pipettor can be used to aspirate and dispense the sample and/or reagent to and from the cuvette, or from a well or tube containing R1 and/or sample and into the cuvette. The pipettor can also be used to mix the reagent R1 and sample within the cuvette module cuvette (step 6 or operation 2130). After mixing the sample with R1 in the cuvette module cuvette, the pipettor is washed and/or rinsed to remove residual sample and/or reagent (step 7 or operation 2135). The next step is aspirating reagent 2 (R2) (step 8 or operation 2140) from a consumable well (well #2) and dispensing R2 into the cuvette module cuvette (step 9 or operation 2145) and mixing R2 into the cuvette containing R1 and sample (step 10 or operation 2150). Again the pipettor is washed (step 11 or operation 2155). The next step includes measuring the sample using the optical emitter. Light is transmitted through an interrogation region of the cuvette and detected by a detector on the opposite side of the cuvette wall. The measurements may be taken at any time point, for example: during processing of the sample, during a reaction of an assay being performed, or after the reaction. The detector measures the wavelength(s) of light transmitted over time and as the reaction proceeds (step 12 or operation 2160). Once the assay is finished, the cuvette is drained, cleaned, and washed and the fluid exiting the cuvette then flows through a waste line into a waste container (step 13 or operation 2165).

In some embodiments, the fluid is a sample. In some embodiments, the fluid is a sample and a reagent. In some embodiments, the fluid is a sample and one or more reagents mixed together. In some embodiments, the fluid is a sample mixed with a buffer. In some embodiments, the reagent is a buffer. In some embodiments, the sample is a biological sample. In some embodiments, the sample is a chemical sample. For example, samples include various fluids such as bodily fluids (such as whole blood, serum, plasma, cerebrospinal fluid, urine, lymph fluids), and other fluids (such as, for example, cell culture suspensions, cell extracts, cell culture supernatants). A sample may be suspended or dissolved in, for example, buffers, extractants, solvents, and the like. Additional examples of samples are provided by fluids deliberately created for the study of biological processes or discovery or screening of drug candidates. The latter include, but are not limited to, aqueous samples that contain bacteria, viruses, DNA, polypeptides, natural or recombinant proteins, metal ions, or drug candidates and the mixtures.

FIG. 22 shows an example of a fluidic system of the cuvette module comprising a tube or channel connected to a hole within the cuvette for dispensing fluids into the cuvette, according to one or more embodiments. Cuvette module 2210 may be a fluidic system of the cuvette module. Cuvette module 2220 may be a module like cuvette module 2210, and may include a fluidic seal 2222 and wash tube 2224.

As described in U.S. Pat. No. 10,215,687, which is hereby incorporated by reference in its entirety, it is appreciated that optimization of the operation of a microfluidic system depends, at least in part, on the ability of a user to utilize a sample of a limited volume. To achieve such optimized operation, the volume of the cuvette should not contain ‘dead space’ that is filled with the substance of the sample but is not taking part in a photometric measurement. The required operational footprint of the cuvette, which facilitates elimination of such ‘dead space’, relates to the area of the photodetector used for photometric measurements.

The cuvettes that have been described thus far have an interrogation region that is contained within the inlet chamber. It is a common feature of these embodiments that the interrogation region may be filled by a fluid entering the inlet, without substantial trapping of air. In other words, the interrogation region of the cuvette may be completely filled under the influence of gravity.

However, alternative embodiments separate the interrogation region from the inlet chamber, so that while the inlet chamber may be filled under the influence of gravity, filling the interrogation region requires the application of a non-gravimetric pressure differential across the fluid.

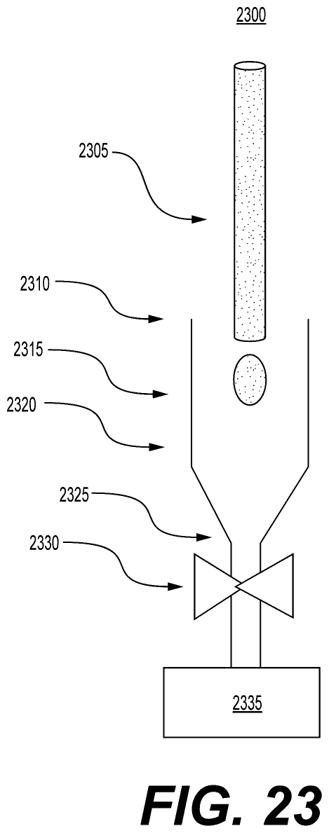

FIG. 23 depicts a representative of the cuvettes wherein the interrogation region is contained within the inlet chamber, according to one or more embodiments. Cuvette 2300 may include liquid dispenser 2305, inlet 2310, inlet chamber 2315, interrogation region 2320, outlet 2325, valve 2330, and pump 2335. Liquid dispenser 2305 may be a probe. Interrogation region 2320 may be contained within the inlet chamber 2315.

FIG. 24A depicts a cuvette design in which the interrogation region is separate from the inlet chamber, according to one or more embodiments. Cuvette 2400 may include inlet 2405, inlet chamber 2410, input channel 2415, joining channel 2420, air channel 2425, valve 2430, interrogation region 2435, outlet 2440, valve 2445, waste channel 2450, and pump 2455. Interrogation region 2435 may be separate from inlet chamber 2410.

FIG. 24B depicts a cuvette design in which the interrogation region is separate from the inlet chamber, according to FIG. 23B. Air may escape through channel 2460, and pressure may apply in a downward direction at point 2465.

FIG. 24C depicts a cuvette design in which the interrogation region is separate from the inlet chamber, according to FIG. 23C. Cuvette 2400 may include joining channel 2470. Liquid may drain from cuvette 2400 towards channel 2475.

Referring to FIG. 23 and FIG. 24A-24D, FIG. 23 shows an embodiment in which the interrogation region is contained within the inlet chamber. This is the embodiment that we have previously described herein. In alternative embodiments, as shown in FIG. 24A, the inlet chamber is separated from the interrogation region. In this embodiment, the inlet chamber may be filled under the influence of gravity. However to fill the interrogation region, a pressure differential is created across the fluid to push or pull the fluid into the interrogation region. In the embodiment where the inlet chamber is separate from the interrogation region, the inputs to multiple modules may be clustered together and thus easily accessible by a pipettor or probe, while the interrogation regions may be located elsewhere, to save space on the instrument.

As with all the embodiments of the cuvette described in this disclosure, the inlet chamber may be filled under the influence of gravity. As shown in FIG. 24A, to fill the interrogation region, valve #1 is opened, and fluid is pushed or pulled into the joining channel. Upon reaching the interrogation region, the fluid then uniformly fills it under the influence of gravity, while air escapes through the air-channel. In other words, the interrogation region is sized and shaped such that surface tension and capillary forces within it are negligible compared to the force of gravity. Moreover, so long as the fluid is pulled or pushed gently through the joining channel, no fluid will be pulled through the air-channel or through valve #1; the fluid will all stay within the interrogation region. After the interrogation region is filled, analysis of the sample then takes place. Upon conclusion of the assay, valve #1 is closed, valve #2 is opened, and the pump pulls the liquid to waste through the waste channel.

FIG. 25 shows a cuvette module system containing the integrated module, a wash station, and a pipette system for use in processing samples, according to one or more embodiments. System 2500 may include cuvette module 2505, waste wash station 2515, pipettor 2520, consumable well plate 2525, and serum tube 2530. Pipettor 2520 may be mounted to a gantry robot and move in direction 2510, which may include movement in a X-Y area.

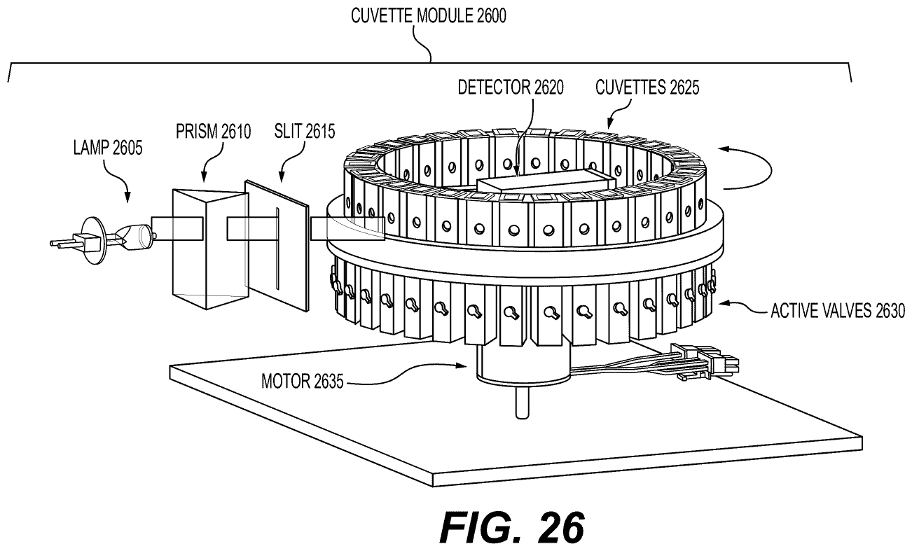

FIG. 26 shows a cuvette module that includes a circular array of cuvettes, according to one or more embodiments. Cuvette module 2600 may include lamp 2605, prism 2610, slit 2615, detector 2620, cuvettes 2625, active valves 2630, and motor 2635.

While the invention has been particularly shown and described with reference to a preferred embodiment and various alternate embodiments, it will be understood by persons skilled in the relevant art that various changes in form and details can be made therein without departing from the spirit and scope of the invention.

All references, issued patents and patent applications cited within the body of the instant specification are hereby incorporated by reference in their entirety, for all purposes.

1. A cuvette for holding fluids, comprising:
(a) an inlet end comprising an inlet open to the atmosphere, wherein the inlet is configured to receive the fluids dispensed into the inlet from above the cuvette;
(b) a body of the cuvette connected to the inlet end, the body composed of walls surrounding the cuvette, each wall having an inner surface and an outer surface, the walls including a plurality of regions comprising:
(i) an inlet chamber, the inlet chamber comprising:
an interrogation region comprising a proximal end and a distal end, the proximal end positioned at the inlet end of the cuvette, the walls at the interrogation region including a first wall and a second wall opposite the first wall, wherein the inlet chamber is configured to: be filled under the influence of gravity; and allow transmission of light through the first wall and the second wall of the interrogation region, and
a tapered region comprising a proximal end and a distal end, the tapered region positioned at the distal end of the interrogation region, the inner surface of the wall at the tapered region tapering inward from the proximal end of the tapered region to a narrowed section at the distal end of the tapered region, wherein there is an obtuse angle formed between the inner surface of the walls of the tapered region and the inner surface of the walls of the interrogation region; and
(ii) a necked region fluidically connected to the distal end of the tapered region, and comprising: an outlet positioned at the distal end of the necked region, wherein the necked region is configured to maintain fluid within the inlet chamber of the cuvette until a pressure gradient is applied across the outlet.

2. The cuvette of claim 1, wherein the necked region comprises an outlet channel.

3. The cuvette of claim 2, wherein the outlet channel comprises an outlet opening comprising an inner diameter ranging from 0.01 mm to 2

4. (canceled)

5. The cuvette of claim 1, wherein the necked region further comprises a restrictive channel.

6. The cuvette of claim 5, further comprising a capillary valve between the transition of the distal end of the tapered region and the proximal end of the restrictive channel.

7. The cuvette of claim 6, wherein the capillary valve is created by the transition of the inner diameter of distal end of the tapered region and the inner diameter of the proximal end of the restrictive channel.

8. The cuvette of claim 7, wherein the restrictive channel has an inner diameter ranging from 0.01 mm to 2 mm.

9. The cuvette of claim 8, wherein the restrictive channel is configured to hold a volume ranging from 0.01 microliters to 2 microliters.

10. The cuvette of claim 1, wherein the volume of the interrogation region of the cuvette is greater than 50% of the total volume of fluid that fills the cuvette.

11. The cuvette of claim 5, wherein the restrictive channel comprises a length ranging from 0.5 mm to 5 mm.

12. The cuvette of claim 5, wherein the inner diameter of the restrictive channel is smaller than the inner diameter of the outlet channel of the necked region.

13. The cuvette of claim 1, wherein the first and second walls of the interrogation region are substantially flat.

14. The cuvette of claim 1, wherein the obtuse angle between the inner surface of the wall of the tapered region and the inner surface of the first wall and the second wall of the interrogation region ranges from 130 to 179 degrees.

15. The cuvette of claim 1, wherein the cuvette comprises a connection point between the distal end of the interrogation region and the proximal end of the tapered region, wherein the connection point comprises the obtuse angle ranging from 130 to 179 degrees.

16. The cuvette of claim 1, wherein the cuvette further comprises an indexing feature configured to index a portion of the cuvette to a surface of a housing, a manifold, a sensor, or a fluidic valve.

17. The cuvette of claim 1, wherein the indexing feature is positioned at the inlet end.

18. The cuvette of claim 17, wherein the indexing feature is positioned at the proximal end of the interrogation region.

19. The cuvette of claim 17, wherein the indexing feature comprises a peripheral rim surrounding the inlet.

20. The cuvette of claim 19, wherein the peripheral rim comprises a lip extending radially outward from the cuvette to lock the cuvette in place.

21. The cuvette of claim 21, wherein the indexing feature comprises a peripheral rim surrounding the inlet.

22-107. (canceled)
